(19) United States
(12) Patent Application Publication
(10) Pub. No.: US 2006/0057493 A1
(43) Pub. Date: Mar. 16, 2006

(54) Planographic printing plate precursor

(75) Inventors: Ryuki Kakino, Shizuoka-ken (JP); Ippei Nakamura, Shizuoka-ken (JP); Ikuo Kawauchi, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/204,229

(22) Filed: Aug. 16, 2005

(30) Foreign Application Priority Data
Aug. 16, 2004 (JP) 2004-236767
Sep. 8, 2004 (JP) 2004-261593

(51) Int. Cl. G03C 1/76

(52) U.S. Cl. 430/270.1

(57) ABSTRACT

The positive-type planographic printing plate precursor of the invention comprises a support and a recording layer provided on the support, wherein the recording layer contains: a polymer compound having (a) a monomer represented by the following formula (1), (b) a monomer having an aliphatic group having 7 or more carbon atoms and having a bridge bond, and (c) monomer having an acid group as a copolymerization component; and an infrared-ray absorbing agent. The positive-type planographic printing plate precursor of the invention achieves both excellent developability and excellent inking property, as well as better image-forming property and a clear image. 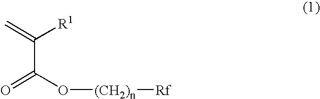
wherein in the formula (1), Rf is a substituent containing a fluoroalkyl group or a perfluoroalkyl group having 9 or more fluorine atoms, n represents 1 or 2, and R¹ represents hydrogen or a methyl group.

### CROSS-REFERENCE TO RELATED APPLICATION

This application claims priority under 35 USC 119 from Japanese Patent Applications Nos. 2004-236767 and 2004-261593, the disclosure of which is incorporated by reference herein.

### BACKGROUND OF THE INVENTION

1. Field of the Invention

The present invention relates to a planographic printing plate precursor, more particularly, a positive-type photosensitive planographic printing plate precursor which can provide a planographic printing plate excellent in inking property and developability and capable of suppressing generation of a developing scum in a developing bath.

2. Description of the Related Art

A planographic printing plate precursor has a construction in which an image forming composition is provided on a substrate.

A typical manufacturing process is to coat and dry an image forming composition dispersed or dissolved in an organic solvent and, if necessary, an upper layer such as a protecting layer thereon, on a surface of a support which has been subjected to suitable surface treatment, undercoating or back coating.

A typical plate-making step includes: causing change in physical property, imagewise, on an image forming composition on a support by contact or projection-format surface exposure via an image mask, or direct exposure with scanning or modification of an electromagnetic wave based on image information from a computer; thereafter performing removal of an image forming composition at a non-image part (i.e., development) and, if necessary, treatment such as hydrophilization, sensitization and formation of a protecting film, thereby, forming a planographic printing plate having a non-image part consisting of a hydrophilic support surface layer and an image part consisting of a hydrophobic composition surface layer.

In the planographic printing plate thus obtained, in a typical printing step, a hydrophilic non-image part receives wetting water, and a lipophilic image part receives an ink to form an ink image on a surface. By directly or indirectly transferring the resulting ink image onto a desired printing medium, a printed article is obtained

As an image forming layer used herein, a positive-type recording layer employing a heat mode process is useful. When the image forming layer is used, it is useful to impart sufficient lipophilicity to a recording layer surface thereof to improve inking property at printing initiation, which leads to remarkable increase in a working efficiency at printing. However, improvement in lipophilicity of a surface of an image forming surface generally deteriorates permeability of developer into the image forming layered, which tends to cause deterioration of developability.

Therefore, in order to achieve both of good developability and good inking property, it is preferable to use a material having a good balance between hydrophilicity and lipophilicity. However, a material exhibiting both good hydrophilicity and good lipophilicity in a satisfactory manner has not been obtained yet.

As a method of reliably obtaining lipophilicity of an image forming layer, for example, a method of using a polymer having a straight, branched or cyclic alkyl group having 4 to 20 carbon atoms such as a phenolic hydroxyl group and a stearyl group has been proposed (for example, see Japanese Patent Application Laid-Open (JP-A) No. 2004-117882). However, when the aforementioned lipophilic polymer is used as a main component of a binder, since an amount thereof to be added is large, there is a possibility that the polymer has an adverse influence on other performances such as developability. That is, handling of the lipophilic polymer is somewhat difficult. On the other hand, when such a lipophilic polymer is used only by a small amount as an additive, there arises a problem in that inking property improving effect cannot be obtained in a satisfactory manner.

In addition, for suppressing developer permeability at a surface, use of a polymer having a fluorine-based functional group has been proposed (for example, see JP-A No. 2002-72474). However, since a compound having a functional group containing a number of fluorine atoms has not only water repellency and alkali resistant developability, but also property of oil repellency, when the compound is blended at a large amount, there is a possibility that the compound adversely affects both inking property on a surface and developability.

Further, as a method of maintaining lipophilicity of a recording layer, addition of a fluorine-based surfactant having a fluoro aliphatic group has also been proposed (for example, JP-A No. 2002-311577, and JP-A No. 2004-101893). However, since compounds described in these references also have property such as oil repellency, water repellency and resistance to alkali developability, there is a possibility that, when the compound is blended by a large amount, not only inking property is deteriorated but also developing scum and sludge are generated during a developing bath treatment and sensitivity is reduced.

### SUMMARY OF THE INVENTION

A first object of the invention is to provide a planographic printing plate precursor which realizes both of excellent developability at a non-image part and inking property at an image part, has better image-forming property, and gives a clear image.

In addition, a second object of the invention is to provide a planographic printing plate precursor in which inking property at an image part is excellent, a satisfactory printed article is obtained and even when plate making treatment is performed continuously, generation of precipitates in a developer is suppressed.

As a result of intensive studies of components of a polymer used as a binder, the present inventors have discovered that the aforementioned problems can be solved by inclusion of a polymer compound having a better balance between developability and surface lipophilicity, which resulted in completion of the invention.

That is, in order to achieve the first object, in a first aspect of the present invention, a planographic printing plate precursor of the invention comprises a recording layer containing a polymer compound having: (a) a monomer represented by the following formula (1); (b) a monomer having an aliphatic group having 7 or more carbon atoms and having a bridge bond; and (c) a monomer having an acid group as a copolymerization component, and an infrared-ray absorbing agent, on a support.

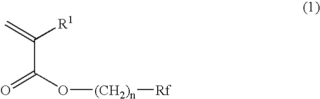

In the formula (1), Rf is a substituent containing a fluoroalkyl group or a perfluoroalkyl group having 9 or more fluorine atoms, n represents 1 or 2, and R¹ represents hydrogen or a methyl group.

In the invention, a “bridge bond” represents a bond in which atoms which are not adjacent in one ring structure are bonded to each other in a bridging manner. When a monomer has two or more cyclic aliphatic groups, it suffices if at least one of the cyclic aliphatic groups has a bridge bond.

A mechanism of action of the invention is not clear, but assumed as follows.

A copolymer used in the invention has a tendency to be unevenly dispersed on a surface, due to function of (a) a monomer component containing fluorine represented by the aforementioned formula (1). Thereupon, a functional group of (b) a monomer having an aliphatic group having 7 or more carbon atoms and having a bridge bond, which is a second copolymerization component, is also specifically oriented on a surface. The partial structure containing fluorine thus formed at the surface contributes to improvement in developer resistance. However, the fluorine-rich structure at the surface having high oil repellency may adversely affect inking property, if no preventive action is taken.

In the invention, since an aliphatic groups having 7 or more carbon atoms and having a bridge bond contained in a second monomer (b) are sterically bulky and have relatively low affinity for an alkali-soluble resin present such as a novolak resin, these groups are easily oriented on a surface. Further, these aliphatic groups have high lipophilicity. It is thus assumed that, as a result of a second monomer (b) being copolymerized (if the amount of the second monomer (b) added is relatively small), the image forming layer surface is imparted high lipophilicity, which leads to improved inking property.

In the copolymer, an aliphatic group having 7 or more carbon atoms and having a bridge bond which contributes to lipophilicity manifests excellent lipophilicity even at a small introduction amount. Due to this, an acid group can be introduced into the copolymer by an amount which is large enough to impart alkali solubility to the image forming layer.

Owing to (c) a monomer having an acid group, which is a third copolymerization component and serves to provide the polymer with alkali solubility, the copolymer has excellent alkali solubility. At an exposed part, the specific copolymer which is unevenly distributed on a surface exhibits good solubility in an alkali, resulting in satisfactory dvelopability. Presumably for this reason, when the specific copolymer is used as a recording layer of a planographic printing plate precursor, it is possible to provide a planographic printing plate precursor excellent in both of inking property at an image part and developability at a non-image part.

In addition, in order to attain the aforementioned second object, in a second aspect of the invention, a planographic printing plate precursor comprises: a support; and a recording layer provided on the support, wherein the recording layer contains: a polymer compound having, as a copolymerization component, (a) a monomer represented by the following formula (1) and (b) a monomer represented by the following formula (2); and an infrared-ray absorbing agent.

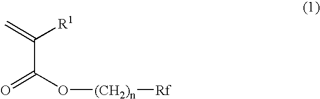

In the formula (1), Rf is a substituent containing a fluoroalkyl group or a perfluoroalkyl group having 9 or more fluorine atoms, n represents 1 or 2, and R¹ represents hydrogen or a methyl group.

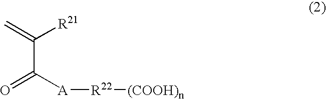

In the formula (2), R²¹ represents a hydrogen atom or a methyl group, and R²² represents a divalent hydrocarbon group having a C3-C30 alicyclic structure. A represents an oxygen atom, or —NR²³—, and R²³ represents a hydrogen atom or a C1-C10 monovalent hydrocarbon group.

Mechanism of action of the present characteristic is not clear, but is assumed as follow:

A polymer compound contained in a recording layer of a planographic printing plate precursor of the present characteristic contains (b) a copolymerization component having an alicyclic structure near carboxylic acid, as represented by the formula (2). Due to function of (a) a monomer component containing fluorine represented by the formula (1), the polymer compound tends to be localized at a surface portion of the recording layer. At printing, due to the (b) structure represented by the formula (2), a hydrophilic carboxylic acid group is blocked by an alicyclic structure in the vicinity thereof and exhibition of hydrophilicity is suppressed, whereby superior inking property is manifested at a recording layer surface.

In contrast, in a developer, by immersing the recording layer in an excessive alkali developer, excellent dissolution/dispersibility due to a carboxylic acid group thereof is manifested.

Further, by introducting an alicyclic structure to the vicinity of an acid group, there is brought a state in which a bulky hindrance exists near the acid group and thus the acid groups are prevented from interacting other. As a result, when the recording layer components, especially polymers, are dispersed in a developer, the polymers are less likely to aggregate, whereby generation of precipitates, developing scum derived from the aggregated polymers in a developer, particularly, generation of a sludge therein which is difficult to be treated and is easily adhered to a plate material, are suppressed.

In short, it is assumed that excellent lipophilicity (inking property) at a surface and an effect of suppressing generation of developing scum and sludge in a developer are made compatible.

According to the invention, there can be provided a planographic printing plate precursor which realizes both excellent developability at a non-image part and good inking property at an image part, has better image-forming property, and gives a clear image.

Further, according to the invention, a planographic printing plate precursor in which inking property at an image part is excellent, a satisfactory printed article is obtained, and even when plate making treatment is performed continuously, generation of precipitates such as developing scum and sludge in a developer is suppressed, can be obtained.

### DETAILED DESCRIPTION OF THE INVENTION

The invention will be explained in detail below.

The planographic printing plate precursor of the invention is characterized in that a recording layer contains: a polymer compound having, as copolymerization components, (a) a monomer represented by the following formula (1), (b) a monomer having an aliphatic group having 7 or more carbon atoms and having a bridge bond, and (3) a monomer having an acid group; and an infrared-ray absorbing agent.

Descriptions will be given on the important compositional components of the invention, i.e., a polymer compound having, as a copolymerization component, (a) a monomer represented by the formula (1), (b) a monomer having an aliphatic group having 7 or more carbon atoms and having a bridge bond, and (c) a monomer having an acid group (hereinafter, which polymer will be referred to as “specific copolymer”).

[Polymer Compound Having (a) Monomer Represented by the Formula (1), (b) Monomer Having Aliphatic Group Having 7 or More Carbon Atoms and Having Bridge Bond, and (c) Monomer Having Acid Group as Copolymerization Component]

(a) a monomer represented by the following formula (1), (b) a monomer having an aliphatic group having 7 or more carbon atoms and having a bridge bond, and (c) a monomer having an acid group which are a copolymerization component giving preferable property to the specific copolymer of the invention will be explained in detail.

A fluorine-containing monomer used as a copolymerization component (a) in the invention is represented by the following formula (1).

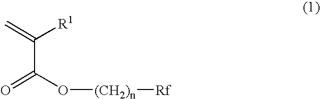

In the formula (1), Rf is a substituent containing a fluoroalkyl group or a perfluoroalkyl group having 9 or more fluorine atoms, n represents 1 or 2, and R¹ represents hydrogen or a methyl group.

The fluorine atom-containing substituent in Rf specifically includes the following fluoroalkyl (meth)acrylate.
CH₂═CRCO₂(CH₂)ₘCₙF₂ₙ₊₁
(m represents 1 or 2, n represents an integer of 4 to 12, and R represents an alkyl group having 1 to 4 carbon atoms
CH₂═CRCO₂(CH₂)ₘ(CF₂)ₙH
(m represents 1 or 2, n represents an integer 4 to 12, and R represents an alkyl group having 1 to 4 carbon atoms)

Herein, in a fluoroalkyl group or a perfluoroalkyl group represented by Rf, by using one having 9 or more fluorine atoms, a recording layer having a specific concentration distribution of a fluorine atom in a film thickness direction is formed. In this specific concentration distribution, a phenomenon is observed in which a fluorine concentration near a recording layer surface is high, while the fluorine concentration is decreased in a depth direction of a recording layer.

Inter alia, particularly, the number of fluorine atoms per monomer unit is preferably 9 to 30, more preferably 13 to 25. In this range, the effect of orienting or locating a specific copolymer on a surface is excellently manifested, and thus excellent inking property is obtained. When the number of fluorine atoms contained in one unit is too many, inking property may be reduced due to oil repellency of a fluorine atom.

From a viewpoint of achieving improvement in surface orienting property of a specific copolymer, as well as good balance between improvement in developability resistance and the inking property, a content of a fluorine atom contained in a specific copolymer is preferably in a range of 5 to 30 mmol/g, more preferably in a range of 8 to 25 mmol/g. Also when the number of fluorine atoms which are inserted and contained in a copolymer is too many, inking property is deteriorated due to oil repellency of a fluorine atom, in some cases.

A monomer used as a copolymerization component (b) in the invention is a monomer having an aliphatic group having 7 or more carbon atoms and having a bridge bond. Since such an aliphatic group having a bridge bond is present near a surface of a recording layer, high lipophilicity is imparted to an image part surface, and improvement in inking property is realized. Since this functional group is bulky as compared with a group having no bridge structure, and as a number of carbon atoms is present in a structure thereof, affinity of the component (b) for a polymer having an acid group such as an alkali-soluble resin present is significantly low. Accordingly, the copolymerization component (b) can avoid being buried in the acid group-containing polymers and are easily oriented or located at a surface of the recording layer, imparting excellent lipophilicity to the surface.

Examples of the monomer having an aliphatic group having 7 or more carbon atoms and having a bridge bond of the invention include some of the monomers exemplified in JP-A No. 2002-311577 which is a co-pending application by the applicant.

Examples of a preferable (b) monomer used in the invention [(b-1) to (b-38)] are shown below, but the invention is not limited by them.

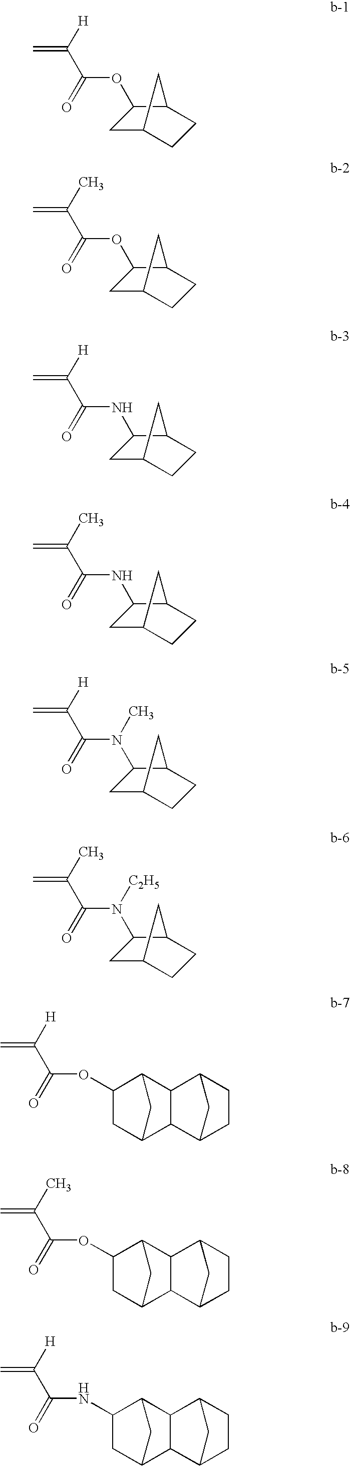

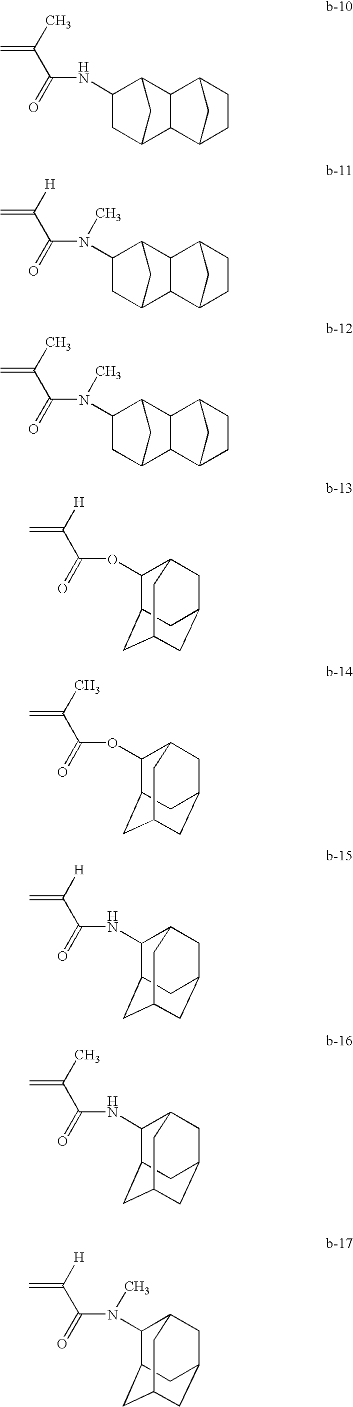

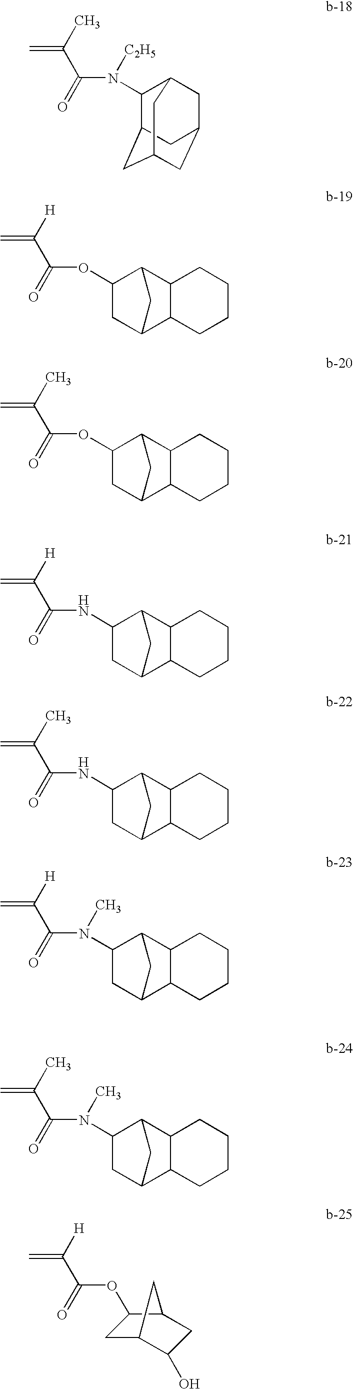

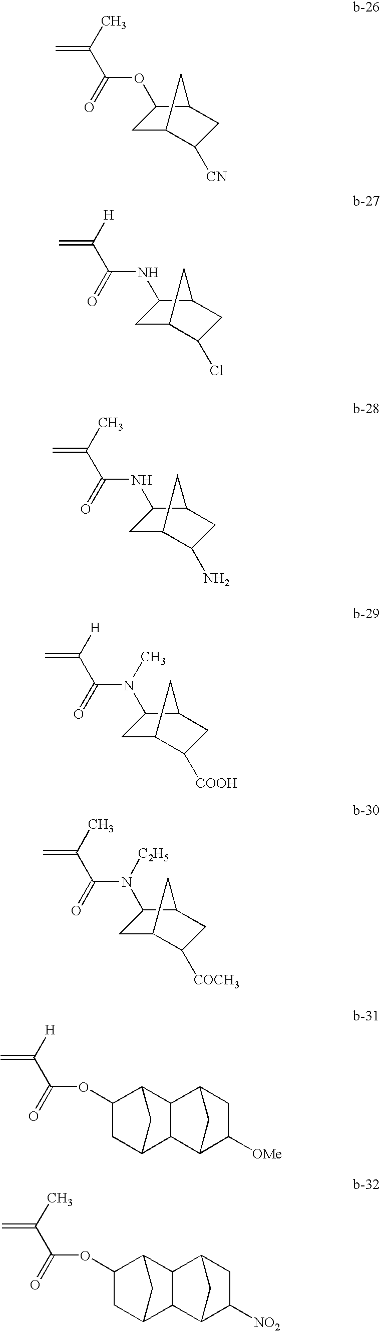

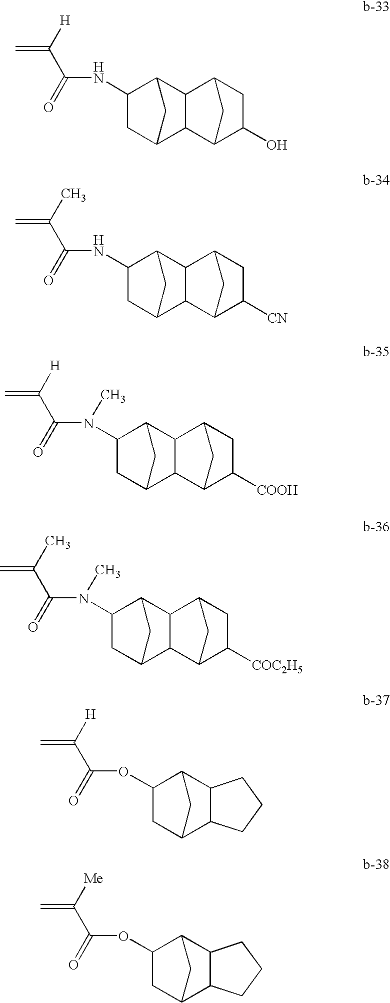

From a viewpoint of inking property improving effect, an aliphatic group having 7 or more carbon atoms and having a bridge bond, contained in a specific copolymer of the invention, is preferably introduced in a range of 0.1 to 10 mmol/g and, in this range, high inking property and excellent alkali solubility are manifested. An introduction amount is more preferably 0.2 to 8 mmol/g, and a range of 0.4 to 5 mmol/g is most preferable.

A monomer used as a copolymerization component (c) in the invention is a monomer having an acid group.

A monomer having an acid group relating to the invention is not particularly limited as far as it is a compound having one or more of acid groups and one or more polymerizable unsaturated groups in a molecule, respectively.

Among acid groups, monomers having acid groups listed in the following (1) to (6) to be contained as a copolymerization component are preferable.
(1) Phenol group (—Ar—OH).
(2) Sulfonamide group (—SO₂NH—R).
(3) Substituted sulfonamide type acid group (hereinafter, referred to as activated imide group) [—SO₂NHCOR, —SO₂NHSO₂R, —CONHSO₂R].
(4) Carboxylic acid group (—CO₂H).
(5) Sulfonic acid group (—SO₃H).
(6) Phosphoric acid group (—OPO₃H₂).

In the above-exemplified (1) to (6), Ar denotes a substituted/unsubstituted divalent aryl bonding group and R denotes a substituted/unsubstituted hydrocarbon group.

From a viewpoint of the effect, among compounds having an acid group selected from the (1) to (6), compounds having (1) a phenol group, (2) a sulfoneamide group and (4) a carboxylic acid group are preferable. Particularly, from a viewpoint of sufficient maintenance of inking property and developability, (4) a carboxylic acid group is most preferable.

(1) Examples pf a monomer having a phenolic hydroxyl group include monomers having a hydroxyaryl group on a side chain.

Examples of a monomer having a hydroxyaryl group on a side chain include those containing at least one type of monomer represented by the following formula (a).

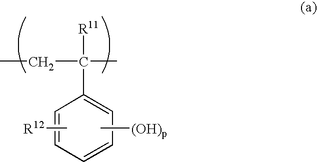

In the formula (a), R¹¹ represents a hydrogen atom or a methyl group. R¹² represents a hydrogen atom, a halogen atom, a hydrocarbon group having 10 or less carbon atoms, an alkoxy group having 10 or less carbon toms, or an aryloxy group having 10 or less carbon atoms, and p represents an integer of 1 to 3.

(2) Examples of a polymer having a sulfonamide group include polymers comprising, as a main component, a minimum structural unit derived from a compound having a sulfonamide group. Example of such compound include compounds having one or more of sulfonamide groups in which at least one hydrogen atom is bound to a nitrogen atom, and a polymerizable unsaturated group, respectively, in a molecule.

Above all, low molecular weight compounds having acryloyl group, allyl group, or vinyloxy group as well as substituted or mono-substituted aminosulfonyl group or substituted sulfonylimino group in one molecule are preferable, and practical examples thereof are those defined by the following general formulas (i) to (v).

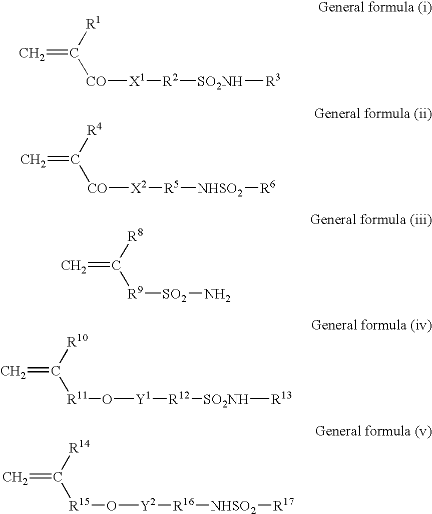

In the formula X¹ and X² independently denote —O— or NR⁷; R¹ and R⁴ independently denote hydrogen, or —CH₃; R², R⁵, R⁹, R¹² and R¹⁶ independently denote substituted/unsubstituted C₁₋₁₂ alkylene group, cycloalkylene group, arylene group, or aralkylene group; R³, R⁷, and R¹³ independently denote hydrogen, substituted/unsubstituted C₁₋₁₂ alkyl group, cycloalkyl group, aryl group, or aralkyl group; R⁶ and R¹⁷ independently denote substituted/unsubstituted C₁₋₁₂ alkyl group, cycloalkyl group, aryl group, or aralkyl group; R⁸, R¹⁰, and R¹⁴ independently denote hydrogen or —CH₃; R¹¹ and R¹⁵ independently denote C₁₋₁₂ alkylene group, cycloalkylene group, arylene group, or aralkylene group optionally having single bond or a substituent group; and Y¹ and Y² independently denote a single bond or CO.

(3) Examples of an alkali-soluble structural unit having an active imide group include minimum structural units derived from a compound having an active imide group. Examples of the aforementioned structural unit include structural units having one or more of active imide groups represented by the following structural formula, and one or more polymerizable unsaturated groups, respectively.

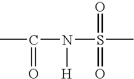

(4) Examples of an alkali-soluble structural unit having a carboxylic acid group include minimum structural units derived from a compound having one or more of carboxylic acid groups, and one or more polymerizable unsaturated groups, respectively, in a molecule.

(5) Examples of an alkali-soluble structural unit having a sulfonic acid group include minimum structural units derived from a compound having one or more of sulfonic acid groups and one or more polymerizable unsaturated groups, respectively, in a molecule.

(6) Examples of an alkali-soluble structural unit having a phosphoric group include minimum structural units derived from a compound having one or more of phosphoric acids and one or more polymerizable unsaturated groups, respectively, in a molecule.

It is not necessary that a monomer having an acidic group selected from the aforementioned (1) to (6), which constitutes a copolymer used in the invention, is particularly one kind, but a copolymer in which two or more kinds of monomers having the same acidic group, or two or more kinds of monomers having different acidic groups are introduced as a copolymerization component can be used.

An introduction amount of the acid group in the specific copolymer is not particularly limited as far as the polymer compound can be dissolved in an alkali developer at a pH of 10 to 13 due to the presence of the acid group.

The most preferable monomer containing an acidic group constituting a specific copolymer used in the invention is a monomer represented by the following formula (I).

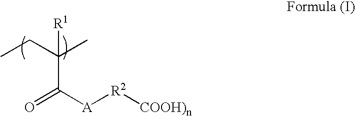

R¹ in the formula (I) represents a hydrogen atom or a methyl group, particularly preferably a methyl group. A tethering group represented by R² in the formula (I) is a tethering group having 2 to 30 atoms except for substituents, and examples include a divalent group such as alkylene, substituted alkylene, arylene, and substituted arylene, and a group having a structure in which a plurality of them are connected with an amide linkage or an ester linkage. For example, preferable examples of a tethering group of a chain structure include a structure in which alkylene such as ethylene and propylene is connected via an ester linkage.

As a tethering group represented by R², a (n+1)-valent hydrocarbon group having an aliphatic cyclic structure having 3 to 30 carbon atoms more preferable. Specific examples include compounds having an aliphatic cyclic structure such as cyclopropane, cyclopentane, cyclohexane, cycloheptane, cyclooctane, cyclodecane, dicyclohexyl, tercyclohexyl, and norbornane. Examples additionally include a (n+1)-valent hydrocarbon group which is obtained by removing (n+1) hydrogen atoms on an arbitrary carbon atom constituting a compound having an aliphatic chain structure having 5 to 20 atoms.

On or more of arbitrary carbon atoms of a compound constituting an aliphatic cyclic and chain structure may be substituted with a hetero atom selected from a nitrogen atom, an oxygen atom and a sulfur atom. Examples of a substituent which can be introduced into a tethering group represented by R² include monovalent non-metal atomic entities except for hydrogen, and examples include a halogen atom (—F, —Br, —Cl, —I), a hydroxyl group, an alkoxy group, an aryloxy group, a mercapto group, an aryl group, an alkenyl group, and an alkynyl group.

When A in the formula (I) is NR₃—, R₃ represents a hydrogen atom or a monovalent hydrocarbon group having 1 to 10 carbon atoms. Examples of a monovalent hydrocarbon group having 1 to 10 carbon atoms represented by this R₃ include an alkyl group, an aryl group, an alkenyl group, and an alkynyl group. Examples of an alkyl group include straight, branched or cyclic alkyl groups having 1 to 10 carbon atoms such as a methyl group, an ethyl group, a propyl group, a butyl group, a pentyl group, a hexyl group, a heptyl group, an octyl group, a nonyl group, a decyl group, an isopropy group, an isobutyl group, a sec-butyl group, a tert-butyl group, an isopentyl group, a neopentyl group, a 1-methylbutyl group, an isohexyl group, a 2-ethylhexyl group, a 2-methylhexyl group, a cyclopentyl group, a cyclohexyl group, a 1-adamantyl group, and a 2-norbornyl group.

A in the formula (I) is preferably an oxygen atom or —NH— because synthesis is easy.

And, n in the formula (I) represents an integer of 1 to 5 and, from a viewpoint of inking property, is preferably 1.

Since when the number of acid group, a representative of which is a carboxyl group, in a specific copolymer is too small, developability is deteriorated and, when the number is too large, desired inking property is not obtained, an acid value per one molecule of a specific copolymer is preferably 0.2 to 10.0 mmol/g, more preferably 0.3 to 5.0 mmol/g, further preferably 0.4 to 3.0 mmol/g from a viewpoint of inking property-sensitivity.

In addition to a constitutional unit composed of three kinds of monomers of the (a) to (c), other constitutional unit may be copolymerized in a specific copolymer of the invention in such a range that the effect of the invention is not deteriorated, for various purposes such as improvement in coating property.

Examples of other constitutional unit which can be jointly used include constitutional units derived from the known monomers such as acrylic acid esters, methacrylic acid esters, acrylamides, methacrylamides, vinyl esters, styrenes, acrylonitrile, maleic acid anhydride, and maleic acid imide.

Examples of the acrylic acid esters include methyl acrylate, ethyl acrylate, (n- or i-)propyl acrylate, (n-, i-, sec- or t-)butyl acrylate, amyl acrylate, 2-ethylhexyl acrylate, dodecyl acrylate, chloroethyl acrylate, 2-hydroxyethyl acrylate, 2-hydroxypropyl acrylate, 5-hydroxypentyl acrylate, cyclohexyl acrylate, allyl acrylate, trimethylolpropane monoacrylate, pentaerythritol monoacrylate, glycidyl acrylate, benzyl acrylate, methoxybenzyl acrylate, chlorobenzyl acrylate, 2-(p-hydroxyphenyl)ethyl acrylate, furfuryl acrylte, tetrahydrofurfuryl acrylate, phenyl acrylate, chlorophenyl acrylate, and sulfamoylphenyl acrylate.

Examples of the methacrylic acid esters include methyl methacrylate, ethyl methacrylate, (n- or i-)propyl methacrylate, (n-, i-, sec- or t-)butyl methacrylate, amyl methacrylate, 2-ethylhexyl methacrylate, dodecyl methacrylate, chloroethyl methacrylate, 2-hydroxyethyl methacrylate, 2-hydroxypropyl methacrylate, 5-hydroxypentyl methacrylate, cyclohexyl methacrylate, allyl methacrylate, trimethylolpropane monomethacrylate, pentaerythritol monomethacrylate, glycidyl methacrylate, methoxybenzyl methacrylate, chlorobenzyl methacrylate, 2-(p-hydroxyphenyl)ethyl methacrylate, frufuryl methacrylate, tetrahydrofrufryl methacrylate, phenyl methacrylate, chlorophenyl methacrylate, and sulfamoylphenyl methacrylate.

Examples of the acrylamides include acrylamide, N-methylacrylamide, N-ethylacrylamide, N-propylacrylamide, N-butylacrylamide, N-benzylacrylamide, N-hydroxyethylacrylamide, N-phenylacrylamide, N-tolylacrylamide, N-(p-hydroxyphenyl)acrylamide, N-(sulfamoylphenyl)acrylamide, N-(phenylsulfonyl)acrylamide, N-(tolylsulfonyl)acrylamide, N,N-dimethylacrylamide, N-methyl-N-phenylacrylamide, and N-hydroxyethyl-N-methylacrylamide.

Examples of the methacrylamides include methacrylamide, N-methylmethacrylamide, N-ethylmethacrylamide, N-propylmethacrylamide, N-butylmethacrylamide, N-benzylmethacrylamide, N-hydroxyethylmethacrylamide, N-phenylmethacrylamide, N-tolylmethacrylamide, N-(p-hydroxyphenyl)methacrylamide, N-(sulfamoylphenyl)methacrylamide, N-(phenylsulfonyl)methacrylamide, N-(tolylsulfonyl)methacrylamide, N,N-dimethylmethacrylamide, N-methyl-N-phenylmethacryamide, and N-hydroxyethyl-N-methylmethacrylamide.

Examples of the vinyl esters include vinyl acetate, vinyl butyrate, and vinyl benzoate.

Examples of the styrenes include styrene, methylstyrene, dimethylstyrene, trimethylstyrene, ethylstyrene, propylstyrene, cyclohexylstyrene, chloromethylstyrene, trifluoromethylstyrene, ethoxymethylstyrene, acetoxymethylstyrene, methoxystyrene, dimethoxystyrene, chlorostyrene, dichlorostyrene, bromostyrene, iodostyrene, fluorostyrene, and carboxystyrene.

Among these monomers which can be used jointly, acrylic acid esters, methacrylic acid esters, vinyl esters, styrenes, and acrylonitrile having 20 or less carbon atoms are preferable.

When a specific copolymer relating to the invention is used in a recording layer in a planographic printing plate precursor, specific copolymers to be used may be alone, or may be used as a mixture by using one or more kinds of other polymer compound having a fluorine-based substituent which are outside the scope of the invention. Other polymer compound having a fluorine-based substituent which can be used jointly herein is used in a range of 1 to 80% by mass, preferably 1 to 70% by mass, further preferably 1 to 60% by mass relative to a total weight of a specific copolymer relating to the invention. As a polymer compound having a fluorine-based substituent which can be used jointly, commercially available polymer compounds can be used without any limitation and, specifically, a fluorine-based surfactant which is generally used in the art is preferably used.

A weight average molecular weight of a specific copolymer in the invention is appropriately determined from a viewpoint of inking propriety and a developability. In general, when a molecular weight grows larger, although inking property is excellent, there is a tendency that developability is deteriorated. Conversely, when a molecular weight is low, although developability is better, inking property is deteriorated. A preferable molecular weight is in a range of 1,000 to 1,000,000, more preferably 2,000 to 500,000 further preferably 3,000 to 300,000 from a viewpoint of film property and inking property improving effect, and balance between handling property, solvent solubility, and uniformity upon coating.

A specific copolymer relating to the invention may be straight, branched, or may have a block structure.

Structures of polymer compounds [(P-1) to (P-51)] preferable in the invention, together with weight average molecular weights thereof are shown below, but the invention is not limited to them.

| | | Mw |
|---|---|---|
| | | 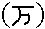 |
| P-1 | 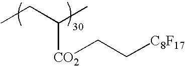 | 2.6 |
| | 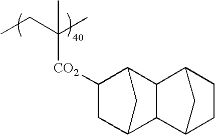 | |
| | 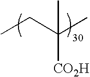 | |
| P-2 | 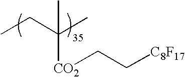 | 2.9 |
| | 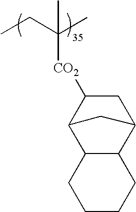 | |
| | 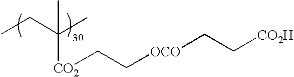 | |
| P-3 | 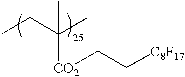 | 3.6 |
| | 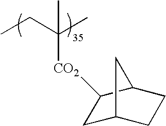 | |
| | 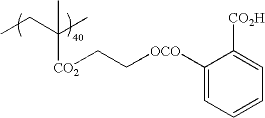 | |
| P-4 | 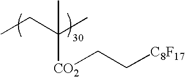 | 4.2 |
| | 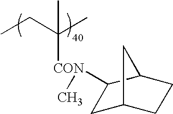 | |
| | 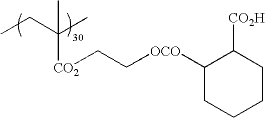 | |
| P-5 | 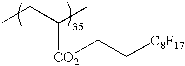 | 3.5 |
| | 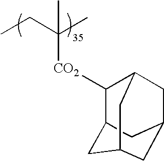 | |
| | 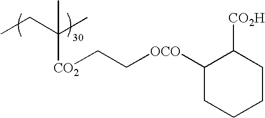 | |
| P-6 | 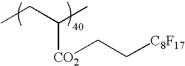 | 8.3 |
| | 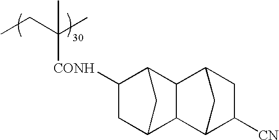 | |
| | 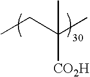 | |
| P-7 | 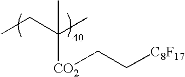 | |
| | 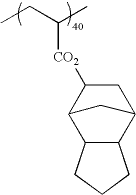 | |
| | 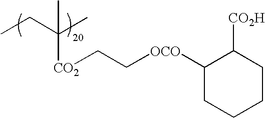 | |
| P-8 | 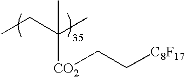 | 1.2 |
| | 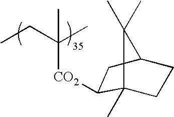 | |
| | 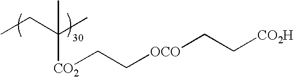 | |
| P-9 | 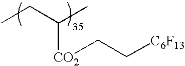 | 3.7 |
| | 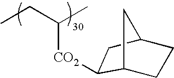 | |
| | 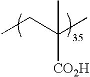 | |
| P-10 | 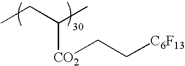 | 6.1 |
| | 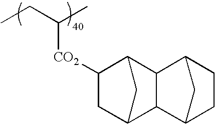 | |
| | 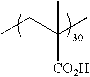 | |
| P-11 | 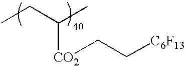 | 8.3 |
| | 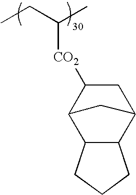 | |
| | 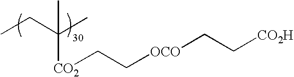 | |
| P-12 | 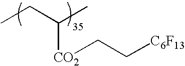 | 6.5 |
| | 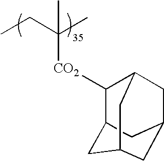 | |
| | 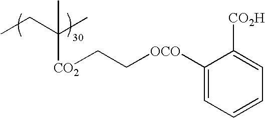 | |
| P-13 | 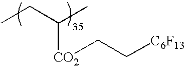 | 2.8 |
| | 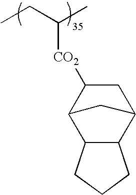 | |
| | 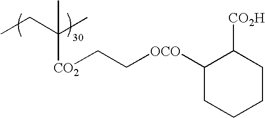 | |
| P-14 | 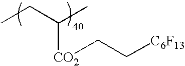 | 3.6 |
| | 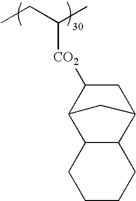 | |
| | 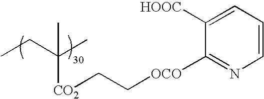 | |
| P-15 | 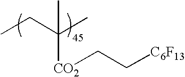 | 5.4 |
| | 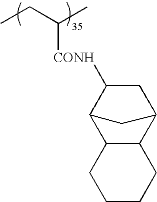 | |
| | 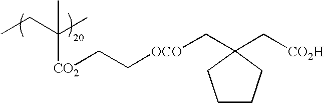 | |
| P-16 | 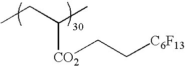 | 6.7 |
| | 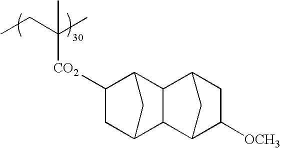 | |
| | 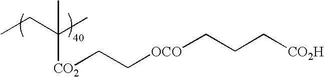 | |
| P-17 | 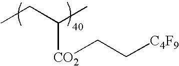 | 8.3 |
| | 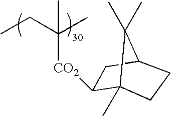 | |
| | 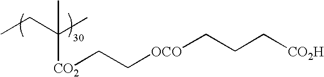 | |
| P-18 | 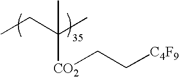 | 6.5 |
| | 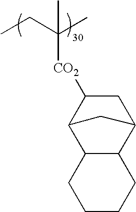 | |
| | 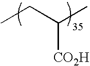 | |
| P-19 | 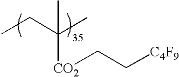 | 7.6 |
| | 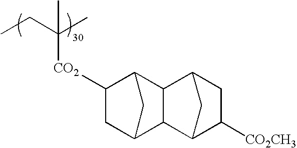 | |
| | 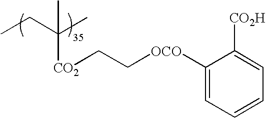 | |
| P-20 | 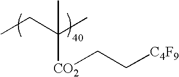 | 8.2 |
| | 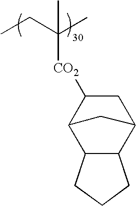 | |
| | 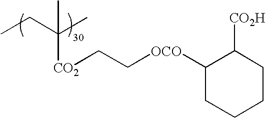 | |
| P-21 | 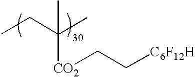 | 3.6 |
| | 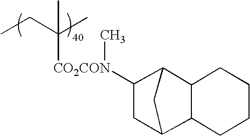 | |
| | 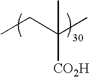 | |
| P-22 | 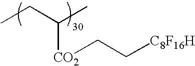 | 2.5 |
| | 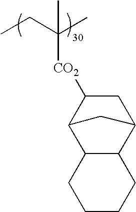 | |
| | 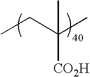 | |
| P-23 | 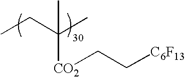 | 1.9 |
| | 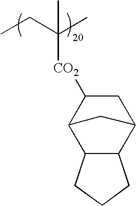 | |
| | 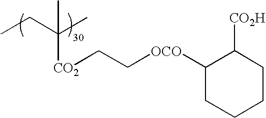 | |
| | 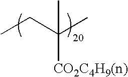 | |
| P-24 | 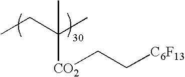 | 1.6 |
| | 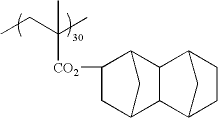 | |
| | 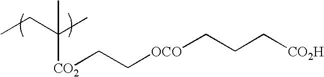 | |
| | 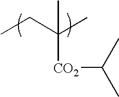 | |
| P-25 | 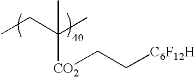 | 3.3 |
| | 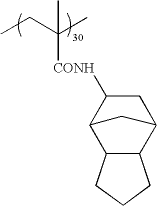 | |
| | 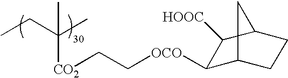 | |
| P-26 | 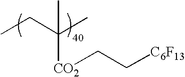 | 2.9 |
| | 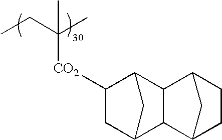 | |
| | 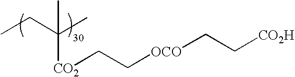 | |
| | 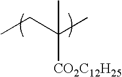 | |
| P-27 | 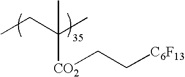 | 2.1 |
| | 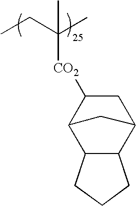 | |
| | 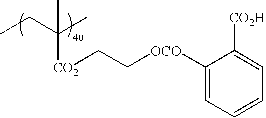 | |
| | 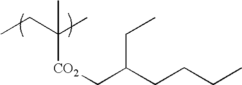 | |
| P-28 | 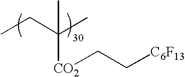 | 1.9 |
| | 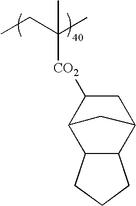 | |
| | 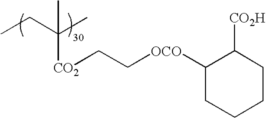 | |
| | 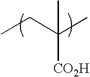 | |
| P-29 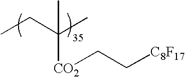 | 3.6 | |
| | 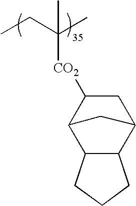 | |
| | 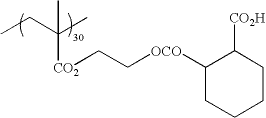 | |
| | 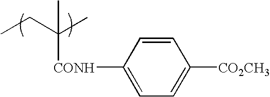 | |
| P-30 | 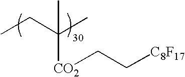 | 4.2 |
| | 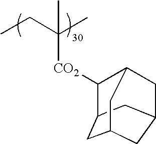 | |
| | 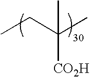 | |
| | 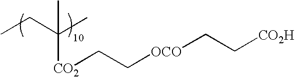 | |
| P-31 | 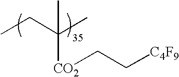 | 3.5 |
| | 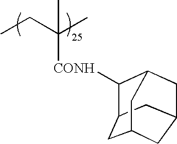 | |
| | 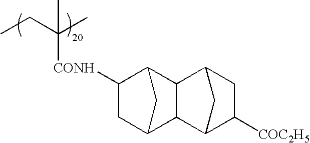 | |
| | 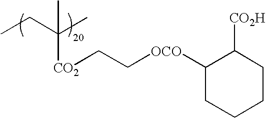 | |
| P-32 | 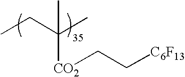 | 6.3 |
| | 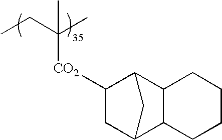 | |
| | 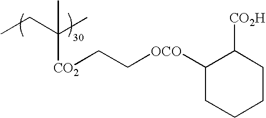 | |
| P-33 | 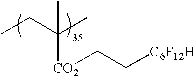 | 3.4 |
| | 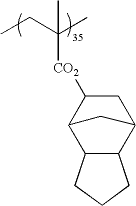 | |
| | 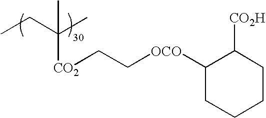 | |
| P-34 | 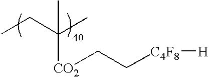 | 2.6 |
| | 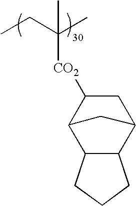 | |
| | 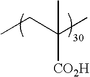 | |
| P-35 | 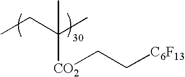 | 3.1 |
| | 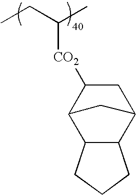 | |
| | 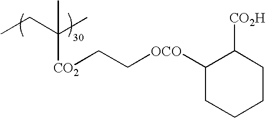 | |
| P-36 | 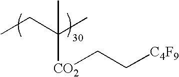 | 2.9 |
| | 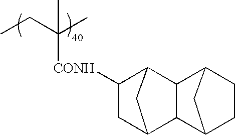 | |
| | 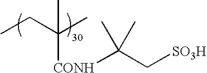 | |
| P-37 | 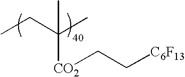 | 3.1 |
| | 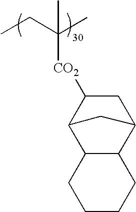 | |
| | 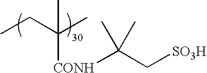 | |
| P-38 | 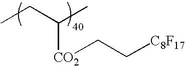 | 3.6 |
| | 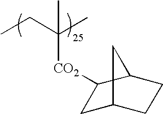 | |
| | 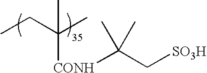 | |
| P-39 | 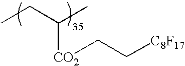 | 1.3 |
| | 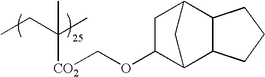 | |
| | 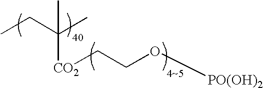 | |
| P-40 | 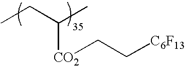 | 1.2 |
| | 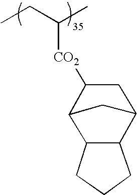 | |
| | 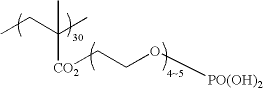 | |
| P-41 | 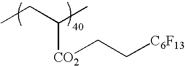 | 1.9 |
| | 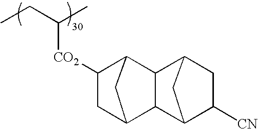 | |
| | 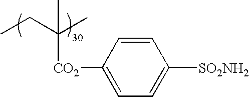 | |
| P-42 | 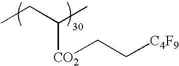 | 2.6 |
| | 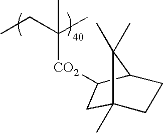 | |
| | 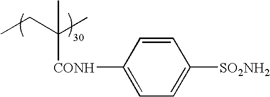 | |
| P-43 | 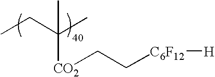 | 5.1 |
| | 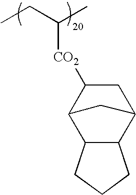 | |
| | 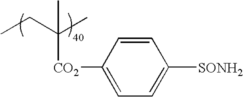 | |
| P-44 | 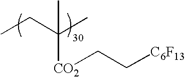 | 3.9 |
| | 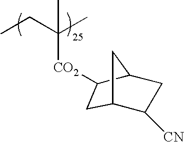 | |
| | 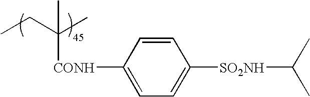 | |
| P-45 | 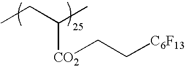 | 3.6 |
| | 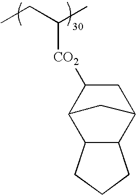 | |
| | 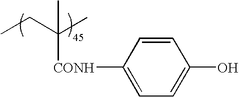 | |
| P-46 | 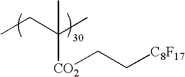 | 2.9 |
| | 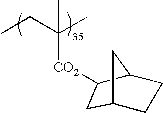 | |
| | 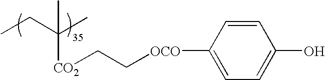 | |
| P-47 | 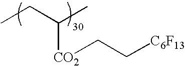 | 2.4 |
| | 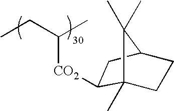 | |
| | 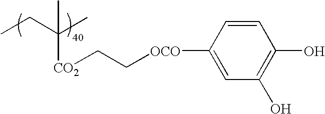 | |
| P-48 | 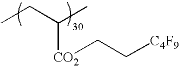 | 3.6 |
| | 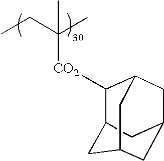 | |
| | 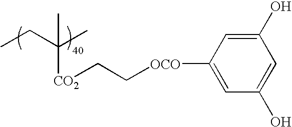 | |
| P-49 | 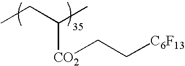 | 3.9 |
| | 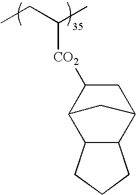 | |
| | 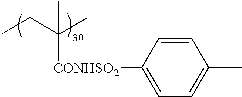 | |
| P-50 | 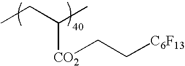 | 2.1 |
| | 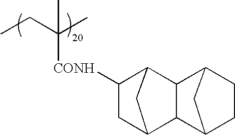 | |
| | 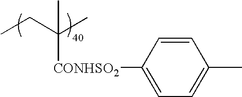 | |
| P-51 | 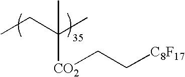 | 1.9 |
| | 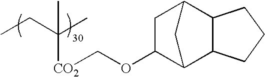 | |
| | 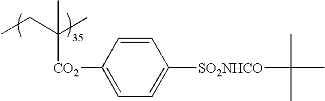 | |

A content of a specific copolymer relating to the invention in a recording layer can be appropriately determined, and is usually preferably in a range of 0.0001 to 20% by mass, more preferably 0.001 to 15% by mass, further preferably 0.01 to 10% by mass relative to a total weight of nonvolatile components in a recording layer.

[Infrared-Ray Absorbing Agent]

In a recording layer of a planographic printing plate precursor of the invention, further, an infrared-ray absorbing agent (infrared-ray absorbing dye or pigment) having absorption maximum at a wavelength of 700 nm to 1200 nm is used. An infrared-ray absorbing agent has the function of absorbing light energy irradiated ray such as infrared-ray laser used in recording and producing heat, and is useful from a viewpoint of improvement in recording sensitivity.

As a dye, commercially available dyes and the known dyes described in the publication such as “Dye Handbook” (edited by The Society of Synthetic Organic Chemistry, Japan, published in 1970) can be utilized. Examples include dyes such as azo dyes, metal complex salt azo dyes, pyrazolone azo dyes, naphthoquinone dyes, anthraquinone dyes, phthalocyanine dyes, carbonium dyes, quinoneimine dyes, methine dyes, cyane dyes, squarylium pigments, pyrilium salts, metal thiolate complexes, oxomol dyes, diimonium dyes, aminium dyes, and croconium dyes.

Preferable examples of the dye include cyanine dyes described in JP-A Nos. 58-125246, 59-84356, 59-202829, and 60-78787; methine dyes described in JP-A Nos. 58-173696, 58-181690, and 58-194595; naphthoquinone dyes described in JP-A Nos. 58-112793, 58-224793, 59-48187, 59-73996, 60-52940, and 60-63744; squalirium dyes described in JP-A No. 58-112792; and cyanine dyes described in GB Patent No. 434,875.

Other preferable examples of the dye include near infrared absorbing sensitizers described in U.S. Pat. No. 5,156,938; substituted arylbenzo(thio)pyrylium salts described in U.S. Pat. No. 3,881,924; trimethinethiopyrylium salts described in JP-A No. 57-142645 (U.S. Pat. No. 4,327,169); pyrylium type compounds described in JP-A Nos. 58-181051, 58-220143, 59-41363, 59-84248, 59-84249, 59-146063, and 59-146061; cyanine dyes described in JP-A No. 59-216146; pentamethinethiopyrylium salts described in U.S. Pat. No. 4,283,475; and pyrylium compounds described in Japanese Patent Application Publication (JP-B) Nos. 5-13514 and 5-19702.

Additional preferable examples of the dye include near infrared absorbing dyes represented by formulae (I) and (II) as described in U.S. Pat. No. 4,756,993.

Among these dyes, particularly preferable are cyanine dyes, phthalocyanine dyes, oxonol dyes, squalirium dyes, pyrylium salts, thiopyrylium dyes, and nickel thiolate complexes. Dyes represented by the following general formulae (a) to (e) are also preferable since such dyes are excellent in terms of photothermal conversion efficiency. The cyanine dyes represented by the following general formula (a) are most preferable for the following reason: when the dyes are used in the photosensitive composition of the invention, the dyes manifest a high degree of polymerizing activity, and the dyes are also excellent in terms of stability and economy.
General Formula (a)

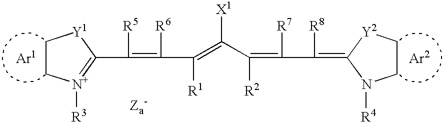

In general formula (a), X¹ represents a hydrogen atom, a halogen atom, —NPh₂, X²-L¹ (wherein X² represents an oxygen atom or a sulfur atom, L¹ represents a hydrocarbon group having 1 to 12 carbon atoms, an aromatic cyclic group having a heteroatom, or a hydrocarbon group containing a heteroatom and having 1 to 12 carbon atoms, and the heteroatom referred to herein is N, S, O, a halogen atom, or Se), or a group represented by the following: 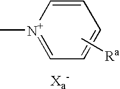
wherein Xa⁻ has the same definition as Za⁻, which will be described at a later time, and R^{a} represents a substituent selected from a hydrogen atom, an alkyl group, an aryl group, a substituted or unsubstituted amino group, or a halogen atom;
R¹ and R² each independently represents a hydrocarbon group having 1 to 12 carbon atoms, and from the viewpoint of the storage stability of the photosensitive composition of the invention when it is used in a coating solution for forming a recording layer of a planographic printing plate precursor, it is preferable that R¹ and R² each independently represents a hydrocarbon group having 2 or more carbon atoms, and more preferably R¹ and R² are bonded to each other to form a 5-membered or 6-membered ring.

Ar¹ and Ar², which may be the same or different, each represent an aromatic hydrocarbon group which may have a substituent. Preferable examples of the aromatic hydrocarbon group include benzene and naphthalene rings. Preferable examples of the substituent include hydrocarbon groups having 12 or less carbon atoms, halogen atoms, and alkoxy groups having 12 or less carbon atoms.

Y¹ and Y², which may be the same or different, each represents a sulfur atom, or a dialkylmethylene group having 12 or less carbon atoms.

R³ and R⁴, which may be the same or different, each represents a hydrocarbon group which has 20 or less carbon atoms and may have a substituent. Preferable examples of the substituent include alkoxy groups having 12 or less carbon atoms, a carboxyl group, and a sulfo group. R⁵, R⁶, R⁷ and R⁸, which may be the same or different, each represents a hydrogen atom, or a hydrocarbon group having 12 or less carbon atoms, and since the raw materials thereof can easily be obtained, each preferably represents a hydrogen atom.

Za⁻ represents a counter anion. However, in a case where the cyanine dye represented by general formula (a) has an anionic substituent in the structure thereof and there is accordingly no need to neutralize electric charges in the dye, Za⁻ is not required. From the viewpoint of the storage stability of the recording layer coating solution, Za⁻ is preferably an ion of a halogen, perchlorate, tetrafluroborate, hexafluorophosphate, carboxylate or sulfonate. From the viewpoints of compatibility of the dye with the alkali-soluble resin and solubility in the coating solution, Za⁻ is preferably a halogen ion, or an organic acid ion such as a carboxylic acid ion or sulfonic acid ion, more preferably a sulfonic acid ion, and even more preferably an arylsulfonic acid ion.

Specific examples of the cyanine dye represented by general formula (a), and which can be preferably used in the invention, include dyes in JP-A No. 2001-133969 (paragraphs [0017] to [0019]), JP-A No. 2002-40638 (paragraphs [0012] to [0038]), and JP-A No. 2002-23360 (paragraphs [0012] to [0023]), as well as dyes illustrated below. 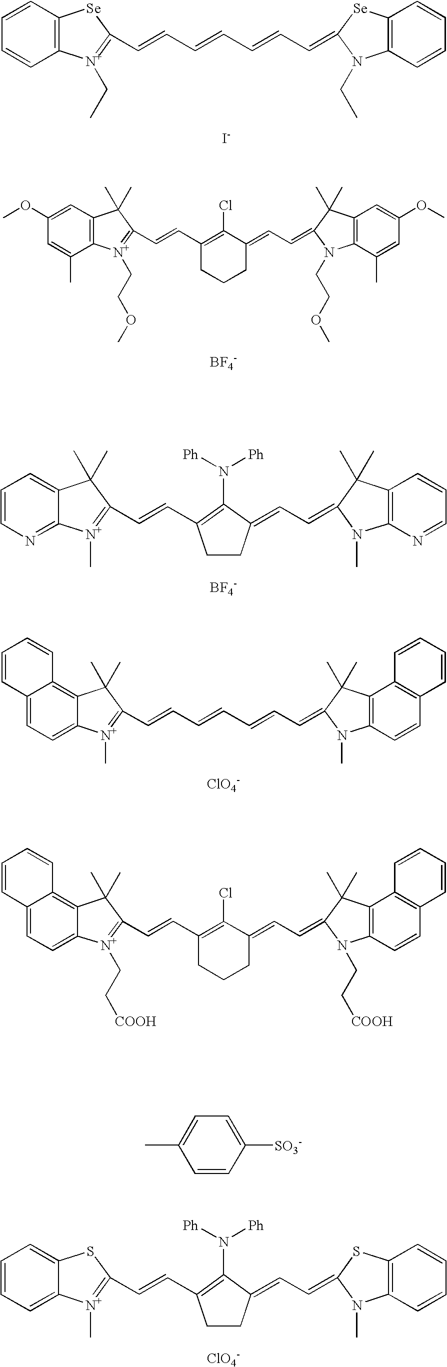 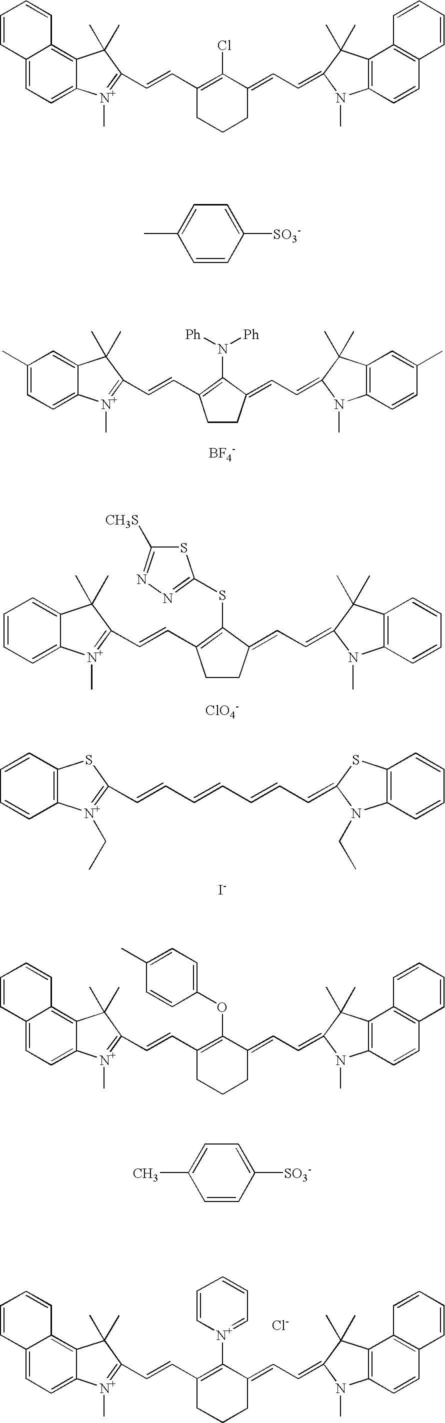 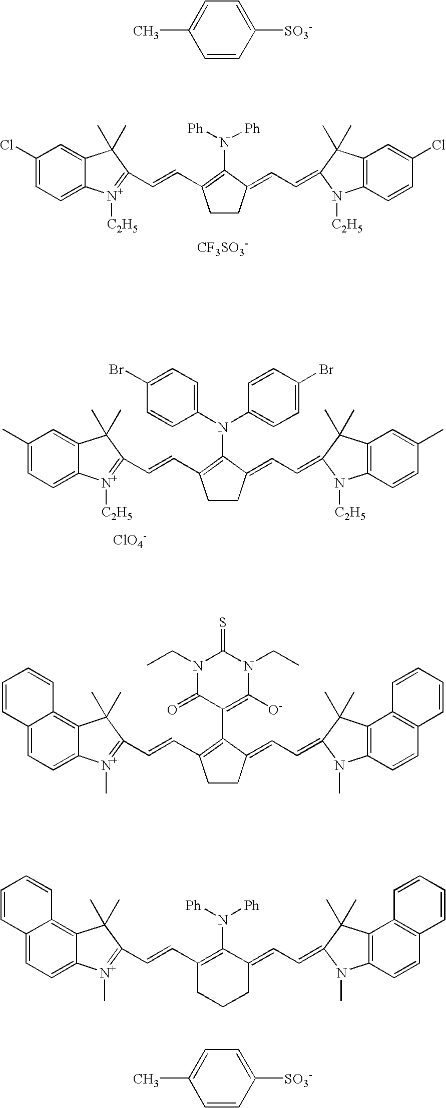
General Formula (b)

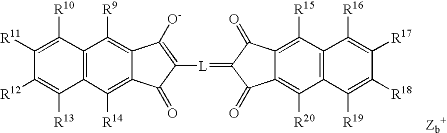

In general formula (b), L represents a methine chain having 7 or more conjugated carbon atoms, and the methine chain may have one or more substituent. The substituents may be bonded to each other to form a cyclic structure. Zb⁺ represents a counter cation. Preferable examples of the counter cation include ammonium, iodonium, sulfonium, phosphonium and pyridinium ions, and alkali metal cations (such as Ni⁺, K⁺ and Li⁺).

R⁹ to R¹⁴ and R¹⁵ to R²⁰ each independently represents a substituent selected from hydrogen atom, halogen atom, and cyano, alkyl, aryl, alkenyl, alkynyl, carbonyl, thio, sulfonyl, sulfinyl, oxy and amino groups; or a substituent obtained by combining two or three from among these substituents. Two or three out of R⁹ to R¹⁴ and R¹⁵ to R²⁰ may be bonded to each other to form a cyclic structure.

A dye wherein L in general formula (b) represents a methine chain having 7 conjugated carbon atoms, and each of R⁹ to R¹⁴ and R¹⁵ to R²⁰ represents a hydrogen atom, is preferable since such a dye can be easily obtained and exhibits advantageous effects.

Specific examples of the dye represented by general formula (b), and which can be preferably used in the invention, are illustrated below. 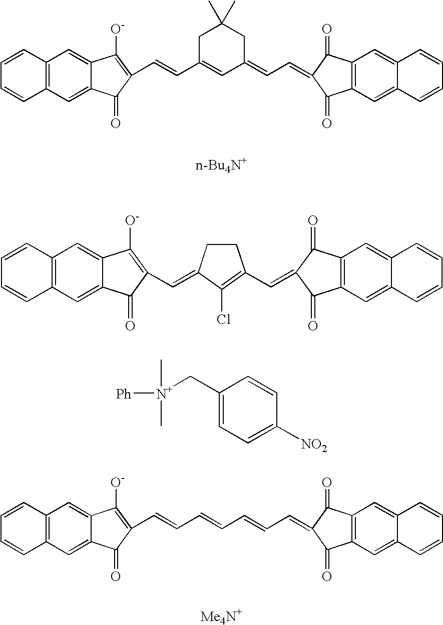
General Formula (c)

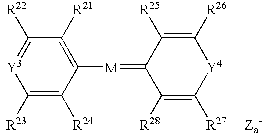

In general formula (c), Y³ and Y⁴ each independently represent an oxygen, sulfur, selenium or tellurium atom; M represents a methine chain having 5 or more conjugated carbon atoms; R²¹ to R²⁴ and R²⁵ to R²⁸, which may be the same or different, each represents a hydrogen or halogen atom, or a cyano, alkyl, aryl, alkenyl, alkynyl, carbonyl, thio, sulfonyl, sulfinyl, oxy or amino group; and Za⁻ represents a counter anion, and has the same meaning as Za⁻ in general formula (a).

Specific examples of the dye which is represented by general formula (c) and which can be preferably used in the invention, are illustrated below. 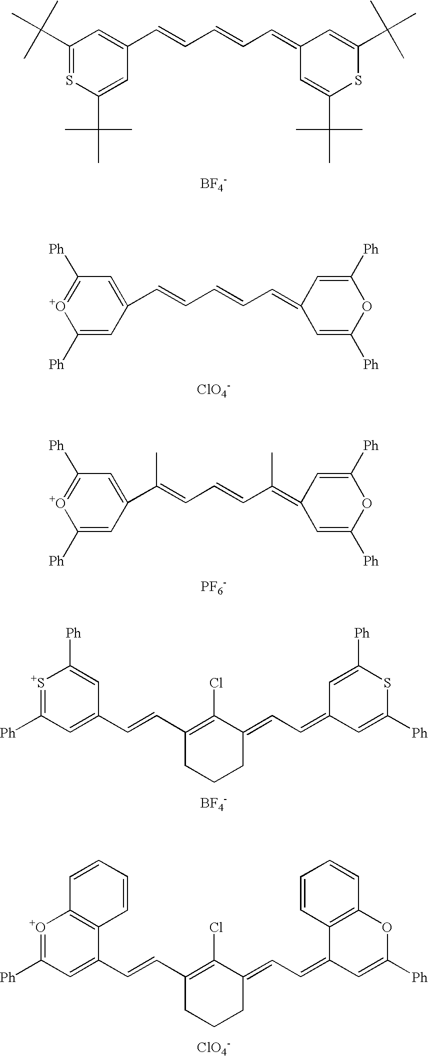
General Formula (d)

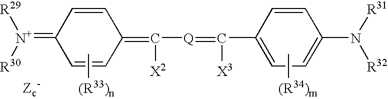

In general formula (d), R²⁹ to R³¹ each independently represents a hydrogen atom, an alkyl group or an aryl group; R³³ and R³⁴ each independently represents an alkyl group, a substituted oxy group, or a halogen atom; n and m each independently represents an integer of 0 to 4; and R²⁹ and R³⁰, or R³¹ and R³² may be bonded to each other to form a ring, or R²⁹ and/or R³⁰ may be bonded to R³³ to form a ring and R³¹ and/or R³² may be bonded to R³⁴ to form a ring. When plural R³³'s and R³⁴'s are present, R³³'s may be bonded to each other to form a ring, or R³⁴'s may be bonded to each other to form a ring.

X² and X³ each independently represents a hydrogen atom, an alkyl group or an aryl group, and at least one of X² and X³ represents a hydrogen atom or an alkyl group.

Q represents a trimethine group or a pentamethine group which may have a substituent, and may be combined with an bivalent organic group to form a cyclic structure. Zc⁻ represents a counter anion and has the same meanings as Za⁻ in general formula (a).

Specific examples of the dye represented by general formula (d) and which can be preferably used in the invention, are illustrated below.

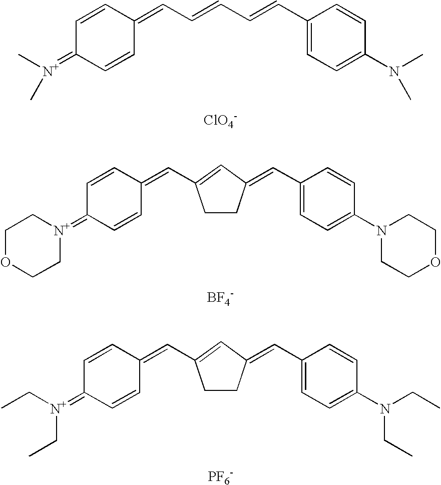

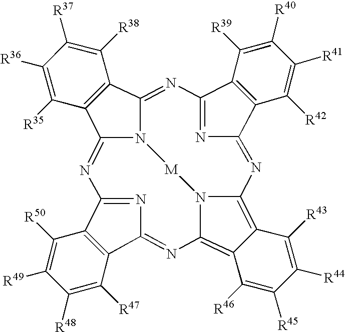

In general formula (e), R³⁵ to R⁵⁰ each independently represents a hydrogen or halogen atom, or a cyano, alkyl, aryl, alkenyl, hydroxyl, carbonyl, thio, sulfonyl, sulfinyl, oxy or amino group, or an onium salt structure, each of which may have a substituent; M represents two hydrogen atoms, a metal atom, a halo metal group, or an oxy metal group. Examples of the metal contained therein include atoms in IA, IIA, IIIB and IVB groups in the periodic table, transition metals in the first, second and third periods therein, and lanthanoid elements. Among these examples, preferable are copper, magnesium, iron, zinc, cobalt, aluminum, titanium, and vanadium.

Specific examples of the dye represented by general formula (e) and which can be preferably used in the invention, are illustrated below.

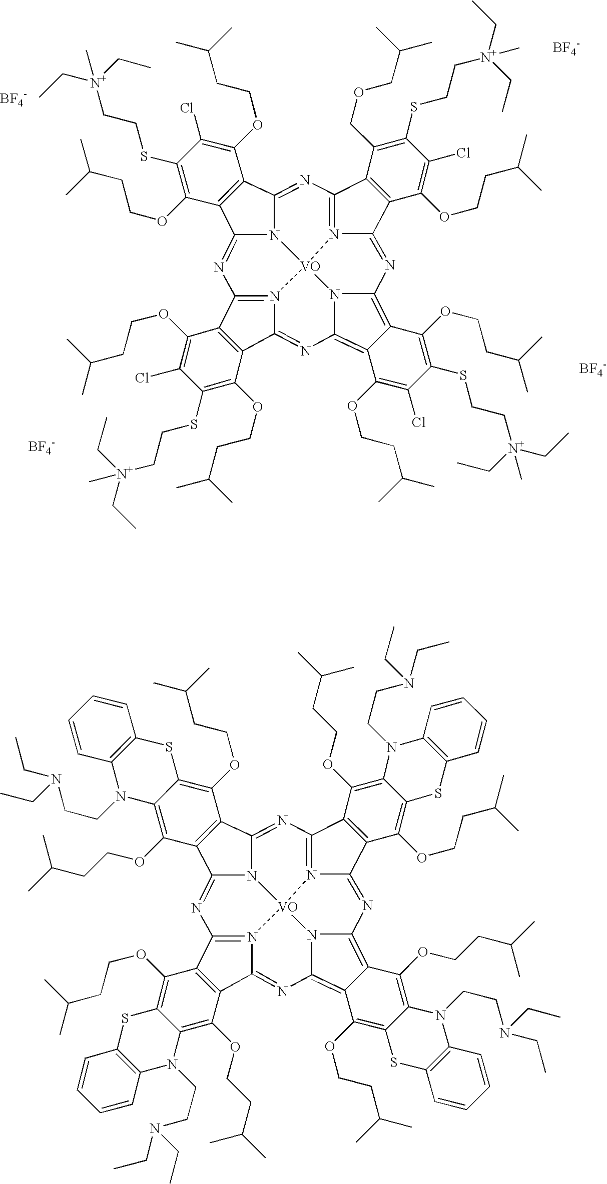

The pigment used as the infrared absorbent in the invention may be a commercially available pigment or a pigment described in publications such as Color Index (C.I.) Handbook, “Latest Pigment Handbook” (edited by Japan Pigment Technique Association, and published in 1977), “Latest Pigment Applied Technique” (by CMC Publishing Co., Ltd. in 1986), and “Printing Ink Technique” (by CMC Publishing Co., Ltd. in 1984).

Examples of the pigment include black pigments, yellow pigments, orange pigments, brown pigments, red pigments, purple pigments, blue pigments, green pigments, fluorescent pigments, metal powder pigments, and polymer-bonded dyes. Specifically, the following can be used: insoluble azo pigments, azo lake pigments, condensed azo pigments, chelate azo pigments, phthalocyanine pigments, anthraquinone pigments, perylene and perynone pigments, thioindigo pigments, quinacridone pigments, dioxazine pigments, isoindolinone pigments, quinophthalone pigments, dyeing lake pigments, azine pigments, nitroso pigments, nitro pigments, natural pigments, fluorescent pigments, inorganic pigments, and carbon black. Among these pigments, carbon black is preferable.

These pigments may be used with or without surface treatment. Examples of surface treatment include a method of coating the surface of the pigments with resin or wax; a method of adhering a surfactant onto the surface; and a method of bonding a reactive material (such as a silane coupling agent, an epoxy compound, or a polyisocyanate) to the pigment surface. The surface treatment methods are described in “Nature and Application of Metal Soap” (Saiwai Shobo), “Printing Ink Technique” (by CMC Publishing Co., Ltd. in 1984). And “Latest Pigment Applied Techlnique” (by CMC Publishing Co., Ltd. in 1986.

From a viewpoint of stability of a dispersion in a recording layer coating solution, and uniformity of a recording layer, a particle diameter of pigments is preferably in a range of 0.01 μm to 10 μm, further preferably in a range of 0.05 μm to 1 μm, particularly preferably in a range of 0.1 μm to 1 μm.

The method for dispersing the pigment may be a known dispersing technique used to produce ink or toner. Examples of a dispersing machine, which can be used, include an ultrasonic disperser, a sand mill, an attriter, a pearl mill, a super mill, a ball mill, an impeller, a disperser, a KD mill, a colloid mill, a dynatron, a three-roll mill, and a pressing kneader. Details are described in “Latest Pigment Applied Technique” (by CMC Publishing Co., Ltd. in 1986).

From the viewpoints of sensitivity, uniformity of the film to be formed and durability, the pigment or dye can be added to the recording layer in a ratio of 0.01 to 30%, preferably 0.1 to 10%, and more preferably 0.1 to 5% in the case of the dye or 0.2 to 10% in the case of pigment by mass, relative to the total solid contents of the recording layer.

[Water-Insoluble and Alkali-Soluble Resin]

From a viewpoint of improvement in film making property, it is preferable to use a water-insoluble and alkali-soluble resin (hereinafter, conveniently, referred to as alkali-soluble resin) in a recording layer relating to the invention.

An alkali-soluble resin which can be used in a positive-type recording layer includes a homopolymer containing an acidic group on a main chain and/or a side chain in a polymer, and a copolymer or a mixture thereof.

Inter alia, resins having acidic groups listed (1) to (6) exemplified in explanation of (c) an acid group-containing monomer in the specific copolymer, in a main chain and/or a side chain of a polymer are preferable from a viewpoint of solubility in an alkaline developer, and manifestation of dissolution suppressing ability.

Among alkali-soluble resins having acidic groups selected from the (1) to (6), alkali-soluble resins having (1) a phenol group, (2) a sulfonamide group and (3) an active imide group are preferable. In particular, alkali-soluble resins having (1) a phenol group or (2) a sulfone amide group are most preferable from a viewpoint of sufficient solubility in an alkaline developer, developing latitude, and film strength.

As the alkali-soluble resin comprising the acidic group selected from the above-mentioned (1) to (6), the following can be exemplified.

(1) Examples of the alkali-soluble resin comprising phenol group may include novolak resin such as condensation polymers of phenol and formaldehyde; condensation polymers of m-cresol and formaldehyde, condensation polymers of p-cresol and formaldehyde, condensation polymers of m-/p-mixed cresol and formaldehyde, and condensation polymers of phenol, cresol (m-, p-, or m-/p-mixture) and formaldehyde; and condensation copolymers of pyrogallol and acetone. Further, copolymers obtained by copolymerizing compound comprising phenyl groups in the side chains can be exemplified. Or, copolymers obtained by copolymerizing compounds comprising phenyl groups in the side chains can also be used.

As the compounds comprising phenol group, acrylamide, methacrylamide, acrylic acid ester, methacrylic acid ester, or hydroxystyrene can be exemplified.

(2) Examples of the alkali-soluble resin comprising sulfoneamido group may include polymers obtained by using the minimum component units derived from compounds comprising sulfoneamido group as main constituent components. Examples of such compounds include those having at least one sulfoneamido group comprising at least one hydrogen atom bonded to the nitrogen atom and at least one polymerizable unsaturated group, in the molecules. Among them, low molecular weight compounds comprising acryloyl, allyl, or vinyloxy group as well as substituted or mono-substituted aminosulfonyl group or a substituted sulfonylimino group in molecules are preferable and the following compounds defined by the following (i) to (v) can be exemplified.

Among compounds represented by the formula (i) to the formula (v), in the positive-type planographic printing plate precursor of the invention, particularly, m-aminosulfonylphenyl methacrylate, N-(p-aminosulfonylphenyl)methacrylamide, and N-(p-aminosulfonylphenyl)acrylamide can be suitably used.

Examples of the alkali-soluble resin having an active imide group in the item (3) include a polymer having as the main component a minimum structural unit derived from a compound having an active imide group. Examples of such a compound include a compound having in the molecule thereof one or more active imide groups represented by the following structural formula and one or more unsaturated groups which can be polymerized with the active imide group(s):

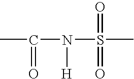

Specifically, N-(p-toluenesulfonyl)methacrylamide, N-(p-toluenesulfonyl)acrylamide and others can be preferably used.

Examples of the monomer having a carboxylic acid group in the item (4) include compounds each having in the molecule thereof one or more carboxylic acid groups and one or more unsaturated groups which can be polymerized with the carboxylic acid group(s).

Examples of the monomer having a sulfonic acid group in the item (5) include compounds each having in the molecule thereof one or more sulfonic acid groups and one or more unsaturated groups which can be polymerized with the sulfonic acid group(s).

Examples of the monomer having a phosphoric acid group in the item (6) include compounds each having in the molecule thereof one or more phosphoric acid group and one or more unsaturated groups which can be polymerized with the phophoric acid group(s).

The minimum constituent unit comprising acidic group selected from (1) to (6), composing an alkali-soluble resin to be used for the positive-type recording layer of the invention, is not necessarily limited to one particular unit, but those obtained by copolymerizing two or more minimum constituent units comprising the same acidic group or two or more minimum constituent units comprising different acidic groups can also be used.

The above-mentioned copolymer contains the compound having the acidic group selected from (1) to (6) to be copolymerized in an amount preferably 10% by mole or more, more preferably 20% by mole or more. If it is less than 10% by mole, the development latitude tends to be improved insufficiently.

In the invention, in the case the compounds are copolymerized to use the obtained copolymer as the alkali-soluble resin, the compounds to be copolymerized may include other compounds without acidic group (1) to (6). Examples of the compounds without acidic group (1) to (6) include the following compounds (m1) to (m12), however they should not be limited to these examples.
(m1) Acrylic acid esters and methacrylic acid esters having aliphatic hydroxyl groups such as 2-hydroxyethyl acrylate or 2-hydroxyethyl methacrylate.
(m2) Alkyl acrylate such as methyl acrylate, ethyl acrylate, propyl acrylate, butyl acrylate, amyl acrylate, hexyl acrylate, octyl acrylate, benzyl acrylate, 2-chloroethyl acrylate, and glycidyl acrylate.
(m3) Alkyl methacrylate such as methyl methacrylate, ethyl methacrylate, propyl methacrylate, butyl methacrylate, amyl methacrylate, hexyl methacrylate, cyclohexyl methacrylate, benzyl methacrylate, 2-chloroethyl methacrylate, and glycidyl methacrylate.
(m4) Acrylamide or methacrylamide such as acrylamide, methacrylamide, N-methylol acrylamide, N-ethylacrylamide, N-hexylmethacrylamide, N-cyclohexylacrylamide, N-hydroxyethylacrylamide, N-phenylacrylamide, N-nitrophenylacrylamide, and N-ethyl-N-phenylacxrylamide.
(m5) Vinyl ethers such as ethyl vinyl ether, 2-chloroethyl vinyl ether, hydroxyethyl vinyl ether, propyl vinyl ether, butyl vinyl ether, octyl vinyl ether, and phenyl vinyl ether.
(m6) Vinyl esters such as vinyl acetate, vinyl chloroacetate, vinyl butylate, and vinyl benzoate.
(m7) Styrenes such as styrene, α-methylstyrene, methylstyrene, and chloromethylstyrene.
(m8) Vinyl ketones such as methyl vinyl ketone, ethyl vinyl ketone, propyl vinyl ketone, and phenyl vinyl ketone.
(m9) Olefins such as ethylene, propylene, isobutylene, butadiene, and isoprene.
(m10) N-vinylpyrrolidone, acrylonitrile, and methacrylonitrile.
(m11) Unsaturated imides such as maleimide, N-acryloylacrylamide, N-acetylmethacrylamide, N-propionylmethacrylamide, and N-(p-chlorobenzoyl)methacrylamide.
(m12) Unsaturated carboxylic acid such as acrylic acid, methacrylic acid, maleic anhydride, and itaconic acid.

As the alkali-soluble resin, in terms of the excellent image formability by exposure by infrared laser, it is preferable to comprise phenolic hydroxyl groups and preferable examples of the resin to be usable are novolak resins and pyrogallol acetone resins such as phenol formaldehyde resin, m-cresol formaldehyde resin, p-cresol formaldehyde resin, m-/p-mixed cresol formaldehyde resin, and phenol/cresol (either m-, p- or m-/p-mixed) mixed formaldehyde resin.

Also, as the alkali-soluble resin having phenolic hydroxyl groups, condensed copolymers of phenol and formaldehyde comprising alkyl having 3 to 8 carbon atoms such as tert-butylphenol formaldehyde resin and octylphenol formaldehyde resin as a substituent group can be exemplified as described in U.S. Pat. No. 4,123,279.

The alkali-soluble resin has a weight average molecular weight preferably 500 or higher and more preferably 1,000 to 700,000 in terms of the image formability and has a number average molecular weight preferably 500 or higher and more preferably 700 to 650,000. The dispersion (the weight average molecular weight/the number average molecular weight) is preferably 1.1 to 10.

These alkali-soluble resins are used alone and two or more of them may be used in combination. In the case of combination, as described in U.S. Pat. No. 4,123,279, condensed polymers of phenol comprising alkyl having 3 to 8 carbon atoms as a substituent group and formaldehyde such as condensed polymer of tert-butylphenol and formaldehyde, condensed polymer of octyl phenol and formaldehyde, and as described in Japanese Patent Application Laid-Open No. 2000-241972 previously applied by inventors, alkali-soluble resins having phenol structure having electron attractive group in an aromatic ring may be used in combination.

The total content of the alkali-soluble resins in the invention is preferably 30 to 98% by weight and more preferably 40 to 95% by weight in total solid components of the image recording material.

[Other Additives]

(Dissolution Suppressing Agent)

In a positive-type recording layer relating to the invention, further, a substance which is thermally degradable and, in the not degraded state, substantially reduces solubility of an alkali-soluble resin, such as an onium salt, an o-quinonediazide compound, an aromatic sulfone compound and an aromatic sulfonic acid ester compound can be used together. Addition of these compounds is preferable from a viewpoint of improvement in dissolution suppressing ability of an image part in a developer.

Examples of an onium salt include a diazonium salt, an ammonium salt, a phosphonium salt, a iodonium salt, a sulfonium salt, a selenonium salt, and an arsonium salt. An onium salt is added preferably at 1 to 50% by mass, more preferably at 5 to 30% by mass, particularly preferably at 10 to 30% by mass relative to a total solid matter constituting an image recording material.

Further, for the purpose of improving sensitivity, cyclic acid anhydrides, phenols, and organic acids may be used.

A ratio of the cyclic acid anhydride, phenols and organic acids occupying in a recording layer is preferably 0.05 to 20% by mass, more preferably 0.1 to 15% by mass, particularly preferably 0.1 to 10% by mass.

In addition to them, an epoxy compound, vinyl ethers, a phenol compound having a hydroxymethyl group described in JP-A No. 8-276558, a phenol compound having an alkoxymethyl group, and a crosslinking compound having alkali dissolution suppressing action described in JP-A No. 11-160860 which has been previously proposed by the present inventors may be appropriately added depending on the purpose.

In addition, in order to widen stability of treatment on developing condition, a nonionic surfactant described in JP-A No. 62-251740 and JP-A No. 3-208514, and an amphoteric surfactant described in JP-A No. 59-121044 and 4-13149 may be added to a recording layer in the invention.

A sensitizing agent for obtaining a visible image immediately after heating by exposure, and a dye and a pigment as an image coloring agent may be added to a recording layer in the invention.

Further, if necessary, a plasticizer is added to a recording layer in the invention for imparting flexibility of a coated film. For example, oligomers and polymers of butylphthalyl, polyethylene glycol, tributyl citrate, diethyl phthalate, dibutyl phthalate, dihexyl phthalate, dioctylphthalate, tricresyl phosphate, tributyl phosphate, trioctyl phosphate, tetrahydrofurfuryl oleate, acrylic acid or methacrylic acid are used.

[Preparation of Planographic Printing Plate Precursor]

A planographic printing plate precursor can be prepared by dissolving components for a coating solution of a desired layer, such as a recording layer coating solution and a protecting layer coating solution relating to the invention in a solvent, and coating the solution on a suitable support.

A recording layer may exhibit a monolayered structure or a multilayered structure.

When a recording layer of a planographic printing plate precursor of the present invention takes a multilayered structure consisting of a plurality of layers having different constitutional components, a construction may be adopted in which, for example, the layer has a lower layer containing an alkali-soluble resin, and an upper layer which contains an alkali-soluble resin, and a compound interacting with the alkali-soluble resin to reduce solubility in an aqueous alkali solution, and can form an image by irradiation with infrared-ray, and a particular infrared-ray absorbing agent is contained in at least one of the upper layer and the lower layer. In this case, a specific copolymer and an infrared-ray absorbing agent in the invention are contained in an upper layer. A lower limit may be a layer containing an alkali-soluble resin as a main component, or a layer which contains an infrared-ray absorbing agent or a dissolution suppressing agent, and functions as a positive-type recording layer.

The case where a recording layer relating to the invention takes a layered structure will be explained below.

Lower Layer Components

A lower layer relating to the invention is characterized in that it contains an alkali-soluble resin. As an alkali-soluble resin used herein, the aforementioned general alkali-soluble resin may be used, but in order to make a boundary between an upper layer and a lower layer, it is preferable that an alkali-soluble resin used in a lower layer has a different main component from that of an alkali-soluble resin used in an upper layer. As an alkali-soluble resin suitably used in a lower layer, an alkali-soluble resin having a highly polar unit such as a copolymer of N-(p-aminosulfonylphenyl)(meth)acrylamide, (meth)acrylic acid alkyl ester and acrylonitrile, a copolymer of 4-maleimidebenzenesulfonamide and styrene, and a copolymer of (meth)acrylic acid, N-phenylmaleimide and (meth)acrylamide, or those resins in which the particular substituent is introduced are preferably used, but the invention is not limited to them.

From a viewpoint of printing durability and multilayered layer forming property, a content of a total alkali-soluble resin in a lower layer of such multilayered-type recording layer is preferably 50 to 100% by mass, more preferably 75 to 99% by mass, particularly preferably 85 to 95% by mass in a total solid matter of a lower layer recording layer.

A lower layer may or may not contain the aforementioned specific copolymer.

As a lower layer component relating to the invention, if necessary, other additive may be used. Examples of other additive include a developing promoter, a surfactant, a sensitizing agent/a coloring agent, a plasticizer, and WAX agent. Details of these components are as described above.

Upper Layer Components

An upper layer relating to the invention is characterized in that it contains an alkali-soluble resin, and a compound which interacts with the alkali-soluble resin to reduce solubility in an aqueous alkali solution (generally, an infrared-ray absorbing pigment such as a cyanine pigment having that function), and can form an image by irradiation with infrared-ray. This upper layer component is the same as that explained as a recording layer previously and, in the invention, a recording layer containing the specific copolymer and infrared-ray absorbing agent is used as an upper layer.

Examples of a solvent used for coating a recording layer are not limited to, but include ethylene dichloride, cyclohexanone, methyl ethyl ketone, methanol, ethanol, propanol, ethylene glycol monomethyl ether, 1-methoxy-2-propanol, 2-methoxyethyl acetate, 1-methoxy-2-propyl acetate, dimethoxyethane, methyl lactate, ethyl lactate, N,N-dimethylacetamide, N,N-dimethylformamide, tetramethylurea, N-methylpyrrolidone, dimethylsulfoxide, sulfolane, γ-butyrolactone, toluene, and water. These solvents are used alone, or by mixing them.

A concentration of the above components (total solid matter including an additive) in a solvent is preferably 1 to 50% by mass.

As a coating method, various methods can be used. Examples include bar coater coating, rotation coating, spray coating, curtain coating, dipping coating, air knife coating, blade coating, and roll coating.

A surfactant for improving coating property, for example, a fluorine-based surfactant described in JP-A No. 62-170950 may be added to a recording layer coating solution relating to the invention. A preferable additional layer is 0.01 to 1% by mass, further preferably 0.05 to 0.5% by mass in terms of a solid matter in a recording layer.

In a multilayered-type recording layer, it is preferable that a lower layer and an upper layer are formed in principle to be separated two layers.

Examples of a method of formation of two separated layers include a method of utilizing a difference in solvent solubility between components contained in a lower layer, and components contained in an upper layer, and a method of coating an upper layer, and rapidly drying and removing a solvent.

These methods will be explained in detail below, and a method of coating two separated layers is not limited to them.

A method of utilizing a difference in solvent solubility between components contained in a lower layer and components contained in an upper layer is to use a solvent system in which all components contained in a lower layer are insoluble, when coating of a coating solution for an upper layer. Thereby, even when two layers are coated, it becomes possible to clearly separate each layer to make a coated film. For example, a component which is in soluble in a solvent such as methyl ethyl ketone and 1-methoxy-1-2-propanol which dissolves an alkali-soluble resin as an upper layer component is selected, a lower layer is coated and dried using a solvent system which dissolves the lower layer component and, thereafter, an upper layer component containing an alkali-soluble resin as a main component is dissolved in methyl ethyl ketone or 1-methoxy-2-propanol, thereby, it becomes possible to form two layers.

Then, examples of a method of drying a solvent extremely rapidly after coating of a second layer (upper layer) include a method of blowing a high pressure air through a slit nozzle disposed approximately vertical to a running direction of a web, a method of imparting heat energy as conducting heat from a lower surface of a web from a roll (heating roll) in which a heating medium such as steam has been supplied to an inside thereof, and a combination of those methods.

Alternatively, in order to impart new function, an upper layer and a lower layer are partially compatibilized actively in such a range that the effect of the invention is sufficiently exerted, in some cases. As such method, in any of the aforementioned method of utilizing difference in solvent solubility, and the method of drying a solvent extremely rapidly after coating of a second layer, this becomes possible by adjusting an extent thereof.

A coating amount (solid matter) of a recording layer on a support obtained after coating and drying is different depending on utility and, as a coating amount grows smaller, apparent sensitivity is increased, but film property of a recording layer is reduced.

From a viewpoint of sensitivity and printing durability, a coating amount of recording layer components after drying in a monolayered-type recording layer is generally preferably in a range of 0.5 to 5.0 g/m², more preferably in a range of 0.7 to 4.0 g/m², further preferably in a range of 0.8 to 3.0 g/m².

From a viewpoint of sensitivity and printing durability, a coating amount of lower layer components after drying in a multilayered-type recording layer is preferably in a range of 0.5 to 4.0 g/m², further preferably in a range of 0.6 to 2.5 g/m². From a viewpoint of sensitivity, developing latitude and damage resistance, a coating amount of upper layer components after drying is preferably in a range of 0.05 to 1.0 g/m², further preferably in a range of 0.08 to 0.7 g/m².

From a viewpoint of sensitivity, image reproductivity, and printing durability, a coating amount of combined lower layer and upper layer after drying is preferably in a range of 0.6 to 4.0 g/m², further preferably in a range of 0.7 to 2.5 g/m².

[Support]

The support which is used in the planographic printing plate precursors of the invention may be any plate-form product that has necessary strength and endurance and is dimensionally stable. Examples thereof include a paper sheet; a paper sheet on which a plastic (such as polyethylene, polypropylene, or polystyrene) is laminated; a metal plate (such as an aluminum, zinc, or copper plate), a plastic film (such as a cellulose diacetate, cellulose triacetate, cellulose propionate, cellulose lactate, cellulose acetate lactate, cellulose nitrate, polyethylene terephthalate, polyethylene, polystyrene, polypropylene, polycarbonate, or polyvinyl acetal film); and a paper or plastic film on which a metal as described above is laminated or vapor-deposited.

Of these supports, a polyester film or an aluminum plate is preferable in the invention. An aluminum plate is particularly preferable since the plate is good in dimensional stability and relatively inexpensive. Preferable examples of the aluminum plate include a pure aluminum plate, and alloy plates comprising aluminum as the main component and a small amount of different elements. A plastic film on which aluminum is laminated or vapor-deposited may be used. Examples of the different elements contained in the aluminum alloy include silicon, iron, manganese, copper, magnesium, chromium, zinc, bismuth, nickel, and titanium. The content by percentage of the different elements in the alloy is at most 10% by mass.

In the invention, pure aluminum is particularly preferable. However, completely pure aluminum is not easily produced from the viewpoint of metallurgy technology. Thus, aluminum containing a trance amount of the different elements may be used.

As described above, the aluminum plate used in the invention, the composition of which is not specified, may be any aluminum plate that has been known or used hitherto. The thickness of the aluminum plate used in the invention is generally from about 0.1 to 0.6 mm, preferably from 0.15 to 0.4 mm, and more preferably from 0.2 to 0.3 mm.

Such aluminum plate may be subjected to surface treatment such as surface roughening treatment and anode oxidation treatment if necessary. Such surface treatment will be briefly explained below.

Before the surface of the aluminum plate is roughened, the plate is subjected to degreasing treatment with a surfactant, an organic solvent, an aqueous alkaline solution or the like if desired, in order to remove rolling oil on the surface. The roughening treatment of the aluminum plate surface is performed by any one of various methods, for example, by a mechanically surface-roughening method, or a method of dissolving and roughening the surface electrochemically, or a method of dissolving the surface selectively in a chemical manner.

The mechanically surface-roughening method which can be used may be a known method, such as a ball polishing method, a brush polishing method, a blast polishing method or a buff polishing method. The electrochemically surface-roughening method may be a method of performing surface-roughening in a hydrochloric acid or nitric acid electrolyte by use of alternating current or direct current. As disclosed in JP-A No. 54-63902, a combination of the two may be used.

The aluminum plate the surface of which is roughened as described above is subjected to alkali-etching treatment and neutralizing treatment if necessary. Thereafter, the aluminum plate is subjected to anodizing treatment if desired, in order to improve the water holding ability or wear resistance of the surface. The electrolyte used in the anodizing treatment of the aluminum plate is any one selected from various electrolytes which can make a porous oxide film. There is generally used sulfuric acid, phosphoric acid, oxalic acid, chromic acid, or a mixed acid thereof. The concentration of the electrolyte may be appropriately decided dependently on the kind of the electrolyte.

Conditions for the anodizing treatment cannot be specified without reservation since the conditions vary dependently on the used electrolyte. The following conditions are generally suitable: an electrolyte concentration of 1 to 80% by mass, a solution temperature of 5 to 70° C., a current density of 5 to 60 A/dm², a voltage of 1 to 100 V, and an electrolyzing time of 10 seconds to 5 minutes. If the amount of the anodic oxide film is less than 1.0 g/m², the printing durability is insufficient or non-image areas of the planographic printing plate are easily injured so that the so-called “injury stains”, resulting from ink adhering to injured portions at the time of printing, are easily generated.

If necessary, the aluminum surface is subjected to treatment for hydrophilicity after the anodizing treatment.

The treatment for hydrophilicity which can be used in the invention may be an alkali metal silicate (for example, aqueous sodium silicate solution) method, as disclosed in U.S. Pat. Nos. 2,714,066, 3,181,461, 3,280,734, and 3,902,734. In this method, the support is subjected to immersing treatment or electrolyzing treatment with aqueous sodium silicate solution. Besides, there may be used a method of treating the support with potassium fluorozirconate disclosed in JP-B No. 36-22063 or with polyvinyl phosphonic acid, as disclosed in U.S. Pat. Nos. 3,276,868, 4,153,461, and 4,689,272.

(Undercoat Layer)

In the planographic printing plate precursor of the invention, an undercoat layer may further be provided, as necessary, between the support and the recording layer.

As components for the undercoat layer, various organic compounds may be used. Examples thereof include carboxymethylcellulose, dextrin, gum arabic, phosphonic acids having an amino group such as 2-aminoethylphosphonic acid, organic phosphonic acids such as phenylphosphonic acid, naphthylphosphonic acid, alkylphosphonic acid, glycerophosphonic acid, methylenediphosphonic acid and ethylenediphosphonic acid, each of which may have a substituent, organic phosphoric acids such as phenylphosphoric acid, naphthylphosphoric acid, alkylphosphoric acid and glycerophosphoric acid, each of which may have a substituent, organic phosphinic acids such as phenylphosphinic acid, naphthylphosphinic acid, alkylphosphinic acid, and glycerophosphinic acid, each of which may have a substituent, amino acids such as glycine and β-alanine, and hydrochlorides of amines having a hydroxyl group, such as hydrochloride of triethanolamine. These may be used in a mixture form.

It is also preferable that an undercoating layer contains a compound having an onium group. A compound having an onium group is described in detail in JP-A No. 2000-10292 and 2000-108538. Besides, a compound selected from a group of polymer compounds having a structural unit, a representative of which is poly(p-vinyl benzoate), in a molecule may be used. More specifically, examples of the polymer compound include a copolymer of p-vinyl benzoate and a vinylbenzyltriethylammonium salt, and a copolymer of p-vinyl benzoate and vinylbenzyltrimethylammonium chloride.

This organic undercoat layer can be formed by the following method: a method of dissolving the above-mentioned organic compound into water, an organic solvent such as methanol, ethanol or methyl ethyl ketone, or a mixed solvent thereof to prepare a solution, applying the solution onto an aluminum plate, and drying the solution to form the undercoat layer; or a method of dissolving the above-mentioned organic compound into water, an organic solvent such as methanol, ethanol or methyl ethyl ketone, or a mixed solvent thereof to prepare a solution, dipping an aluminum plate into the solution to cause the plate to adsorb the organic compound, washing the plate with water or the like, and then drying the plate to form the undercoat layer.

In the former method, the solution of the organic compound having a concentration of 0.005 to 10% by mass can be applied by various methods. In the latter method, the concentration of the organic compound in the solution is from 0.01 to 20% by mass, preferably from 0.05 to 5% by mass, the dipping temperature is from 20 to 90° C., preferably from 25 to 50° C., and the dipping time is from 0.1 second to 20 minutes, preferably from 2 seconds to 1 minute.

The pH of the solution used in this method can be adjusted into the range of 1 to 12 with a basic material such as ammonia, triethylamine or potassium hydroxide, or an acidic material such as hydrochloric acid or phosphoric acid. A yellow dye can be added to the solution in order to improve the reproducibility of the tone of the image recording material.

The coated amount of the organic undercoat layer is suitably appropriately from 2 to 200 mg/m², and preferably from 5 to 100 mg/m², in terms of obtaining sufficient printing durability.

An image forming material thus formed is ordinarily subjected to image exposure and development process.

(Back Coating Layer)

If necessary, a back coating layer is disposed on a support back of a planographic printing plate precursor of the invention. As such back coating layer, a covering layer consisting of an organic polymer compound described in JP-A No. 5-45885, and a metal oxide obtained by hydrolysis and polycondensation of an organic or inorganic metal compound described in JP-A No. 6-35174 is preferably used. Among these covering layers, an alkoxy compound of silicon such as Si(OCH₃)₄, Si(OC₂X₅)₄, Si(OC₃H₇)₄, and Si(OC₄H₉)₄ is inexpensive and easily available, and a covering layer of metal oxide derived therefrom is excellent in developer resistance, and is particularly preferable.

[Exposure]

As a light source of active light used in image exposure of a planographic printing plate precursor of the invention, a light source having a light emitting wavelength in a near infrared to infrared region is preferable, and a solid laser, and a semiconductor laser are particularly preferable.

[Developing Treatment]

The developing solution which may be applied to the developing treatment of the planographic printing plate precursor of the invention is a developing solution having a pH range from 9.0 to 14.0 and preferably a pH range from 12.0 to 13.5. As the developing solution (hereinafter referred to as a developing solution including a replenishing solution), a conventionally known aqueous alkali solution may be used.

Examples of the alkali agent include inorganic alkali salts such as sodium silicate, potassium silicate, trisodium phosphate, tripotassium phosphate, triammonium phosphate, disodium hydrogenphosphate, dipotassium hydrogenphosphate, diammonium hydrogenphosphate, sodium carbonate, potassium carbonate, ammonium carbonate, sodium hydrogencarbonate, potassium hydrogencarbonate, ammonium hydrogen carbonate, sodium borate, potassium borate, ammonium borate, sodium hydroxide, ammonium hydroxide, potassium hydroxide and lithium hydroxide; and organic alkali agents such as monomethylamine, dimethylamine, trimethylamine, monoethylamine, diethylamine, triethylamine, monoisopropylamine, diisopropylamine, triisopropylamine, n-butylamine, monoethanolamine, diethanolamine, triethanolamine, monoisopropanolamine, diisopropanolamine, ethyleneimine, ethylenediamine, and pyridine.

These alkali agents may be used alone or in combinations of two or more thereof.

Among the above aqueous alkali solutions, one developer which exerts the effect of the invention is an aqueous solution of a pH 12 or higher so-called “silicate developer” containing alkali silicate as a base, or containing alkali silicate obtained by mixing a base with a silicon compound, and the other more preferable developer is a so-called “non-silicate developer” which does not contain alkali silicate, and contains a non-reducing sugar (organic compound having buffering action) and a base.

In the former, developability of an aqueous solution of alkali metal silicate can be regulated by a ratio (generally expressed by mole ratio of [SiO₂]/[M₂O]) of silicon oxide SiO₂ and alkali metal oxide M₂O. For example, an aqueous solution of sodium silicate in which a mole ratio of SiO₂/Na₂O is 1.0 to 1.5 (that is,[SiO₂]/[Na₂O] is 1.0 to 1.5), and a content of SiO₂ is J to 4% by mass as disclosed in JP-A No. 54-62004, and an aqueous solution of alkali metal silicate in which [SiO₂]/[M] is 0.5 to 0.75 (that is, [SiO₂]/[M₂O] is 1.0 to 1.5), a concentration of SiO₂ is 1 to 4% by mass, and the developer contains at least 20% potassium using gram atom of a total alkali metal present therein as a standard, as described in Japanese Patent Application Publication (JP-B) No. 57-7427 are preferably used.

A so-called “non-silicate developer” containing no alkali silicate and containing non-reducing sugar and a base is also preferable for application to developing of a planographic printing plate precursor of the invention. When a planographic printing plate precursor is developing-treated using this developer, a surface of a recording layer is not deteriorated, and inking property of a recording layer can be maintained in the letter state.

This developer contains, as its component, at least one compound selected from a non-reducing sugar, and a least one kind, a base, and it is preferable that a pH of the solution is in a range of 9.0 to 13.5. Such non-reducing sugar is a sugar having no free aldehyde group or ketone group, and not exhibiting reducing property, and is classified into a trehalose-type oligosaccharide in which reducing groups are bound, a glycoside in which a reducing group of a sugar and a non-sugar are bound, and sugar alcohol obtained by hydrogenating sugars to reduce them, and any of them is suitable used.

Examples of the trehalose type oligosaccharides include saccharose and trehalose. Examples of the glucosides include alkylglucosides, phenolglucosides, and mustard seed oil glucoside. Examples of the sugar alcohols include D, L-arabite, ribitol, xylitol, D, L-sorbitos, D, L-mannitol, D, L-iditol, D, L-talitol, dulcitol, and allodulcitol. Furthermore, maltitol, obtained by hydrogenating a disaccharide, and a reductant obtained by hydrogenating an oligosaccharide (i.e., reduced starch syrup) are preferable. Of these examples, sugar alcohol and saccharose are more preferable. D-sorbitol, saccharose, and reduced starch syrup are even more preferable since they have buffer effect within an appropriate pH range and are inexpensive.

These nonreducing sugars may be used alone or in combination of two or more thereof. The percentage thereof in the developer is preferably from 0.1 to 30% by mass, more preferably from 1 to 20% by mass from the viewpoints of the buffer effect and the developing power of the solution.

The base combined with the nonreducing sugar(s) may be an alkali agent that has been known so far. Examples thereof include inorganic alkali agents such as sodium hydroxide, potassium hydroxide, lithium hydroxide, trisodium phosphate, tripotassium phosphate, triammonium phosphate, disodium phosphate, dipotassium phosphate, diammonium phosphate, sodium carbonate, potassium carbonate, ammonium carbonate, sodium hydrogencarbonate, potassium hydrogencarbonate, ammonium hydrogencarbonate, sodium borate, potassium borate and ammonium borate; and
organic alkali agents such as monomethylamine, dimethylamine, trimethylamine, monoethylamine, diethylamine, triethylamine, monoisopropylamine, diisopropylamine, triisopropylamine, n-butylamine, monoethanolamine, diethanolamine, triethanolamine, monoisopropanolamine, diisopropanolamine, ethyleneimine, ethylenediamine, and pyridine.

The bases may be used alone or in combination of two or more. Among the bases, sodium hydroxide and potassium hydroxide are preferable. The reason is that pH adjustment can be made in a wide pH range by regulating the amount of the alkali agent to be added to the non-reducing sugar. Also, trisodium phosphate, sodium carbonate, potassium carbonate or the like itself have a buffer action and are hence preferable.

These alkali agents are added so that a pH of the developer be in a range of 9.0 to 13.5. The amount depends on the desired pH and the type and additional amount of non-reducing sugar, and more preferable pH range is 10.0 to 13.2.

In a developer, further, an alkaline buffer consisting of a weak acid and a strong base other than sugars can be used. As such weak acid used as a buffer, weak acids having a dissociation constant (pKa) of 10.0 to 13.2 are preferable.

Examples of such weak acid are selected from those described in IONISATION CONSTANTS OF ORGANIC ACIDS IN AQUEOUS SOLUTION published by Pergamin Press, and include alcohols such as 2,2,3,3-tetrafluoropropanol-1 (pKa 12.74), trifluoroethanol (pKa 12.37), trichloroethanol (pKa 12.24), aldehydes such as pyridine-2-aldehyde (pKa 12.68), and prydine-4-aldehyde (pKa 12.05), compounds having a phenolic hydroxyl group such as salicylic acid (pKa 13.0), 3-hydroxy-2-naphthoic acid (pKa 12.84), catechol (pKa 12.6), gallic acid (pKa 12.4), sulfosalicylic acid (pKa 11.7), 3,4-dihydroxysulfonic acid (pKa 12.2), 3,4-dihydroxybenzoic acid (pKa 11.94), 1,2,4-trihydroxybenzene (pKa 11.82), hydroquinone (pKa 11.56), pyrogallol (pKa 11.34), o-cresol (pKa 10.33), resorcinol (pKa 11.27), p-cresol (pKa 10.27), and m-cresol (pKa 10.09), oximes such as 2-buthanoneoxime (pKa 12.45), acetoxime (pKa 12.42), 1,2-cyclohectanedionedioxime (pKa 12.3), 2-hydroxybenzaldehydeoxime (pKa 12.10), dimethylglyoxime (pKa 11.9), ethanediamidodioxime (pKa 11.37), and acetophenoneoxime (pKa 11.35), nucleic acid-associated substances such as adenosine (pKa 12.56), inosine (pKa 12.5), guanine (pKa 12.3), cytosine (pKa 12.2), hypoxanthine (pKa 12.1), and xanthine (pKa 11.9), diethylaminomethylphosphonic acid (pKa 12.32), 1-amino-3,3,3-trifluorobenzoic acid (pKa 12.29), isopropylidenediphosphonic acid (pKa 12.10), 1,1-ethylidenediphosphonic acid (pKa 11.54), 1-hydroxy 1,1-ethylidenediphosphonate (pKa 11.52), benzimidazole (pKa 12.86), thiobenzamide (pKa 12.8), picolinethioamide (pKa 12.55), and barbituric acid (pKa 12.5).

Among these weak acids, preferable are sulfosalicylic acid, and salicylic acid. As a base to be combined with these weak acids, sodium hydroxide, ammonium hydroxide, potassium hydroxide, and lithium hydroxide are preferably used. These alkali agents are used alone, or by combining two or more kinds. The above various alkali agents are used by adjusting a pH in a preferable range by a concentration and a combination.

If necessary, various surfactants and organic solvents may be added to a developer in order to enhance promotion of developability, dispersing of a developing work-up and inkphilicity at a printing plate image part. Examples of a preferable surfactant include anionic, cationic, nonionic and amphoteric surfactants.

Preferable examples of surfactants include nonionic surfactants such as polyoxyethylene alkyl ethers, polyoxyethylene alkyl phenyl ethers, polyoxyethylene polystyryl phenyl ethers, polyoxyethylene polyoxypropylene alkyl ethers, glycerin fatty acid partial esters, sorbitan fatty acid partial esters, pentaerythritol fatty acid partial esters, propylene glycol monofatty acid esters, sucrose fatty acid partial esters, polyoxyethylene sorbitan fatty acid partial esters, polyoxyethylene sorbitol fatty acid partial esters, polyethylene glycol fatty acid esters, polyglycerin fatty acid partial esters, polyoxyethylenated castor oils, polyoxyethylene glycerin fatty acid partial esters, fatty acid diethanolamides, N,N-bis-2-hydroxyalkylamines, polyoxyethylenealkylamine, triethanolamine fatty acid ester, and trialkylamine oxide, anionic surfactants such as fatty acid salts, abietic acid salts, hydroxyalkanesulfonic acid salts, alkanesulfonic acid salts, dialkylsulfosuccinic acid ester salts, straight alkylbenzenesulfonic acid salts, branched alkylbenzenesulfonic acid salts, alkylnaphthalenesulfonic acid salts, alkylphenoxypolyoxyethylene propyl sulfonic acid salts, polyoxyethylene alkylsulfophenyl ether salts, N-methyl-N-oleyl taurine sodium salt, N-alkylsulfosuccinic acid monoamide disodium salt, petroleum sulfonic acid salts, sulfated tallow soil, fatty acid alkyl ester sulfuric acid ester salts, alkyl sulfate ester salts, polyoxyethylene alkyl ether sulfate ester salts, fatty acid monoglyceride sulfate ester salts, polyoxyethylene alkyl phenyl ether sulfate ester salts, polyoxyethylene styryl phenyl ether sulfate ester salts, alkyl phosphate ester salts, polyoxyethylene akyl etser phosphate ester salts, polyoxyethylene alkyl phenyl ether phosphate ester salts, partially saponified styrene/maleic acid anhydride copolymer, partially saponified olefin/maleic acid copolymer, and naphthalene sulfonic acid salt formalin condensates, cationic surfactants such as alkylamine salts, quaternary ammonium salts such as tetrabutyl ammonium bromide, polyoxyethylene alkylamide salts, and polyethylene polyamine derivative, and amphoteric surfactants such as carboxybetaines, aminocarboxylic acids, sulfobetaines, amino sulfate esters, and imidazolines. Polyoxyethylene referred in the above surfactants can be exchangeably read into polyoxyalkylene such as polyoxymethylene, polyoxypropylene, and polyoxybutylene, and those surfactants are also included.

A further preferable surfactant is a fluorine-based surfactant containing a perfluoroalkyl group in a molecule. Examples of such fluorine-based surfactant include anionic type such as perfluoroalkylcarboxylic acid salt, perfluoroalkylsulfonic acid salt, and perfluoroalkylphosphoric acid ester, amphoteric type such as perfluoroalkylbetaine, cationic type such as perfluoroalkyltrimethylammonium salt, and nonionic type such as perfluoroalkylamine oxide, perfluoroalkylethylene oxide adduct, perfluoroalkyl group and hydrophilic group-containing oligomer, perfluoroalkyl group and lipophilic group-containing oligomer perfluoroalkyl group, hydrophilic group and lipophilic group-containing oligomer, and perfluoroalkyl group and lipophilic group-containing urethane. The above surfactants may be used alone, or by combining two or more kinds, and are added to a developer in a range of 0.001 to 10% by mass, more preferably 0.01 to 5% by mass.

In a developer, various developing stabilizing agents can be used. Preferable examples of them include a polyethylene glycol adduct of sugar alcohol, a tetraalkylamonium salt such as tetrabutylammonium hydroxide, a phosphonium salt such as tetrabutylphosphonium bromide, and a iodonium salt such as diphenyliodonium chloride described in JP-A No. 6-282079. Further examples include an anionic surfactant and an amphoteric surfactant described in JP-A No. 50-51324, a water-soluble cationic polymer described in JP-A No. 55-95946, and a water-soluble amphoteric polymer electrolyte described in JP-A No. 56-142528.

Further examples include an organic boron compound with alkylene glycol added thereto described in JP-A No. 59-84241, a polyoxyethylene.polyoxypropylene block polymerization-type water-soluble surfactant described in JP-A No. 60-111246, an alkylenediamine compound in which polyoxyethylene.polyoxypropylene is substituted described in JP-A No. 60-129750, polyethylene glycol having a weight average molecular weight of 300 or more described in JP-A No. 61-215554, a fluorine-containing surfactant having a cationic group described in JP-A No. 63-175858, and a water-soluble ethylene oxide-added compound, and a water-soluble polyalkylene compound obtained by adding 4 more or more of ethylene oxide to an acid or an alcohol described in JP-A No. 2-39157.

An organic solvent is added to a developer if necessary. As the organic solvent, an organic solvent having solubility in water of about 10% by mass or less is suitable, and preferably an organic solvent is selected from organic solvents having solubility in water of 5% by mass or less. Examples include 1-phenylethanol, 2-phenylethanol, 3-phenyl-1-propanol, 4-phenyl-1-butanol, 4-phenyl-2-butanol, 2-phenyl-1-butanol, 2-phenoxyethanol, 2-benzyloxyethanol, o-methoxybenzyl alcohol, m-methoxybenzyl alcohol, p-methoxybenzyl alcohol, benzyl alcohol, cyclohexanol, 2-methylcyclohexanol, 3-methylcyclohexanol, 4-methylcyclohexanol, N-phenylethanolamine, and N-phenyldiethanolamine.

A content of an organic solvent is 0.1 to 5% by mass relative to a total mass of a solution used. A use amount thereof is closely related with a use amount of a surfactant. It is preferable that as an amount of an organic solvent is increased, an amount of a surfactant is increased. This is because when an amount of surfactant is small, and a large amount of an organic solvent is used, an organic solvent is not completely dissolved, therefore, maintenance of better developability can not be expected.

A reducing agent can be further added to a developer. This prevents stain of a printing plate. Examples of a preferable organic reducing agent include a phenol compound such as thiosalicylic acid, hydroquinone, methol, methoxyquinone, resorcine, and 2-methylresorcine, and an amine compound such as phenylenediamine, and phenylhydrazine. Examples of a further preferable inorganic reducing agent include a sodium salt, a potassium salt, and an ammonium salt of an inorganic acid such as sulfurous acid, hydrogen sulfurous acid, phosphorous acid, hydrogen phosphorous acid, dihydrogen phosphorous acid, thiosulfuric acid and dithionic acid.

Among these reducing agents, a reducing agent particularly excellent in stain preventing effect is a sulfite salt. These reducing agents are contained in a developer upon use preferably in a range of 0.05 to 5% by mass.

Organic carboxylic acid may further added to a developer. Preferable organic carboxylic acid is aliphatic carboxylic acid and aromatic carboxylic acid having 6 to 20 carbon atoms. Specific examples of aliphatic carboxylic acid include caproic acid, enathylic acid, caprylic acid, lauric acid, myristic acid, palmitic acid and stearic acid, and particularly preferable is alkanoic acid having 8 to 12 carbon atoms. Carboxylic acid may be an unsaturated fatty acid having a double bond in a carbon chain, or a branched carbon chain. Aromatic carboxylic acid is a compound in which benzene ring, a naphthalene ring, or an anthracene ring is substituted with a carboxylic group, and examples include o-chlorobenzoic acid, p-chlorobenzoic acid, o-hydoxybenzoic acid, p-hydroxybenzoic acid, o-aminobenzoic acid, p-aminobenzoic acid, 2,4-dyhydroxybenzoic acid, 2,5-dihydroxybenzoic acid, 2,6-dihdroxybenzoic acid, 2,3-dihydroxybenzoic acid, 3,5-dihydroxybenzoic acid, gallic acid, 1-hydroxy-2-naphthoic acid 3-hydroxy-2-naphthoic acid, 2-hydroxy-1-naphthoic acid, 1-naphthoic acid, and 2-naphthoic acid. Hydroxynaphthoic acid is particularly effective.

It is preferable to use the aforementioned aliphatic or aromatic carboxylic acid as a sodium salt, a potassium salt or an ammonium salt in order to enhance water solubility. A content of organic carboxylic acid in a developer used in the invention is not particularly limited. When the content is less than 0.1% by mass, the effect is not sufficient and, when the content is 10% or more, not only the effect is not improved more, but also this prevents dissolution upon use of another additive. Therefore, a preferable addition amount is 0.1 to 10% by mass, more preferably 0.5 to 4% by mass relative to a developer.

If necessary, a developer may further contain an antiseptic, a coloring agent, a thickener, an anti-foaming agent and hard water softening agent. Examples of a hard water softening agent include polyphosphoric acid and a sodium salt, a potassium salt and an ammonium salt thereof, aminopolycarboxylic acid such as ethylenediaminetetraacetic acid, diethylenetriaminepentaacetic acid, triethylenetetraminehexaacetic acid, hydroxyethylethylenediaminetriacetic acid, nitrilotriacetic acid, 1,2-diaminocyclohexanetetraacetic acid, and 1,3-diamino-2-propanoltetraacetic acid, and a sodium salt, a potassium salt and an ammonium salt thereof, aminotri(methylenephosphonic acid), ethylenediaminetetra(methylenephosphonic acid), diethylenetriaminepenta(methylenephosphonic acid), triethylenetetraminehexa(methylenephosphonic acid), hydroxyethylethylenediaminetri(methylenephosphonic acid) and 1-hydroethane-1,1-diphosphonic acid, and a sodium salt, a potassium salt and an ammonium salt thereof.

An optimal value of such hard water softening agent varies depending on chelating thereof, and a hardness of hard water to be used, and an amount of hard water. A general use amount is in a range of 0.01 to 5% by mass, more preferably 0.01 to 0.5% by mass relative to a developer upon use. When an addition amount is smaller than this range, desired purpose is not sufficiently attained and, when an addition amount is larger than this range, this adversely influences on an image part, such as decoloration. A remaining component of a developer is water. It is advantageous from a viewpoint of transportation that a developer is formulated into a concentrated solution having a smaller content of water than that at use, and the solution is diluted with water upon use. A concentration degree in this case is suitably such an extent that each component is not separated or precipitated.

As a developer to be used in the invention, the developer described in JP-A No. 6-282079 can be also used. This is a developer containing an alkali metal silicate salt having a mole ratio of SiO₂/M₂O (M represents an alkali metal) of 0.5 to 2.0, and a water-soluble ethylene oxide-added compound obtained by adding 5 mole or more of ethylene oxide to sugar alcohol having 4 or more of hydroxyl groups. Sugar alcohol is a polyhydric alcohol corresponding to an entity in which an aldehyde group or a ketone group of a sugar is reduced to a primary or secondary alcohol group. Examples of sugar alcohol include D, L-D, L-threit, erythrit, D, L-aribit, ribit, xilit, D, L-sorbit, D, L-mannit, D, L-igit, D, L-talit, dulcit, and allodulcit. Further examples include di-, tri-, tetra-, penta- and hexaglycerin which are fused with sugar alcohol. The water-soluble ethylene oxide-added compound is obtained by adding 5 mole or more of ethylene oxide to 1 mole of the sugar alcohol. Further, if necessary, propylene oxide may be block-copolymerized with an ethylene oxide-added compound in such a range that solubility is acceptable. These ethylene oxide-added compounds may be used alone, or by combining two or more kinds.

An addition amount of these water-soluble ethylene oxide-added compounds is suitably 0.001 to 5% by mass, more preferably 0.001 to 2% by mass relative to a developer (use solution).

The aforementioned various surfactants and organic solvents may be further added to this developer, if necessary, for the purpose of enhancing promotion of developability, dispersing of developing work-up, and inkphilicity at a printing plate image part.

A planographic printing plate precursor which has been developing-treated with a developer having such composition is post-treated with washing water, a rinse solution containing a surfactant, or a finisher or a protecting gum solution containing, as a main component, gum arabic or a starch derivative. For post-treatment of the planographic printing plate precursor of the invention, these treatments can be used by variously combining them.

In recent years, automatic developing machines for printing plate precursors have been widely used in order to rationalize and standardize plate-making processes in the plate-making and printing industries. These automatic developing machines are generally made up of a developing section and a post-processing section. Specifically, the machine includes a device for carrying printing plate precursors, various treating solution tanks, and spray devices. These machines are machines for spraying respective treating solutions, which are pumped up, onto an exposed printing plate through spray nozzles, for development, while the printing plate is transported horizontally.

Recently, a method has also attracted attention in which a printing plate precursor is immersed in treating solution tanks filled with treating solutions and conveyed by means of in-liquid guide rolls, to effect development. Further, there has been known a method in which rinsing is carried out with a small predetermined amount of rinsing water supplied onto the printing plate after development and the waste water is re-used as the diluting water for the original developer.

Such automatic processing can be performed while replenishers are being replenished into the respective treating solutions in accordance with the amounts to be treated, operating times, and other factors. Further, a so-called use-and-dispose processing manner can also be used, in which treatments are conducted with treating solutions which in practice have not yet been used.

In the planographic printing plate precursor of the present invention, in cases where unnecessary image portions (for example, a film edge mark of an original picture film) are present on a planographic printing plate obtained by exposing imagewise a planographic printing plate precursor to which the invention is applied, developing the exposed precursor, and subjecting the developed precursor to water-washing and/or rinsing and/or desensitizing treatment(s), unnecessary image portions can be erased.

The erasing is preferably performed by applying an erasing solution to unnecessary image portions, leaving the printing plate as it is for a given time, and washing the plate with water, as described in, for example, JP-B No. 2-13293. This erasing may also be performed by a method of radiating active rays introduced through an optical fiber onto the unnecessary image portions, and then developing the plate, as described in JP-A No. 59-174842.

The planographic printing plate obtained as described above is, if desired, coated with a desensitizing gum, and subsequently the plate can be made available for a printing step. When it is desired to make a planographic printing plate have a higher degree of printing resistance, baking treatment is applied to the planographic printing plate.

In a case where the planographic printing plate is subjected to the baking treatment, it is preferable that before the baking treatment takes place the plate is treated with a surface-adjusting solution as described in JP-B No. 61-2518, or JP-A Nos. 55-28062, 62-31859 or 61-159655.

This method of treatment is, for example, a method of applying the surface-adjusting solution onto the planographic printing plate with a sponge or absorbent cotton infiltrated with the solution, a method of immersing the planographic printing plate in a vat filled with the surface-adjusting solution, or a method of applying the surface-adjusting solution to the planographic printing plate with an automatic coater. In a case where after application the amount of solution applied is made uniform with a squeegee or a squeegee roller, a better result can be obtained.

In general, the amount of surface-adjusting solution applied is suitably from 0.03 to 0.8 g/m² (dry mass). If necessary the planographic printing plate onto which the surface-adjusting solution is applied can be dried, and then the plate is heated to a high temperature by means of a baking processor (for example, a baking processor (BP-1300) sold by Fuji Photo Film Co., Ltd.) or the like. In this case the heating temperature and the heating time, which depend on the kind of components forming the image, are preferably from 180 to 300° C. and from 1 to 20 minutes, respectively.

If necessary, a planographic printing plate subjected to baking treatment can be subjected to treatments which have been conventionally conducted, such as a water-washing treatment and gum coating. However, in a case where a surface-adjusting solution containing a water soluble polymer compound or the like is used, the so-called desensitizing treatment (for example, gum coating) can be omitted. The planographic printing plate obtained as a result of such treatments is applied to an offset printing machine or to some other printing machine, and is used for printing on a great number of sheets.

### EXAMPLES

The invention will be explained by way of examples, which, however, do not limit the scope of the invention.

(Preparation of Support)

Using a JIS-A-1050 aluminum plate having a thickness of 0.3 mm, the aluminum plate was treated by combining the following steps to prepare supports A, B, C and D.

(a) Mechanical Surface Roughening Treatment

While a suspension containing a polishing agent (silica sand) with a specific gravity of 1.12 and water was supplied as a polishing slurry to the a surface of each aluminum sheet, the and mechanical surface roughening was carried out by rotating roller type nylon brushes. The average particle size of the polishing agent was 8 μm and the maximum particle size was 50 μm. The material of the nylon brushes was 6-10 nylon and hair length and hair diameters were 45 mm and 0.3 mm, respectively. The nylon brushes were produced by implanting the hairs densely in holes formed in stainless cylinders with a diameter of φ300 mm. Three rotating brushes were used. Two supporting rollers (φ200 mm diameter) were placed in lower parts of the brushes with a separation distance of 300 mm. The brush rollers were pushed until the load of the driving motor for rotating the brushes was increased by 7 kW or more from the load before the brush rollers being pushed against the aluminum sheet. The rotation direction of the brushes was the same as the moving direction of the aluminum sheet. The rotation speed of the brushes was 200 rpm.

(b) Alkaline Etching Treatment

Etching treatment was carried out by spraying an aqueous NaOH solution (NaOH concentration being 26% by weight and also containing an aluminum ion 6.5% by weight) to the aluminum plate at 70° C., to dissolve the aluminum sheet by an amount of 6 g/m². After that, the aluminum sheet was washed with water by spraying.

(c) Desmut Treatment

Desmut treatment was carried out by spraying an aqueous solution of 1% by weight nitric acid (containing an aluminum ion at concentration of 0.5% by weight) at 30° C., and then the resulting aluminum sheet was washed with water. As the aqueous nitric acid solution used for the desmutting, waste solution from a step of the electrochemical surface roughening in an aqueous nitric acid solution by AC (alternate current) was used.

(d) Electrochemical Surface Roughening Treatment

Electrochemical surface roughening treatment was be carried out continuously by using 60 Hz AC voltage. The electrolytic solution used in this case was an aqueous solution of nitric acid (the concentration being 10.5 g/L and also containing aluminum ion by 5 g/L) at 50° C. The electrochemical surface roughening was carried out using an AC power waveform which had a trapezoidal rectangular waveform, with the time TP from a zero current value to the peak being 0.8 msec and DutyUTY ratio 1:1, and employing a carbon electrode as an opposed electrode. Ferrite was used as an auxiliary anode. A radial cell type electrolytic bath was used.

The current density was 30 A/dm² at the peak value of the current and the total electricity quantity was 220 C/dm² when the aluminum sheet was used as an anode. Five percent of the electric current flowing from the electric power was shunted to the auxiliary anode.

After that, the resulting aluminum sheet was washed with a water spray.

(e) Alkali Etching Treatment

Etching treatment was carried out at 32° C. for the aluminum sheet at by spraying a solution with sodium hydroxide concentration 26% by weight and aluminum ion concentration 6.5% by weight onto the aluminum sheet. 0.2 g/m² of the aluminum sheet was dissolved, to remove the smut component of which main component was aluminum hydroxide produced during the electrochemical surface roughening by using alternating current in the prior step. The edge portions of the pits formed were dissolved to make the edge portions smooth. After that, the aluminum sheet was washed by spraying water spray.

(f) Desmut Treatment

Desmut treatment was carried out by spraying an aqueous solution of 15% by weight nitric acid (containing aluminum ion 4.5% by weight) at 30° C. Then the resulting aluminum sheet was washed by spraying water spray. As For the aqueous nitric acid solution used for the desmut, waste solution from the step of the electrochemical surface roughening with an aqueous nitric acid solution by AC was used.

(g) Electrochemical Surface Roughening Treatment

Electrochemical surface roughening treatment was carried out continuously by using 60 Hz AC voltage. The electrolytic solution used in this step was an aqueous solution of hydrochloric acid (the concentration thereof being 7.5 g/L and also containing aluminum ion by 5 g/L) at 35° C. The AC power waveform had a trapezoidal rectangular waveform and a carbon electrode was used as an opposed electrode, to effect the electrochemical surface roughening treatment. Ferrite was used as an auxiliary anode. A radial cell type electrolytic bath was used.

The current density was 25 A/dm² at the peak value of the current and the total electricity quantity was 50 C/dm² when the aluminum sheet was used as an anode.

After that, the resulting aluminum sheet was washed with a water spray.

(h) Alkali Etching Treatment

Etching treatment was carried out at 32° C. for the aluminum sheet by spraying a solution containing 26 wt. % sodium hydroxide and 6.5 wt. % aluminum ion thereon, to dissolve 0.10 g/m² of the aluminum sheet, so as to remove the smut, of which main component is mainly aluminum hydroxide produced during the electrochemical roughening treatment of the surface by using alternating current in the prior step. Further, the edge portions of the pits formed were dissolved to make the edge portions smooth. After that, the aluminum sheet was washed by spraying water spray.

(i) Desmut Treatment

Desmut treatment was is carried out by spraying with an aqueous solution of 25% by weight sulfuric acid (containing aluminum ion 0.5% by weight) at 60° C. and then washing the resulting aluminum sheet was washed by spraying water spray.

(j) Anodization Treatment

As an electrolytic solution, sulfuric acid was used. The electrolytic solution contained sulfuric acid by 170 g/L (and contained aluminum ion 0.5% by weight). The temperature of the electrolytic solution was 43° C. After Then the aluminum sheet was washed with a water by spraying.

The electric current density was about 30 A/dm². Final oxide film thickness was about 2.7 g/m².

<Support A>

Each of the foregoing (a) through (j) steps was sequentially carried out, and the amount of etching in the step (e) was controlled so as to be 3.4 g/m², such that support A was prepared.

<Support B>

Support B was prepared by sequentially carrying out the aforementioned steps (a) to (j) but omitting the steps (g), (h) and (i).

<Support C>

Respective steps were successively performed except that steps (a), (g), (h) and (i) among the aforementioned steps were omitted, a support was prepared.

<Support D>

Respective steps were successively performed except that steps (a), (d), (e) and (f) among the aforementioned steps were omitted, a sum of an electricity amount in a (g) step was adjusted to be 450 C/dm² to prepare a support.

Supports A, B, C and D as obtained above were subsequently subjected to the following hydrophilization treatment and undercoating treatment.

(k) Alkali Metal Silicate Salt Treatment

An aluminum support obtained by anode oxidation treatment was immersed in a treatment bath containing 1 mass % aqueous solution of No. 3 sodium silicate at a temperature of 30° C. for 10 seconds, thereby effecting alkali metal silicate salt treatment (silicate treatment). Thereafter, water washing by spraying using well water was performed. Thereupon, a silicate adhering amount was 3.6 mg/m².

(Undercoating Treatment)

An undercoating solution having the following composition was coated on the aluminum support thus obtained after alkali metal silicate salt treatment, and was dried at 80° C. for 15 seconds. A covering amount after drying was 16 mg/m².

| <Undercoating solution composition> | |
|---|---|
| Following polymer compound | 0.3 g |
| Methanol | 100 g |
| Water | 1.0 g |
| 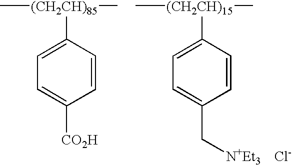 | |
| Weight average molecular weight 28000 | |

### Examples 1 to 10, Comparative Examples 1 to 6

A first layer (lower layer) coating solution having the following composition was coated on the resulting support A, with a wire bar, and was dried in a drying oven at 150° C. for 60 seconds to adjust a coating amount to 0.85 g/m².

A second layer (upper layer) coating solution having the following composition was coated on the resulting support with a lower layer with a wire bar. After coating, this was dried in a drying oven at 145° C. for 70 seconds to adjust a total coating amount to 1.15 g/m², to prepare positive-type planographic printing plate precursors of Examples 1 to 10, and Comparative Examples 1 to 6.

| <First layer (lower layer) coating solution> | |
|---|---|
| Copolymer 1 (synthesized according to the following | 2.133 g |
| description) | |
| Cyanine dye A (following structure) | 0.098 g |
| 2-Mercapto-5-methylthio-1,3,4-thiadiazole | 0.030 g |
| Cis-Δ⁴-tetrahydrophthalic acid anhydride | 0.100 g |
| 4,4′-Sulfonyldiphenol | 0.090 g |
| p-Toluenesulfonic acid | 0.008 g |
| Ethylviolet in which counter-anion was replaced with | 0.100 g |
| 6-hydroxynaphthalenesulfonic acid | |
| 3-Methoxy-4-diazodiphenylamine hexafluorophosphate | 0.030 g |
| Fluorine-based surfactant | 0.035 g |
| (trade name :Megafack F-780, manufactured by | |
| Dainippon Ink and Chemicals, Incorporated) | |
| Methyl ethyl ketone | 26.6 g |
| 1-Methoxy-2-propanol | 13.6 g |
| γ-Butyrolactone | 13.8 g |
| 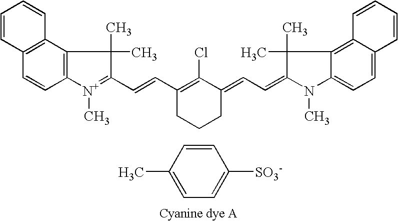 | |

<Synthesis of Copolymer 1>

After stirring, 31.0 g (0.36 mole) of methacrylic acid, 39.1 g (0.36 mole) of ethyl chloroformate and 200 ml of acetonitrile were placed into a 500 ml three-neck flask equipped with a condenser and a dropping funnel, and the mixture was stirred while it was cooled in an ice-water bath. To this mixture was added dropwise 36.4 g (0.36 mole) of triethylamine by a dropping funnel over about 1 hour. After completion of addition, an ice-water bath was removed, and the mixture was stirred at room temperature for 30 minutes.

51.7 g (0.30 mole) of p-amiobenzenesulfonamide was added to this reaction mixture, and the mixture was stirred for 1 hour while it was warmed to 70° C. in an oil bath. After completion of the reaction, this mixture was placed into 1 liter of water while the water was stirring, and the resulting mixture was stirred for 30 minutes. This mixture was filtered to take precipitates, which was slurried with 500 ml of water, the slurry was filtered, and the resulting solid was dried to obtain N-(p-aminosulfonylphenyl)methacrylamide as a white solid (yield 46.9 g).

Then, 4.61 g (0.0192 mole) of N-(p-aminosulfonylphenyl)methacrylamide, 2.58 g (0.0258 mole) of ethyl methacrylate, 0.80 g (0.015 mole) of acrylonitrile and 20 g of N-dimethylacetamide were placed into a 20 ml three-neck flask equipped with a stirrer, a condenser and a dropping funnel, and the mixture was stirred while it was heated to 65° C. in a hot water bath. To this mixture was added 0.15 g of 2,2′-azobis(2,4-dimethylvaleronitrile) (trade name: V-65, manufactured by Wako Pure Chemical Industries, Ltd.) as a polymerization initiator, and the mixture was stirred for 2 hours under a nitrogen stream while a temperature was retained at 65° C. To this reaction mixture was added dropwise a mixture of 4.61 g of N-(p-aminosulfonylphenyl)methacrylamide, 2.58 g of methyl methacrylate, 0.80 g of acrylonitrile, 20 g of N,N-dimethylacetamide, and 0.15 g of V-65 with a dropping funnel over 2 hours. After completion of addition, the resulting mixture was stirred at 65° C. for 2 hours. After completion of the reaction, 40 g of methanol was added to the mixture and cooled, and the resulting mixture was placed into 2 liter of water while the water was stirred, the mixture was stirred for 30 minutes, and precipitates were collected by filtration, and dried to obtain 15 g of a white solid. A weight average molecular weight (polystyrene standard) of this specific copolymer 1 was measured by gel permeation chromatography, and was found to be 54,000.

<Second layer (upper layer) coating solution>

| | |
|---|---|
| Copolymer of ethyl methacrylate and | 0.030 g |
| 2-methacryloyloxyethylsuccinic acid | |
| (Mole ratio 67:33, weight average molecular weight 92,000) | |
| Novolak resin P1:phenolcresol-formaldehyde novolak | 0.300 g |
| (Phenol:m-cresol:p-cresol = 30:30:40, weight average molecular | |
| weight:5500) | |
| Sulfonium salt (following structure) | 0.1 g |
| Cyanine dye A(following structure) | 0.015 g |
| Ethylviolet in which counter-anion thereof was | 0.012 g |
| replaced with 6-hydroxynaphthalenesulfonic acid | |
| Fluorine-based surfactant | 0.011 g |
| (trade name: Megafack F-780, manufactured by | |
| Dainippon Ink and Chemicals, Incorporated) | |
| Methyl ethyl ketone | 13.1 g |
| 1-Methoxy-2-propanol | 6.79 g |
| Specific copolymer of the invention or comparative copolymer | 0.055 g |
| (compound described in Table 1) | |
| 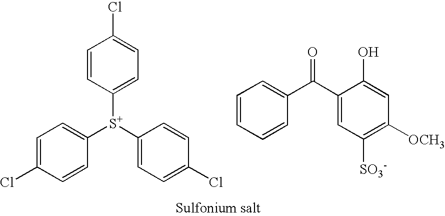 | |

A structure of a comparative copolymer used in Comparative Example is as follows:

| | | Mt (×10⁴) |
|---|---|---|
| PA-1 | 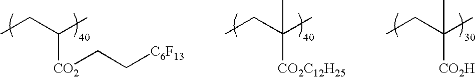 | 3.8 |
| PA-2 | 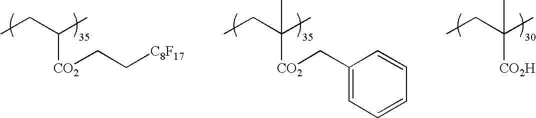 | 5.1 |
| PA-3 | 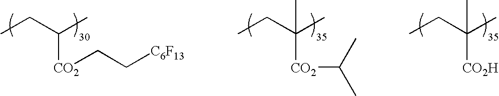 | 5.7 |
| PA-4 | 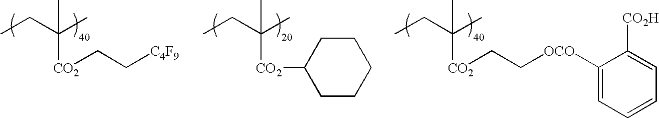 | 6.9 |
| PA-5 | 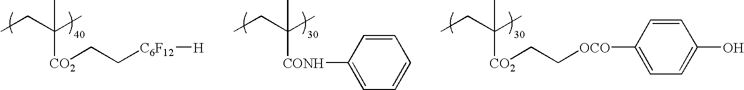 | 7.8 |
| PA-6 | 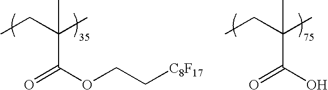 | 8.1 |
| PA-7 | 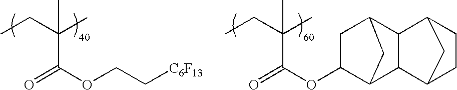 | 4.6 |

[Evaluation of Planographic Printing Plate Precursor]

Evaluation of a planographic printing plate precursor was performed regarding each term of developing latitude, sensitivity and burning property. Details of an assessing method is as follows:

1. Developability

A planographic printing plate precursor was stored for 5 days under condition of a temperature of 25° C. and a relative humidity of 50%. A PS plate developer, trade name: DT-1 manufactured by Fuji Photo Film Co., Ltd., which is a developer substantially not containing an alkali metal silicate salt, was used under standard use condition, and a (relative) time required before development was satisfactorily performed without staining and/or coloring caused by a recording layer residual film due to poor development, was compared between the samples. Specifically, the time required before starting of satisfactory development in example 1 is expressed as the standard value (100) of the developing time index. The larger developing time index represents the higher developability, which is the more preferable. Results are shown in the following Table 1.

2. Inking Property

The resulting planographic printing plate precursor was exposed to the light, imagewise, at a setter exposing amount of 8.0 W and 150 rpm using trade name: TrendSetter3244F manufactured by CREO. The exposed printing plate was subjected to development using a PS plate developer, trade name: DT-1 manufactured by Fuji Photo Film Co., Ltd. under standard use condition. The printing plate was then subjected to a printing machine, and the (relative) number of prints needed before obtaining a print article in which an ink was satisfactorily adhered on an image part and which had no problem was compared between the samples. The number of prints needed before a satisfactory printing article was obtained in example 1 is expressed as the standard value (100) of the inking index. The larger inking index represents the more excellent inking property, which is the more preferable. The smaller the number of prints needed before a satisfactory printing article was obtained represents the more excellent inking property, which is the more preferable. Results are shown in the following Table 1.

TABLE 1

| | Specific | | | Inking |
|---|---|---|---|---|
| | copolymer or | | | Property |
| | comparative | | Inking Property | (Number |
| | copolymer | Developability | (Index) | of sheet) |
| Example 1 | P-1 | 100 | 100 | 20 |
| Example 2 | P-2 | 120 | 110 | 18 |
| Example 3 | P-6 | 100 | 100 | 20 |
| Example 4 | P-9 | 100 | 100 | 20 |
| Example 5 | P-10 | 110 | 100 | 20 |
| Example 6 | P-13 | 130 | 140 | 14 |
| Example 7 | P-23 | 130 | 130 | 15 |
| Example 8 | P-38 | 120 | 100 | 20 |
| Example 9 | P-42 | 100 | 110 | 18 |
| Example 10 | P-46 | 100 | 110 | 18 |
| Comparative | PA-1 | 80 | 40 | 50 |
| Example 1 | | | | |
| Comparative | PA-2 | 80 | 50 | 40 |
| Example 2 | | | | |
| Comparative | PA-4 | 90 | 60 | 33 |
| Example 3 | | | | |
| Comparative | PA-5 | 80 | 40 | 50 |
| Example 4 | | | | |
| Comparative | PA-6 | 100 | 40 | 50 |
| Example 5 | | | | |
| Comparative | PA-7 | 50 | 120 | 17 |
| Example 6 | | | | |

As shown in Table 1, it is seen that planographic printing plate precursors of Examples 1 to 10 realize improvement in inking property, while good developability is maintained. On the other hand, all of planographic printing plate precursors not containing the specific copolymer relating to the invention were inferior in developability and inking property, as compared with Examples 1-6.

### Examples 11 to 20, Comparative Example 7-12

In Examples 11 to 20, and Comparative Examples 7-12, planographic printing plate precursors were prepared according the same manner except that a sulfonium salt was removed from second layer (upper layer) coating solutions of Examples 1 to 10, and Comparative Examples 1 to 6. Planographic printing plate precursors obtained herein were evaluated according to the same method as that of Example 1. As in Examples 1 to 10, the results are shown as index values, in which the result of Example 11 is expressed as 100. Results are shown in Table 2.

TABLE2

| | Specific | | | Inking |
|---|---|---|---|---|
| | copolymer or | | | Property |
| | comparative | | Inking Property | (Number |
| | copolymer | Developability | (Index) | of sheet) |
| Example 11 | P-1 | 100 | 100 | 20 |
| Example 12 | P-6 | 100 | 100 | 20 |
| Example 13 | P-13 | 140 | 140 | 14 |
| Example 14 | P-18 | 100 | 110 | 18 |
| Example 15 | P-21 | 110 | 90 | 22 |
| Example 16 | P-22 | 100 | 100 | 20 |
| Example 17 | P-32 | 140 | 140 | 14 |
| Example 18 | P-39 | 120 | 100 | 20 |
| Example 19 | P-45 | 100 | 120 | 17 |
| Example 20 | P-49 | 120 | 130 | 15 |
| Comparative | PA-1 | 70 | 50 | 40 |
| Example 7 | | | | |
| Comparative | PA-2 | 70 | 50 | 40 |
| Example 8 | | | | |
| Comparative | PA-4 | 80 | 60 | 33 |
| Example 9 | | | | |
| Comparative | PA-5 | 70 | 50 | 40 |
| Example 10 | | | | |
| Comparative | PA-6 | 100 | 40 | 50 |
| Example 11 | | | | |
| Comparative | PA-7 | 40 | 120 | 17 |
| Example 12 | | | | |

As shown in Table 2, it is seen that planographic printing plate precursors of Examples 11 to 20 realize improvement in inking property, while good developability is maintained. On the other hand, all of planographic printing plate precursors of Comparative Example 7 to 12 to which the specific copolymer relating to the invention was not added were inferior in developability and inking property as compared with Examples.

### Examples 21 to 28, Comparative Examples 13 to 16

A first layer (lower layer) coating solution having the following composition was coated on the resulting support C with a wire bar, and was dried in a drying oven at 130° C. for 60 seconds to adjust a coating amount to 0.6 g/m².

A second layer (upper layer) coating solution having the following composition was coated on the resulting support with a lower layer, with a wire bar. After coating, this was dried in a drying oven at 150° C. for 60 seconds to adjust a total coating amount to 1.25 g/m², to prepare each of positive-type planographic printing plate precursors of Examples 21 to 28 and Comparative Examples 13 to 16.

<First layer (lower layer) coating solution>

| | |
|---|---|
| Copolymer | 2.133 g |
| Cyanine dye A (aforementioned structure) | 0.098 g |
| 2-Mercapto-5-methylthio-1,3,4-thiadiazole | 0.030 g |
| Cis-Δ⁴-tetrahydrophthalic acid anhydride | 0.100 g |
| 4,4′-Sulfonyldiphenol | 0.090 g |
| p-Toluenesulfonic acid | 0.008 g |
| Ethylviolet in which counter-anion is replaced with | 0.100 g |
| 6-hydroxynaphthalenesulfonic acid | |
| 3-Methoxy-4-diazodiphenylamine hexafluorophosphate | 0.030 g |
| Fluorine-based surfactant | 0.035 g |
| (trade name: Megafack F-780, manufactured by | |
| Dainippon Ink and Chemicals, Incorporated) | |
| Methyl ethyl ketone | 26.6 g |
| 1-Methoxy-2-propanol | 13.6 g |
| Dimethyl sulfoxide | 13.8 g |

<Second Layer (upper layer) coating solution>

| | |
|---|---|
| Copolymer of ethyl methacrylate | 0.030 g |
| and 2-methacryloyloxyethylsuccinic acid | |
| (Mole ratio 67:33, weight average molecular weight 92,000) | |
| Novolak resin P1: phenolcresol-formaldehyde novolak | 0.300 g |
| (Phenol:m-cresol:p-cresol = 30:30:40, | |
| weight average molecular weight: 5500) | |
| Sulfonium salt (aforementioned structure) | 0.1 g |
| Cyanine dye A (aforementioned structure) | 0.015 g |
| Ethylviolet in which counter-anion is replaced with | 0.012 g |
| 6-hydroxynaphthalenesulfonic acid | |
| Fluorine-based surfactant | 0.011 g |
| (trade name: Megafack F-780, manufactured by | |
| Dainippon Ink ad Chemicals, Incorporated) | |
| Methyl ethyl ketone | 13.1 g |
| 1-Methoxy-2-propanol | 6.79 g |
| Specific copolymer relating to the invention or comparative | 0.055 g |
| copolymer (compound described in Table 3) | |

<Evaluation of Examples 21 to 28 and Comparative Examples 13 to 16>

Each of the resulting planographic printing plate precursors of Examples 21 to 28 and Comparative Examples 13 to 16 was assessed according to the same method as that of Example 1. As in Examples 1 to 10, the results are shown as index values, in which the result of Example 21 is expressed as 100. Results are shown in the following Table 3.

TABLE3

| | Specific | | | Inking |
|---|---|---|---|---|
| | copolymer or | | | Property |
| | comparative | | Inking Property | (Number |
| | copolymer | Developability | (Index) | of sheet) |
| Example 21 | P-1 | 100 | 100 | 20 |
| Example 22 | P-3 | 110 | 120 | 17 |
| Example 23 | P-8 | 120 | 110 | 18 |
| Example 24 | P-13 | 140 | 140 | 14 |
| Example 25 | P-34 | 110 | 90 | 22 |
| Example 26 | P-37 | 120 | 90 | 22 |
| Example 27 | P-48 | 100 | 100 | 20 |
| Example 28 | P-50 | 110 | 120 | 17 |
| Comparative | PA-3 | 70 | 60 | 33 |
| Example 13 | | | | |
| Comparative | PA-5 | 70 | 60 | 33 |
| Example 14 | | | | |
| Comparative | PA-6 | 100 | 50 | 40 |
| Example 15 | | | | |
| Comparative | PA-7 | 50 | 130 | 15 |
| Example 16 | | | | |

As shown in Table 3, it is seen that planographic printing plate precursors of Examples 21 to 28 realize improvement in inking property, while good developability is maintained. On the other hand, all of planographic printing plate precursors of Comparative Examples 13 to 16 to which the specific copolymer relating to the invention was not added were inferior in developability and inking property, as compared with Examples.

### Examples 29 to 36, Comparative Examples 17 to 20

In Examples 29 to 36 and Comparative Examples 17 to 20, planographic printing plate precursors were prepared according to the same manner except that a sulfonium salt was removed from second layer (upper layer) coating solutions of Examples 21 to 28 and Comparative Examples 13 to 16. Planographic printing plate precursors obtained herein were assessed according to the same method as that of Example 1. As in Examples 1 to 10, the results are shown as the index values, in which the result of Example 29 is expressed as 100. Results are shown in Table 4.

TABLE4

| | Specific | | | Inking |
|---|---|---|---|---|
| | copolymer or | | | Property |
| | comparative | | Inking Property | (Number |
| | copolymer | Developability | (Index) | of sheet) |
| Example 29 | P-1 | 100 | 100 | 20 |
| Example 30 | P-9 | 100 | 100 | 20 |
| Example 31 | P-10 | 100 | 110 | 18 |
| Example 32 | P-13 | 140 | 140 | 14 |
| Example 33 | P-19 | 110 | 120 | 17 |
| Example 34 | P-43 | 110 | 110 | 18 |
| Example 35 | P-44 | 110 | 120 | 17 |
| Example 36 | P-51 | 120 | 120 | 17 |
| Comparative | PA-3 | 60 | 50 | 40 |
| Example 17 | | | | |
| Comparative | PA-5 | 60 | 50 | 40 |
| Example 18 | | | | |
| Comparative | PA-6 | 90 | 40 | 50 |
| Example 19 | | | | |
| Comparative | PA-7 | 40 | 120 | 17 |
| Example 20 | | | | |

As shown in Table 4, it is seen that planographic printing plate precursors of Examples 29 to 36 realize improvement in inking property, while developability is maintained. On the other hand, all of planographic printing plate precursors of Comparative Examples 11 to 12 to which the specific copolymer relating to the invention was not added were inferior in developability and inking property, as compared with Examples.

### Examples 37 to 44, Comparative Examples 21 to 24

A first layer (lower layer) coating solution having the following composition was coated on the resulting support D, with a wire bar, and was dried in a drying oven at 150° C. for 60 seconds to adjust a coating amount to 0.81 g/ml.

A second layer (upper layer) coating solution having the following composition was coated on the resulting support with a lower layer, with a wire bar. After coating, this was dried in a drying oven at 150° C. for 60 seconds to adjust a total coating amount to 0.99 g/m², to prepare each of positive-type planographic printing plate precursors of Examples 37 to 44 and Comparative Examples 21 to 24.

<First layer (lower layer) coating solution>

| | |
|---|---|
| Aforementioned copolymer 1 | 2.133 g |
| Cyanine Dye A (aforementioned structure) | 0.098 g |
| Cis-Δ⁴-tetrahydrophthalic acid anhydride | 0.110 g |
| 4,4′-Sulfonyldiphenol | 0.090 g |
| p-Toluenesulfonic acid | 0.008 g |
| Ethylviolet in which counter-anion is replaced with | 0.100 g |
| 6-hydroxynaphthalenesulfonic acid | |
| 3-Methoxy-4-diazodiphenylamine hexafluorophosphate | 0.030 g |
| Fluorine-based surfactant | 0.035 g |
| (trade name: Megafack F-780, manufactured by | |
| Dainippon Ink and Chemicals, Incorporated) | |
| Methyl ethyl ketone | 26.6 g |
| 1-Methoxy-2-propanol | 13.6 g |
| γ-Butyrolactone | 13.8 g |

<Second layer (upper layer) coating solution>

| | |
|---|---|
| Copolymer of ethyl methacrylate and | 0.030 g |
| 2-methacryloyloxyethylsuccinic acid | |
| (Mole ratio 67:33, weight average molecular weight 92,000) | |
| Novolak resin P5: phenolcresol-formaldehyde novolak | 0.300 g |
| (Phenol:m-cresol:p-cresol = 40:40:20, | |
| weight average molecular weight: 8000) | |
| Sulfonium salt (aforementioned structure) | 0.020 g |
| Cyanine dye A (aforementioned structure) | 0.015 g |
| Fluorine-based surfactant | 0.011 g |
| (trade name: Megafack F-780 manufactured by | |
| Dainippon Ink and Chemicals, Incorporated) | |
| Methyl ethyl ketone | 13.1 g |
| 1-Methoxy-2-propanol | 6.79 g |
| Specific copolymer relating to the invention or | 0.055 g |
| comparative copolymer (compound described in Table 5) | |

<Evaluation of Examples 37 to 44 and Comparative Examples 21 to 24>

The resulting planographic printing plate precursors were assessed according to the same method as that of Example 1 except that a PS plate developer “DP-4” of a developer (Fuji Photo Film Co., Ltd.) containing an alkali metal silicate salt was used as a developer. As in Examples 1 to 10, the results are shown as index values, in which the result of Example 37 is expressed to be 100. Results are shown in Table 5.

TABLE 5

| | Specific | | | Inking |
|---|---|---|---|---|
| | copolymer or | | Property | |
| | comparative | | | (Number |
| | copolymer | Developability | Inking Property | of sheet) |
| Example 37 | P-1 | 100 | 100 | 20 |
| Example 38 | P-2 | 120 | 100 | 20 |
| Example 39 | P-3 | 100 | 110 | 18 |
| Example 40 | P-6 | 100 | 100 | 20 |
| Example 41 | P-13 | 140 | 140 | 14 |
| Example 42 | P-38 | 110 | 100 | 20 |
| Example 43 | P-40 | 120 | 90 | 22 |
| Example 44 | P-49 | 120 | 120 | 17 |
| Comparative | PA-3 | 70 | 70 | 29 |
| Example 21 | | | | |
| Comparative | PA-5 | 60 | 70 | 29 |
| Example 22 | | | | |
| Comparative | PA-6 | 100 | 50 | 40 |
| Example 23 | | | | |
| Comparative | PA-7 | 50 | 120 | 17 |
| Example 24 | | | | |

As shown in Table 5, it is seen that planographic printing plate precursors of Examples 37 to 44 realize improvement in inking property, while good developability is maintained. On the other hand, all of planographic printing plate precursors of Comparative Examples 21 to 24 to which the specific copolymer relating to the invention was not added were inferior in developability and inking property, as compared with Examples.

### Examples 45 to 52, Comparative Examples 25 to 28

In Examples 45 to 52 and Comparative Examples 25 to 28, planographic printing plate precursors were prepared according to the same manner except that a sulfonium salt was removed from second layer (upper layer) coating solutions of Examples 37 to 44 and Comparative Examples 21 to 24. Planographic printing plate precursors obtained herein were assessed according to the same method as that of Example 1. As in Examples 1 to 10, the results are shown as the index values, in which the result of Example 45 is expressed to be 100. Results are shown in Table 6.

TABLE 6

| | Specific | | | Inking |
|---|---|---|---|---|
| | copolymer or | | | Property |
| | comparative | | | (Number |
| | copolymer | Developability | Inking Property | of sheet) |
| Example 45 | P-1 | 100 | 100 | 20 |
| Example 46 | P-13 | 140 | 140 | 14 |
| Example 47 | P-14 | 120 | 110 | 18 |
| Example 48 | P-15 | 130 | 130 | 15 |
| Example 49 | P-16 | 120 | 110 | 18 |
| Example 50 | P-38 | 120 | 100 | 20 |
| Example 51 | P-48 | 100 | 110 | 18 |
| Example 52 | P-50 | 120 | 120 | 17 |
| Comparative | PA-3 | 70 | 60 | 33 |
| Example 25 | | | | |
| Comparative | PA-5 | 60 | 60 | 33 |
| Example 26 | | | | |
| Comparative | PA-6 | 100 | 40 | 50 |
| Example 27 | | | | |
| Comparative | PA-7 | 50 | 130 | 15 |
| Example 28 | | | | |

As shown in Table 6, it is seen that planographic printing plate precursors of Examples 45 to 52 realize improvement in inking property, while good developability is maintained. On the other hand, all of planographic printing plate precursors of Comparative Examples 25 to 28 to which the specific copolymer relating to the invention was not added were inferior in developability and inking property.

### Examples 53 to 60, Comparative Examples 29 to 32

The following image forming layer coating solution was coated on the resulting support D, and was dried at 150° C. for 1 minute to form an image forming layer, to obtain each of planographic printing plate precursors of Examples 53 to 60 and Comparative Examples 29 to 32. A coating amount after drying was 1.55 g/m².

<Image forming layer coating solution>

| | |
|---|---|
| Novolak resin P7: phenolcresol-formaldehyde Novolak | 1.0 g |
| (phenol:m-cresol:p-cresol = 20:60:20, | |
| weight average molecular weight: 10200) | |
| Cyanine dye A (aforementioned structure) | 0.05 g |
| Dye in which counter-anion of Victoria Pure Blue BOH is | 0.01 g |
| replaced with 1-naphthalenesulfonic acid anion | |
| Fluorine-based surfactant | 0.05 g |
| (trade name: Megafack F-177, manufactured by | |
| Dainippon Ink and Chemicals, Incorporated) | |
| Methyl ethyl ketone | 9.0 g |
| 1-Methoxy-2-propanol | 9.0 g |
| Specific copolymer relating to the invention or comparative | 0.2 g |
| copolymer (compound describe in Table 7) | |

<Evaluation of Examples 53 to 60 and Comparative Examples 29 to 32>

The resulting planographic printing plate precursors were assessed according to the same method as that of Example 1 except that a PS plate developer “DP-4” of a developer (manufactured by Fuji Photo Film Co., Ltd.) containing an alkali metal silicate salt was used as a developer. As in Examples 1 to 10, the results are shown as the index values, in which the result of Example 53 is expressed to be 100. Results are shown in Table 7.

TABLE 7

| | Specific | | | Inking |
|---|---|---|---|---|
| | copolymer or | | | Property |
| | comparative | | | (Number |
| | copolymer | Developability | Inking Property | of sheet) |
| Example 53 | P-1 | 100 | 100 | 20 |
| Example 54 | P-2 | 110 | 100 | 20 |
| Example 55 | P-6 | 100 | 100 | 20 |
| Example 56 | P-13 | 140 | 140 | 14 |
| Example 57 | P-38 | 120 | 100 | 20 |
| Example 58 | P-41 | 100 | 120 | 17 |
| Example 59 | P-44 | 100 | 110 | 18 |
| Example 60 | P-48 | 100 | 110 | 18 |
| Comparative | PA-1 | 80 | 40 | 50 |
| Example 29 | | | | |
| Comparative | PA-2 | 80 | 50 | 40 |
| Example 30 | | | | |
| Comparative | PA-6 | 90 | 50 | 40 |
| Example 31 | | | | |
| Comparative | PA-7 | 40 | 130 | 15 |
| Example 32 | | | | |

As shown in Table 7, it is seen that planographic printing plate precursors of Examples 53 to 60 realize improvement in inking property, while good developability is maintained. On the other hand, all of planographic printing plate precursors of Comparative Examples 29 to 32 to which the specific copolymer relating to the invention was not added were inferior in developability and inking property, as compared with Examples of the present invention.

### Second Embodiment

The planographic printing plate precursor of the invention is characterized in that a recording layer contains: a polymer compound (hereinafter, referred to as a “specific copolymer”) having, as a copolymerization component, (a) a monomer represented by the following formula (1) and (b) a monomer represented by the formula (2); and an infrared-ray absorbing agent.

[A Polymer Compound Having (a) a Monomer Represented by the Formula (1), and (b) a Monomer Represented by the Formula (2) as a Copolymerization Component]

(a) A fluorine-containing monomer represented by the formula (1) and (b) a monomer having an alicyclic structure near a carboxylic acid represented by the formula (2), which are copolymerization components imparting preferable property to the specific polymer relating to the invention, will be described in detail.

A fluorine-containing monomer used as a copolymerization component (a) in the invention is represented by the formula (1).

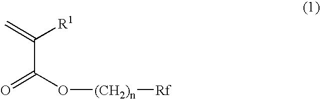

In the formula (1), Rf is a substituent containing a fluoroalkyl group or a perfluoroalkyl group having 9 or more fluorine atoms, n represents 1 or 2, and R¹ represents hydrogen or a methyl group.

Examples of a fluorine atom-containing substituent in Rf include the following fluoroalkyl (meth)acrylate:
CH₂═CRCO₂(CH₂)ₘCₙF₂ₙ₊₁
(m represents 1 or 2, and n represents an integer of 4 to 12, and R represents an alkyl group of a carbon number of 1 to 4)
CH₂═CRCO₂(CH₂)ₘ(CF₂)ₙH
(m represents 1 or 2, and n represents an integer of 4 to 12, and R represents an alkyl group of a carbon number of 1 to 4)

Here, by using a fluoroalkyl group or a perfluoroalkyl group represented by Rf having 9 or more fluorine atoms, a recording layer having a unique distribution of fluorine atom concentration in a film thickness direction is formed, in which distribution a fluorine concentration near a recording layer surface is relatively high and the fluorine concentration is decreased in the depth direction of a recording layer. The number of fluorine atoms per monomer unit is preferably 9 to 30, and more preferably 13 to 25. In this range, effect of orienting the specific polymer at a recording layer surface is manifested better, and thus superior inking property is obtained. When the number of fluorine atoms contained in one unit is too large, deterioration in inking property due to oil repellency of fluorine atoms may be caused.

In addition, from a viewpoint of improving the surface orienting property of the specific polymer and a balance between developing resistance enhancing effect and inking property, a content of a fluorine atom in a specific polymer is preferably in a range of 5 to 30 mmol/g, more preferably in a range of 8 to 25 mmol/g. When the number of fluorine atoms contained in a copolymer is too large, deterioration in inking property due to oil repellency of a fluorine atom may occur.

A carboxyl group-containing monomer used as a copolymerization component (b) in the invention is represented by the following formula (2).

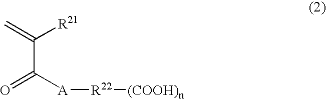

In the formula (2), R²¹ represents a hydrogen atom or a methyl group, and R²² represents a divalent hydrocarbon group having a C3-C30 alicyclic structure. A represents an oxygen atom, or —NH²³—, and R²³ represents a hydrogen atom or a C1-C10 monovalent hydrocarbon group.

R²¹ in the formula (2) represents a hydrogen atom or a methyl group and, particularly, a methyl group is preferable. Examples of a divalent hydrocarbon group having a C3-C30 alicyclic structure as R²² in the formula (2) include a divalent hydrocarbon group obtained by removing two hydrocarbon groups on an arbitrary carbon atom constituting a compound having an alicyclic structure, such as cyclopropane, cyclopentane, cyclohexane, cycloheptane, cyclooctane, cyclodecane, dicyclohexyl, tercyclohexyl, norbornane, decahydronaphthalene, perhydrofluororene, tricycle[5.2.1.02.6]decane, adamantane, quadricyclane, congressane, cubane, spiro[4.4]octane, cyclopentene, cyclohexene, cycloheptene, cyclooctene, cyclodecene, cyclohexadiene, cycloheptadiene, cyclooctadiene, cycloheptatriene, cyclodecatriene, cyclooctatetraene, norbornylene, octahydronaphthalene, bicycle[2.2.1]heptadiene, bicyclo[4.3.0]nonadiene, dicyclopentadiene, hexahydroanthracene, and spiro[4.5]decadiene, which may be substituted with at least one substituent. The number of carbon atoms of R²² (including that of a substituent thereof) is preferably in a range of 3 to 30.

In (b) a monomer represented by the formula (2), an alicyclic structure represented by R²² and a carboxyl group bound thereto characteristically effect the superior inking property of the specific copolymer of the invention. That is, by sterically protecting a hydrophilic carboxyl group with an alicyclic structure, surface hydrophilicity of a film comprising the specific copolymer is reduced, i.e., the film surface is made hydrophobic, whereby inking property is improved. It is assumed that, since an alicyclic structure has a more steric structure than an aromatic cyclic structure, a distance between a carboxyl group and a ring structure is reduced and thus an effective shielding function is obtained.

Examples of a substituent which can be introduced into a divalent hydrocarbon group having an alicyclic structure represented by R²² include a non-metal atomic moiety except for hydrogen, such as a halogen atom (—F, —Br, —Cl, —I), a hydroxyl group, an alkoxy group, an aryloxy group, an amino group, a N-alkylamino group, a N,N-dialkylamino group, a N-arylamino group, a N,N-diarylamino group, a N-alkyl-N-arylamino group, an acyloxy group, a carbamoyloxy group, a N-alkylcarbamoyloxy group, a N-arylcarbamoyloxy group, a N,N-dialkylcarbamoyloxy group, a N,N-diarylcarbamoyloxy group, a N-alkyl-N-arylcarbamoyloxy group, an alkylsulfoxy group, an arylsulfoxy group, an acylthio group, an acylamino group, a N-alkylacylamino group, a N-arylacylamino group, an aryl group, an alkenyl group, and an alkynyl group.

A hydrophobic substituent such as a halogen atom, a hydrocarbon group (alkyl group, aryl group, alkenyl group, alkynyl group), an alkoxy group, and an aryloxy group is preferable because it has a tendency to improve printing durability. These substituents may be bonded to each other or with a hydrocarbon group as a substitute thereof to form a ring. The substituent may further be substituted.

R²³, when A in the formula (2) is NR²³—, represents a hydrogen atom or a C1-C10 monovalent hydrocarbon group. Examples of a C1-C10 monovalent hydrocarbon group represented by R²³ include an alkyl group, an aryl group, an alkenyl group, and an alkynyl group.

Examples of the alkyl group include a straight, branched or cyclic alkyl group of a carbon number of 1 to 10 such as a methyl group, an ethyl group, a propyl group, a butyl group, a pentyl group, a hexyl group, a heptyl group, an octyl group, a nonyl group, a decyl group, an isopropyl group, an isobutyl group, a sec-butyl group, a tert-butyl group, an isopentyl group, a neopentyl group, a 1-methylbutyl group, an isohexyl group, a 2-ethylhexyl group, a 2-methylhexyl group, a cyclopentyl group, a cyclohexyl group, a 1-adamantyl group, and a 2-norbornyl group.

Examples of an aryl group include a C1-C10 aryl group such as a phenyl group, a naphthyl group and an indenyl group; and a C1-C10 heteroaryl group containing one heteroatom selected from the group consisting of a nitrogen atom, an oxygen atom, and a sulfur atom, for example, a furyl group, a thienyl group, a pyrrolyl group, a pyridyl group, and a quinolyl group.

Examples of an alkenyl group include a C1-C10 straight, a branched or a cyclic alkenyl group such as a vinyl group, a 1-propenyl group, a 1-butenyl group, a 1-methyl-1-propenyl group, a 1-cyclopentenyl group, and a 1-cyclohexenyl group.

Examples of an alkynyl group include a C1-C10 alkynyl group such as an ethynyl group, a 1-propynyl group, a 1-butynyl group, and a 1-octynyl group. Substituents which may be possessed by R²³ are the same as those exemplified as substituents which can be introduced into R²², provided that a carbon number of R²³ including a substituent is 1 to 10.

A in the formula (2) is preferably an oxygen atom or —NH—, in terms of easy synthesis.

Preferable examples of a repetition unit derived from a monomer represented by the formula (2) are shown below, but the invention is not limited to them.

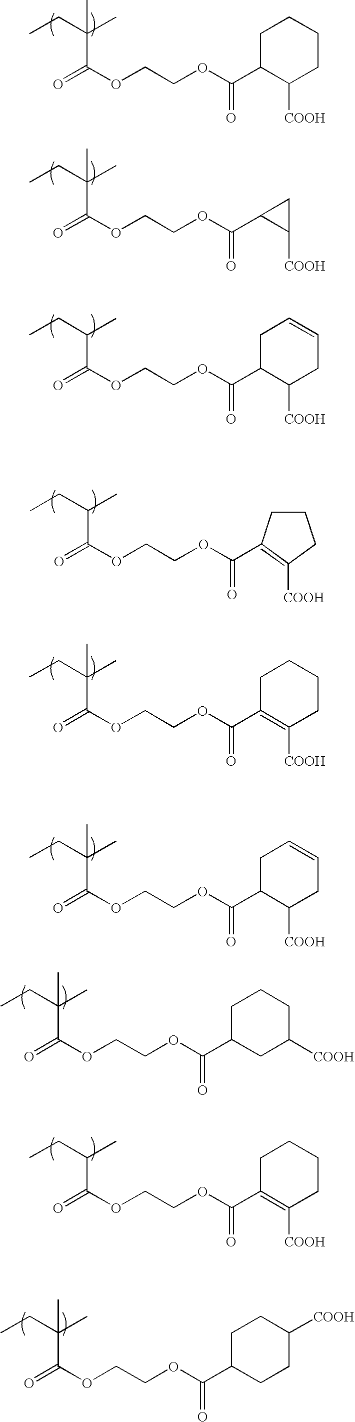

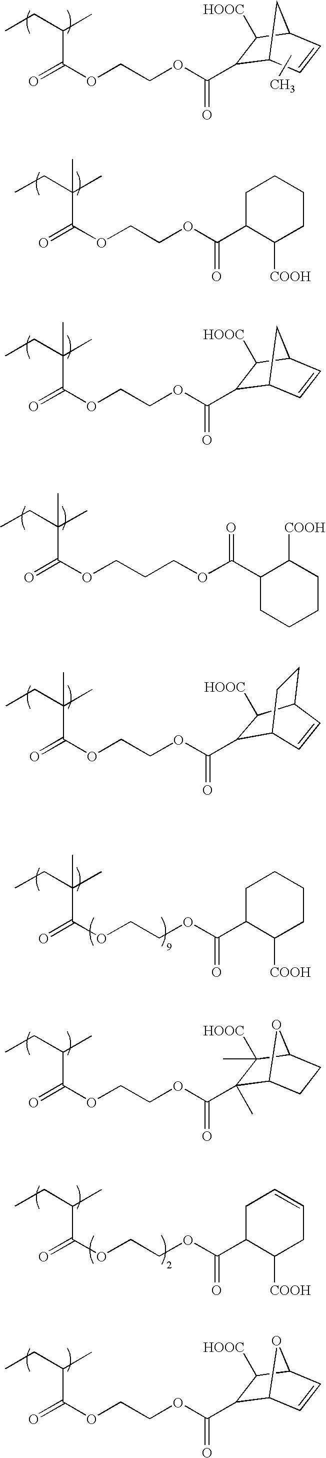

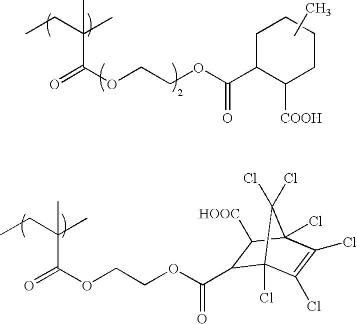

Only one type, or two or more types, of repetition unit derived from a monomer represented by the formula (2) may be contained in a binder polymer. A total content of a repetition unit derived from a monomer represented by the formula (2) in a polymer of the invention is appropriately determined depending on its structure and the design of a photosensitive layer. The total content of a repetition unit is preferably in a range of 0.1 to 99 mol %, more preferably 1 to 80 mol %, further preferably 5 to 60 mol % relative to a total mole amount of a specific polymer component.

When the content of a carboxyl group in a polymer is too small, sludge is generated in a developer. When the content of a carboxyl group is too large, desired good inking property is not obtained. Therefore, the acid value per polymer is preferably 0.01 to 3.0 mmol/g, more preferably 0.1 to 2.5 mmol/g, further preferably 0.2 to 2.0 mmol/g from a viewpoint of obtaining good inking property and sensitivity.

In the polymer compound in the invention, in addition to a structural unit derived from the aforementioned two types of monomers (a) and (b), other monomer may further be copolymerized for various purposes such as improvement in coating property in such a range as not to mar the effect of the invention.

Examples of other monomer which can be used together herein include the known monomers such as acrylic acid esters, methacrylic acid esters, acrylamides, methacrylamides, vinyl esters, styrenes, acrylonitrile, maleic anhydride, and maleic imide.

Since examples of these other monomers which can be used together are the same as those of a first embodiment, description thereof will be omitted.

A recording layer in the planographic printing plate precursor of the present embodiment may contain only one type of the specific polymer, or may be a mixture of two or more types of the specific polymer. Further, as long as the effect of the invention is not deteriorated, one or more types of fluorine-containing polymer compound beyond the scope of the invention may be used together with the specific polymer in the invention (i.e., a mixture of the specific copolymer and the fluorine-containing polymer may be used).

The content of a fluorine-containing polymer compound which is used together with the specific copolymer is preferably in a range of 0.01 to 300% by weight, more preferably 0.1 to 250% by weight, further preferably 1 to 200% by weight relative to a total weight of the specific copolymer of the invention. As the fluorine-containing polymer compound which can be used together with the specific copolymer, commercially available compounds can be used without limitation and, specifically, fluorine-based surfactants which are often used in the art. Preferable examples thereof include fluorine-based polymers described in JP-A No. 2002-311577, JP-A No. 2002-72474, and JP-A No. 2004-101893.

A weight average molecular weight of the specific polymer of the invention is appropriately determined from a viewpoint of achieving good inking property and developability, and suppressing generation of precipitates in a developer. In general, the higher a molecular weight is, the better inking property is obtained. However, developability may be deteriorated and generation of precipitates or aggregates in a developer may be increased accordingly. Conversely, when a molecular weight is relatively low, although deterioration of developability and generation of precipitates or aggregates in a developer are suppressed, inking property is deteriorated. A preferable molecular weight of the specific copolymer is in a range of 1,000 to 1,000,000, more preferably 2,000 to 500,000, further preferably 3,000 to 300,000 from a viewpoint of achieving good balance between the film property, the inking property enhancing effect and handling property, solvent solubility, and uniformity upon coating.

The specific copolymer relating to the invention may be linear, or may be branched, or may have a block structure.

Structures of polymer compounds [(P-1) to (P-21)] suitable in the invention, and weight average molecular weight (Mw) thereof are shown below, but the invention is not limited to them.

| | | Mw |
|---|---|---|
| | | (10,000) |
| P-1 | 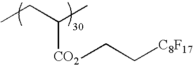 | 3.6 |
| | 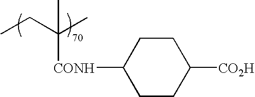 | |
| P-2 | 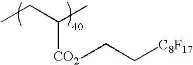 | 5.2 |
| | 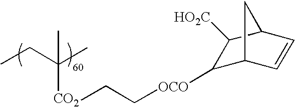 | |
| P-3 | 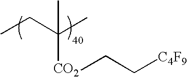 | 2.8 |
| | 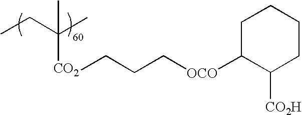 | |
| P-4 | 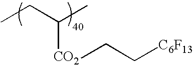 | 2.6 |
| | 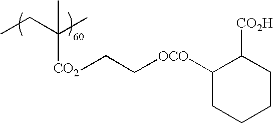 | |
| P-5 | 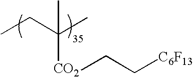 | 3.5 |
| | 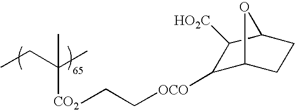 | |
| P-6 | 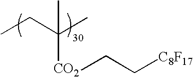 | 4.1 |
| | 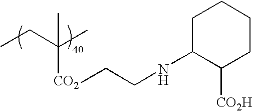 | |
| | 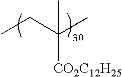 | |
| P-7 | 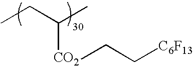 | 5.2 |
| | 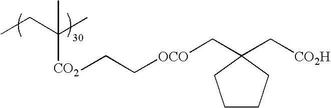 | |
| | 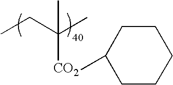 | |
| P-8 | 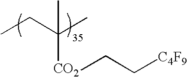 | 2.6 |
| | 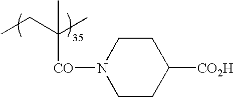 | |
| | 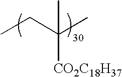 | |
| P-9 | 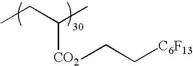 | 1.5 |
| | 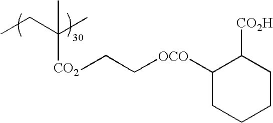 | |
| | 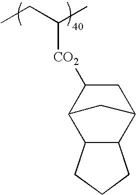 | |
| P-10 | 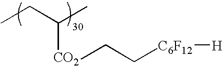 | 3.8 |
| | 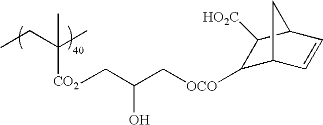 | |
| | 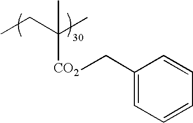 | |
| P-11 | 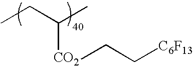 | 4.2 |
| | 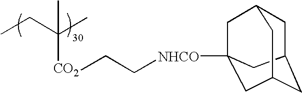 | |
| | 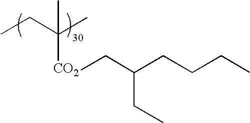 | |
| P-12 | 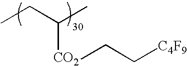 | 5.1 |
| | 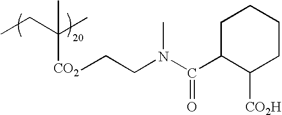 | |
| | 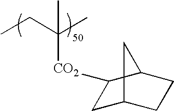 | |
| P-13 | 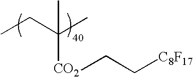 | 3.0 |
| | 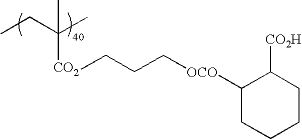 | |
| | 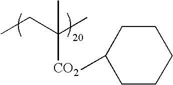 | |
| P-14 | 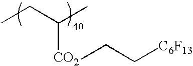 | 2.5 |
| | 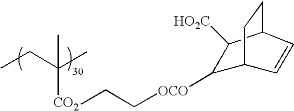 | |
| | 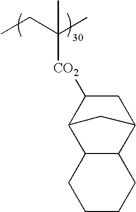 | |
| P-15 | 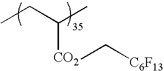 | 1.9 |
| | 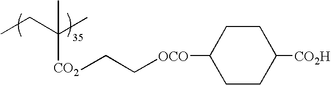 | |
| | 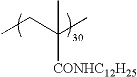 | |
| P-16 | 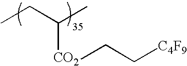 | 1.2 |
| | 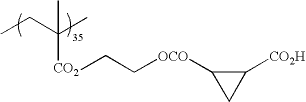 | |
| | 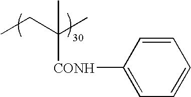 | |
| P-17 | 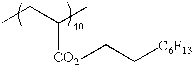 | 1.8 |
| | 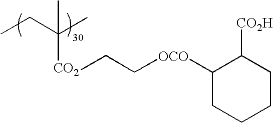 | |
| | 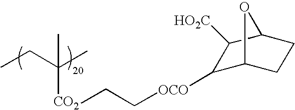 | |
| | 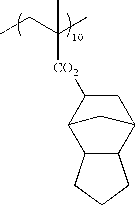 | |
| P-18 | 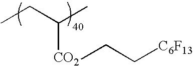 | 3.1 |
| | 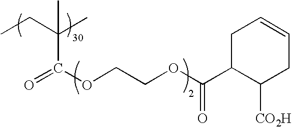 | |
| | 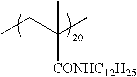 | |
| P-19 | 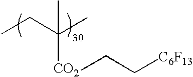 | 1.9 |
| | 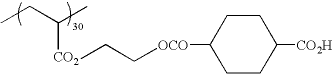 | |
| | 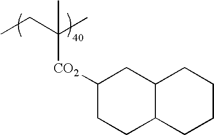 | |
| P-20 | 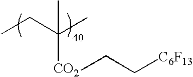 | 2.1 |
| | 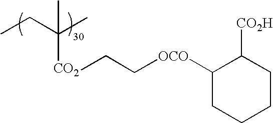 | |
| | 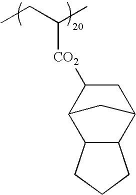 | |
| | 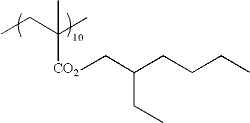 | |
| P-21 | 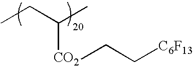 | 1.9 |
| | 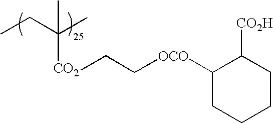 | |
| | 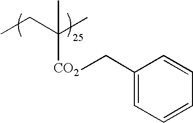 | |
| | 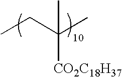 | |

Mw (10,000)
Mw (10,000)
Mw (10,000)
Mw (10,000)

The content of the specific polymer relating to the invention in a recording layer can be freely determined, and is generally in a range of 0.0001 to 20% by mass, more preferably 0.001 to 15% by mass, further preferably 0.01 to 10% by mass relative to a total weight of a non-volatile component in a recording layer.

Since other components such as an infrared-ray absorbing agent are the same as those of the first embodiment, descriptions thereof will be omitted.

### Example

The present embodiment will be further described below according to Examples, but the scope of the present embodiment is not limited to these Examples.

In each of Examples 1 to 60 of the present embodiment and Comparative Examples 1 to 18, supports A, B, C and D and a first layer (lower layer) were prepared as in Examples of the first embodiment.

A coating solution for a second layer (upper layer) of the following composition was coated on the support with a lower layer obtained as described above, with a wire bar. After coating, the product was dried at 145° C. for 70 seconds in a drying oven, at a total coating amount of 1.15 g/m², to prepare positive-type planographic printing plate precursors of Examples 1 to 8 and Comparative Examples 1 to 2.

<Coating solution for second layer (upper layer)>

| | |
|---|---|
| Copolymer of ethyl methacrylate and | 0.030 g |
| 2-methacryloyloxyethylsuccinic acid | |
| (mole ratio 67:33, weight average molecular weight:92,000) | |
| Novolak resin P1:phenolcresol-formardehyde novolak | 0.300 g |
| (phenol:m-cresol:p-cresol = 30:30:40, weight average molecular | |
| weight:5500) | |
| Sulfonyl salt (following structure) | 0.1 g |
| Cyanine dye A (aforementioned structure) | 0.015 g |
| Ethyl violet in which counter anion thereof was | 0.012 g |
| replaced with 6-hydroxynaphthalene sulfonate | |
| Fluorine-based surfactant | 0.011 g |
| (Megafack F-780, manufactured by Dainippon Ink and | |
| Chemicals, Incorporated) | |
| Methyl ethyl ketone | 13.1 g |
| 1-Methoxy-2-propanol | 6.79 g |
| Specific polymer or comparative copolymer | 0.055 g |
| (compound described in Table 1) | |
| 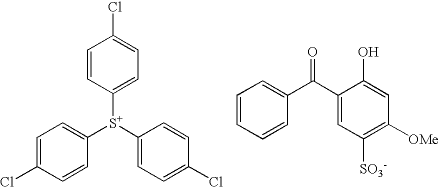 | |

In addition, a structure of a comparative copolymer used in each Comparative Example, together with its weight average molecular weight (Mw) is shown below.

| | | Mw (10,000) |
|---|---|---|
| AP-1 | 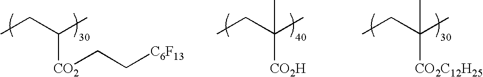 | 2.1 |
| AP-2 | 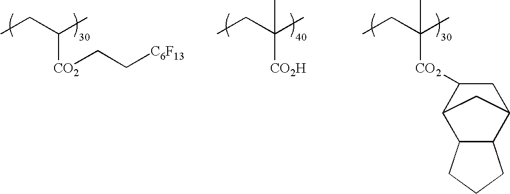 | 1.9 |
| AP-3 | 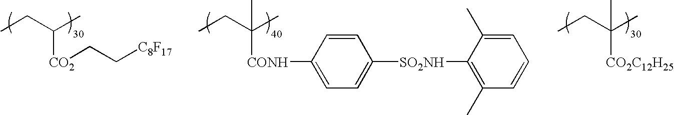 | 3.5 |
| AP-4 | 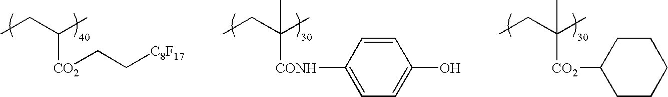 | 4.2 |
| AP-5 | 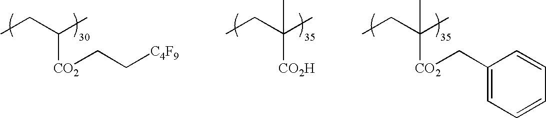 | 2.9 |
| AP-6 | 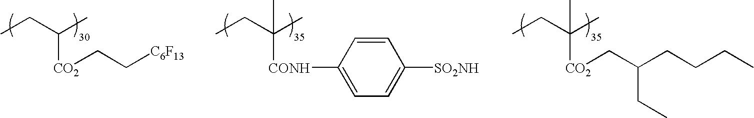 | 3.6 |

[Evaluation of Planographic Printing Plate Precursor]

Each planographic printing plate precursor was evaluated for each item of developing latitude, sensitivity and burning property. Details of the evaluation method are as follows.

1. Presence/Absence of Sludge Generation

After a whole surface (1 m²) of a planographic printing plate precursor 1 m² was exposed to light, the printing plate precursor was treated for development with 100 cc of a developer (DT-1) for a PS plate manufactured by Fuji Photo Film Co., Ltd., which is a developer containing substantially no alkali metal silicate. Thereafter, weather sludge due to precipitates or aggregates derived from the specific polymer of the invention was generated or not in a developer was evaluated. When generation cannot be visually confirmed, it is evaluated as “◯”. When generation of sludge derived from precipitates or aggregates is visually confirmed, it is evaluated as “x”. Results are shown in the following Table 1.

2. Fleshing Property

Using TrendSetter3244F manufactured by CREO, a planographic printing plate precursor was imagewise exposed to light at the amount of setter exposing of 8.0W and 150 rpm. The printing plate precursor was then treated for development with a developer DT-1 for a PS plate manufactured by Fuji Photo Film Co., Ltd. under standard use condition. The printing plate thus obtained was applied to a printing machine, and the number of prints (sheets) needed before obtaining a printed article in which ink was normally loaded on an image portion thereof and had no problem was evaluated. A smaller number of this indicates better inking property. Results are shown in following Table 1.

TABLE 1

| | Specific copolymer or | | |
|---|---|---|---|
| | comparative | Generation of | Inking |
| | copolymer | sludge | Property |
| Example 1 | P-1 | ∘ | 16 |
| Example 2 | P-2 | ∘ | 16 |
| Example 3 | P-3 | ∘ | 14 |
| Example 4 | P-4 | ∘ | 14 |
| Example 5 | P-6 | ∘ | 12 |
| Example 6 | P-7 | ∘ | 10 |
| Example 7 | P-8 | ∘ | 12 |
| Example 8 | P-9 | ∘ | 8 |
| Example 9 | P-15 | ∘ | 13 |
| Example 10 | P-16 | ∘ | 14 |
| Comparative | AP-1 | x | 31 |
| Example 1 | | | |
| Comparative | AP-2 | x | 28 |
| Example 2 | | | |
| Comparative | AP-3 | x | 33 |
| Example 3 | | | |
| Comparative | AP-4 | x | 31 |
| Example 4 | | | |

As shown in Table 1, it is understood that inking property of the planographic printing plate precursors of Examples 1 to 10 was significantly improved. Generation of sludge derived from precipitates in a developer was not observed. In contrast, in all of the planographic printing plate precursors of Comparative Examples 1 to 4, inking property was poor, as compared with Examples, and generation of sludge due to precipitates in a developer was observed.

### Examples 11 to 20, Comparative Examples 5 to 8

In Examples 11 to 20 and Comparative Examples 5 to 8, evaluation was performed in the same manner as that of Examples 1 to 10 and Comparative Examples Ito 4, except that a sulfonium salt was removed from coating solutions for a second layer (upper layer) of Examples 1 to 10 and Comparative Examples 1 to 4. Results are shown in Table 2.

TABLE 2

| | Specific copolymer or | | |
|---|---|---|---|
| | comparative | Generation of | Inking |
| | copolymer | sludge | Property |
| Example 11 | P-1 | ∘ | 18 |
| Example 12 | P-7 | ∘ | 14 |
| Example 13 | P-8 | ∘ | 15 |
| Example 14 | P-9 | ∘ | 8 |
| Example 15 | P-14 | ∘ | 10 |
| Example 16 | P-15 | ∘ | 15 |
| Example 17 | P-16 | ∘ | 15 |
| Example 18 | P-19 | ∘ | 12 |
| Example 19 | P-20 | ∘ | 8 |
| Example 20 | P-21 | ∘ | 18 |
| Comparative | AP-2 | x | 30 |
| Example 5 | | | |
| Comparative | AP-3 | x | 32 |
| Example 6 | | | |
| Comparative | AP-4 | x | 32 |
| Example 7 | | | |
| Comparative | AP-6 | x | 30 |
| Example 8 | | | |

As shown in Table 2, it is understood that inking property of the planographic printing plate precursors of Example 11 to 20 was significantly improved and generation of sludge was significantly suppressed therein. In contrast, in all of the planographic printing plate precursors of Comparative Examples 5 to 8 not containing the specific polymer relating to the present invention, inking property was poor, as compared with Examples 11-20 and generation of sludge due to precipitates in a developer was observed. From these results, it is understood that the effect of the invention is exhibited regardless of the presence/absence of a sufonium salt in a recording layer.

### Examples 21 to 28, Comparative Examples 9 to 10

A support C thus obtained was coated with a coating solution for a first layer (lower layer) of the following composition, with a wire bar. The product was then dried for 60 seconds in a drying oven at 130° C., such that the coating amount thereof was 0.60 g/m².

The support with a lower layer thus obtained was coated with a coating solution for a second layer (upper layer) of the following composition, with a wire bar. The product was then dried at 150° C. for 60 seconds in a drying oven, such that the total coating amount thereof was 1.25 g/m², to prepare positive-type planographic printing plate precursors of Examples 21 to 28 and Comparative Examples 9 to 10.

<Coating solution for first layer (lower layer)>

| | |
|---|---|
| Copolymer 1 | 2.133 g |
| Cyanine dye A (aforementioned structure) | 0.098 g |
| 2-Mercapto-5-methylthio-1,3,4-thiadiazole | 0.030 g |
| Cis-Δ⁴-tetrehydrophthalic acid anhydride | 0.100 g |
| 4,4′-Sulfonyldiphenol | 0.090 g |
| p-Toluenesulfonic acid | 0.008 g |
| Ethyl violet in which counter anion thereof was | 0.100 g |
| replaced with 6-hydroxynaphthalene sulfonic acid | |
| 3-Methoxy-4-diazodiphenylamine hexafluorophosphate | 0.030 g |
| Fluorine-based surfactant | 0.035 g |
| (Mgafack F-780, manufactured by Dainippon Ink and | |
| Chemicals, Incorporated) | |
| Methyl ethyl ketone | 26.6 g |
| 1-Methoxy-2-propanol | 13.6 g |
| Dimethylsulfoxide | 13.8 g |

<Coating solution for second layer (upper layer)>

| | |
|---|---|
| Copolymer of ethylmethacrylate and | 0.030 g |
| 2-methacryloyloxyethyl succinic acid | |
| (mole ratio) 67:33, weight average molecular weight 92,000 | |
| Novolak resin P1; phenolcresol-formardehyde novolak | 0.300 g |
| (phenol:m-cresol:p-cresol = 30:30:40, weight average molecular | |
| weight: 5500) | |
| Sulfonium salt (aforementioned structure) | 0.1 g |
| Cyanine dye A (aforementioned structure) | 0.015 g |
| Ethyl violet in which counter anion was replaced with | 0.012 g |
| 6-hydroxynaphthalenesulfonic acid | |
| Fluorine-based surfactant | 0.011 g |
| (Megeafack F-780, manufactured by Dainippon Ink and | |
| Chemicals, Incorporated) | |
| Methyl ethyl ketone | 13.1 g |
| 1-Methoxy-2-propanol | 6.79 g |
| specific polymer or comparative copolymer | 0.055 g |
| (compound described in Table 1) | |

<Evaluation of Examples 21 to 28 and Comparative Examples 9 to 10>

The respective planographic printing plate precursors of Examples 21 to 28 and Comparative Examples 9 to 10 thus obtained were assessed by the same method as that of Example 1.

TABLE 3

| | Specific copolymer or | | |
|---|---|---|---|
| | comparative | Generation of | Inking |
| | copolymer | sludge | Property |
| Example 21 | P-1 | ∘ | 18 |
| Example 22 | P-9 | ∘ | 7 |
| Example 23 | P-10 | ∘ | 18 |
| Example 24 | P-14 | ∘ | 9 |
| Example 25 | P-18 | ∘ | 18 |
| Example 26 | P-19 | ∘ | 15 |
| Example 27 | P-20 | ∘ | 7 |
| Example 28 | P-21 | ∘ | 16 |
| Comparative | AP-1 | x | 34 |
| Example 9 | | | |
| Comparative | AP-3 | x | 30 |
| Example 10 | | | |

As shown in Table 3, it is understood that inking property of the planographic printing plate precursors of Example 21 to 28 was significantly improved and generation of sludge due to precipitates in a developer was significantly was prevented therein. In contrast, in all of the planographic printing plate precursors of Comparative Examples 9 to 10 not containing the specific polymer relating to the present invention, inking property was poor, as compared with Examples 21-28, and generation of sludge due to precipitates in a developer was observed.

### Examples 29 to 36, Comparative Examples 11 to 12

In Examples 29 to 36 and Comparative Examples 11 to 12, evaluation was performed in the same manner as that of Examples 21-28 and Comparative Examples 9-10, except that a sulfonium salt was removed from coating solutions for a second layer (upper layer) of Examples 21 to 28 and Comparative Examples 9 to 10. Results are shown in Table 4.

TABLE 4

| | Specific copolymer or | | |
|---|---|---|---|
| | comparative | Generation of | Inking |
| | copolymer | sludge | Property |
| Example 29 | P-1 | ∘ | 21 |
| Example 30 | P-2 | ∘ | 21 |
| Example 31 | P-3 | ∘ | 19 |
| Example 32 | P-8 | ∘ | 18 |
| Example 33 | P-9 | ∘ | 8 |
| Example 34 | P-10 | ∘ | 16 |
| Example 35 | P-11 | ∘ | 11 |
| Example 36 | P-19 | ∘ | 14 |
| Comparative | AP-3 | x | 32 |
| Example 11 | | | |
| Comparative | AP-6 | x | 35 |
| Example 12 | | | |

As shown in Table 4, it is understood that inking property of the planographic printing plate precursors of Example 29 to 36 was significantly improved and generation of sludge due to precipitates in a developer was significantly was prevented therein. In contrast, in all of the planographic printing plate precursors of Comparative Examples 11 and 12 not containing the specific polymer relating to the present invention, inking property was poor, as compared with Examples 29-36, and generation of sludge due to precipitates in a developer was observed.

### Examples 37 to 44, Comparative Examples 13 to 14

A support D thus obtained was coated with a coating solution for a first layer (lower layer) of the following composition, with a wire bar. The product was then dried for 60 seconds in a drying oven at 150° C., such that the coating amount thereof was 0.81 g/m².

The support with a lower layer thus obtained was coated with a coating solution for a second layer (upper layer) of the following composition, by using a wire bar. The product was then dried at 150° C. for 60 seconds in a drying oven, such that the total coating amount thereof was 0.99 g/m², to prepare positive-type planographic printing plate precursors of Examples 37 to 44 and Comparative Examples 13 and 14.

<Coating solution for first layer (lower layer)>

| | |
|---|---|
| Aforementioned polymer 1 | 2.133 g |
| Cyanine dye A (aforementioned structure) | 0.098 g |
| Cis-Δ⁴-tetrehydrophthalic acid anhydride | 0.110 g |
| 4,4′-sulfonyldiphenol | 0.090 g |
| p-Toluenesulfonic acid | 0.008 g |
| Ethyl violet in which counter anion was replaced with | 0.100 g |
| 6-hydroxynaphthalenesulfonic acid | |
| 3-Methoxy-4-diazodiphenylaminehexafluorophosphate | 0.030 g |
| Fluorine-based surfactant | 0.035 g |
| (Megafack F-780, manufactured by Dainippon Ink and | |
| Chemicals, Incorporated) | |
| Methyl ethyl ketone | 26.6 g |
| 1-Mrthoxy-2-propanol | 13.6 g |
| γ-Butyrolactone | 13.8 g |

<Coating solution for second layer (upper layer)>

| | |
|---|---|
| Copolymer of ethyl methacrylate and | 0.030 g |
| 2-methacrloyloxyethylsuccinic acid | |
| (mole ratio 67:33, weight average molecular weight 92,000) | |
| Novolak resin P5: | 0.300 g |
| (phenolcresol-formardehydenovolak | |
| phenol:m-cresol:p-cresol = 40:40:20, | |
| weight average molecular: 8000) | |
| Sulfonium salt (aforementioned structure) | 0.020 g |
| Cyanine dye A (aforementioned structure) | 0.015 g |
| Fluorine-based surfactant | 0.011 g |
| (Megafack F-780, manufactured by Dainippon Ink and | |
| Chemicals, Incorporated) | |
| Methyl ethyl ketone | 13.1 g |
| 1-Methoxy-2-propanol | 6.79 g |
| Specific polymer or comparative copolymer | 0.055 g |
| (compound described in Table 1) | |

<Evaluation of Examples 37 to 44 and Comparative Examples 13 to 14>

In Examples 37 to 44 and Comparative Examples 13 and 14, evaluation of the respective planographic printing plate precursors thus obtained was each performed in the same manner as that of Example 1, except that a developer “DP-4” for a PS plate manufactured by Fuji Photo film Co., Ltd. containing an alkali metal silicate was used as a developer.

TABLE 5

| | Specific copolymer or | | |
|---|---|---|---|
| | comparative | Generation of | Inking |
| | copolymer | sludge | Property |
| Example 37 | P-1 | ∘ | 18 |
| Example 38 | P-2 | ∘ | 18 |
| Example 39 | P-8 | ∘ | 14 |
| Example 40 | P-9 | ∘ | 8 |
| Example 41 | P-12 | ∘ | 11 |
| Example 42 | P-14 | ∘ | 9 |
| Example 43 | P-15 | ∘ | 14 |
| Example 44 | P-16 | ∘ | 16 |
| Comparative | AP-2 | x | 32 |
| Example 13 | | | |
| Comparative | AP-6 | x | 28 |
| Example 14 | | | |

As shown in Table 5, it is understood that inking property of the planographic printing plate precursors of Example 37 to 44 was significantly improved and generation of sludge due to precipitates in a developer was significantly was prevented therein. In contrast, in all of the planographic printing plate precursors of Comparative Examples 13 and 14 not containing the specific polymer relating to the present invention, inking property was poor, as compared with Examples 29-36, and generation of sludge due to precipitates in a developer was observed.

### Examples 45 to 52, Comparative Examples 15 to 16

In Examples 45 to 52 and Comparative Examples 15 to 16, evaluation was performed in the same manner as Examples 37 to 44 and Comparative Examples 13 and 14, except that a sulfonium salt was removed from the coating solutions for a second layer (upper layer) of Examples 37 to 44 and Comparative Examples 13 to 14. Results are shown in Table 6.

TABLE 6

| | Specific copolymer or | | |
|---|---|---|---|
| | comparative | Generation of | Inking |
| | copolymer | sludge | Property |
| Example 45 | P-1 | ∘ | 17 |
| Example 46 | P-8 | ∘ | 17 |
| Example 47 | P-9 | ∘ | 9 |
| Example 48 | P-16 | ∘ | 17 |
| Example 49 | P-17 | ∘ | 10 |
| Example 50 | P-18 | ∘ | 14 |
| Example 51 | P-19 | ∘ | 14 |
| Example 52 | P-20 | ∘ | 9 |
| Comparative | AP-1 | x | 29 |
| Example 15 | | | |
| Comparative | AP-3 | x | 29 |
| Example 16 | | | |

As shown in Table 6, it is understood that inking property of the planographic printing plate precursors of Example 45 to 52 was significantly improved and generation of sludge due to precipitates in a developer was significantly was prevented therein. In contrast, in both of the planographic printing plate precursors of Comparative Examples 13 and 14 not containing the specific polymer relating to the present invention, inking property was poor, as compared with Examples 45-52, and generation of sludge due to precipitates in a developer was observed.

### Examples 53 to 60, Comparative Examples 17 and 18

A support D thus obtained was coated with a coating solution for an image forming layer of the following composition. The support was then dried for one minute at 150° C. to form an image forming layer thereon, whereby the planographic printing plate precursors of Examples 53 to 60 and Comparative Examples 17 and 18 were obtained. The coating amount after being dried of each sample was 1.55 g/m².

<Image forming layer coating solution>

| | |
|---|---|
| Novolak resin P7: phenolcresol-hormardehydenovolak | 1.0 g |
| (phenol:m-cresol:p-cresol = 20:60:20, weight average molecular | |
| weight: 0200) | |
| Cyanine dye A (aforementioned structure) | 0.05 g |
| Dye obtained by replacing the counter anion of Victria Pure Blue | 0.01 g |
| BOH with 1-naphthalenesulfonic acid anion | |
| fluorine-based surfactant | 0.05 g |
| (Megafack F-177, manufactured by Dainippon Ink and | |
| Chemicals, Incorporated) | |
| Methyl ethyl ketone | 9.0 g |
| 1-Methoxy-2-propanol | 9.0 g |

<Evaluation of Examples 53 to 60 and Comparative Examples 17 and 18>

In Examples 53 to 60 and Comparative Examples 17 and 18, evaluation of the respective planographic printing plate precursors thus obtained was each performed in the same manner as that of Example 1, except that a developer “DP-4” for a PS plate manufactured by Fuji Photo film Co., Ltd. containing an alkali metal silicate was used as a developer.

TABLE 7

| | Specific copolymer or | | |
|---|---|---|---|
| | comparative | Generation of | Inking |
| | copolymer | sludge | Property |
| Example 53 | P-1 | ∘ | 18 |
| Example 54 | P-4 | ∘ | 17 |
| Example 55 | P-9 | ∘ | 8 |
| Example 56 | P-10 | ∘ | 15 |
| Example 57 | P-11 | ∘ | 10 |
| Example 58 | P-12 | ∘ | 13 |
| Example 59 | P-13 | ∘ | 15 |
| Example 60 | P-14 | ∘ | 10 |
| Comparative | AP-3 | x | 26 |
| Example 17 | | | |
| Comparative | AP-5 | x | 29 |
| Example 18 | | | |

As shown in Table 7, it is understood that inking property of the planographic printing plate precursors of Example 53 to 60 was significantly improved and generation of sludge due to precipitates in a developer was significantly was prevented therein. From this, it is known that in the planographic printing plate precursor of the invention, a superior effect thereof can be exhibited not only in a recording layer of a multi-layer structure but also in a recording layer of a single-layer structure. In contrast, in both of the planographic printing plate precursors of Comparative Examples 17 and 18 containing no specific polymer relating the invention, inking was poor as compared with Examples 56-60 and generation of sludge due to precipitates in a developer was observed.

What is claimed is:

1. A positive-type planographic printing plate precursor, comprising:
a support, and
a recording layer provided on the support,
wherein the recording layer comprises: a polymer compound having, as a copolymerization component, (a) a monomer represented by the following formula (1), (b) a monomer having an aliphatic group having 7 or more carbon atoms and having a bridge bond, (c) a monomer having an acid group; and an infrared-ray absorbing agent. 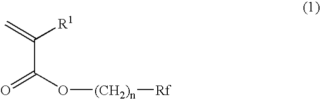
wherein in the formula (1), Rf is a substituent containing a fluoroalkyl group or a perfluoroalkyl group having 9 or more fluorine atoms, n represents 1 or 2, and R¹ represents hydrogen or a methyl group.

2. The positive-type planographic printing plate precursor according to claim 1, wherein the recording layer has a multi-layer structure comprising an uppermost layer and another layer, and the uppermost layer contains the polymer compound and the infrared-ray absorbing agent.

3. The positive-type planographic printing plate precursor according to claim 1, wherein in the formula (1), Rf is a substituent containing a fluoroalkyl group or a perfluoroalkyl group having 9 to 30 fluorine atoms.

4. The positive-type planographic printing plate precursor according to claim 1, wherein a fluorine atom content in the polymer compound is 5 to 30 mmol/g.

5. The positive-type planographic printing plate precursor according to claim 1, wherein a content of the aliphatic group having 7 or more carbon atoms and having a bridge bond in the polymer compound is 0.1 to 10 mmol/g.

6. The positive-type planographic printing plate precursor according to claim 1, wherein a content of the acid group in the polymer compound is 0.2 to 10.0 mmol/g.

7. The positive-type planographic printing plate precursor according to claim 2, wherein another layer contains an alkali-soluble resin, and the uppermost layer further contains an alkali-soluble resin and a compound which interacts with the alkali-soluble resin to reduce solubility in an aqueous alkali solution thereof.

8. The positive-type planographic printing plate precursor according to claim 7, wherein in the formula (1), Rf is a substituent containing a fluoroalkyl group or a perfluoroalkyl group having 9 to 30 fluorine atoms.

9. The positive-type planographic printing plate precursor according to claim 7, wherein a fluorine atom content in the polymer compound is 5 to 30 mmol/g.

10. The positive-type planographic printing plate precursor according to claim 7, wherein a content of the aliphatic group having 7 or more carbon atoms and having a bridge bond in the polymer compound is 0.1 to 10 mmol/g.

11. A planographic printing plate precursor, comprising:
a support; and
a recording layer provided on the support,
wherein the recording layer contains: a polymer compound having, as a copolymerization component, (a) a monomer represented by the formula (1) and (b) a monomer represented by the following formula (2); and an infrared-ray absorbing agent. 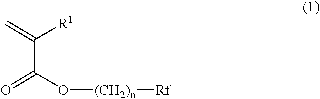
In the formula (1), Rf is a substituent containing a fluoroalkyl group or a perfluoroalkyl group having 9 or more fluorine atoms, n represents 1 or 2, and R¹ represents hydrogen or a methyl group. 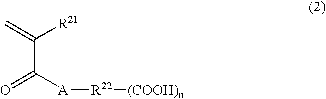
In the formula (2), R²¹ represents a hydrogen atom or a methyl group, and R²² represents a divalent hydrocarbon group having a C3-C30 alicyclic structure. A represents an oxygen atom, or —NR²³—, and R²³ represents a hydrogen atom or a C1-C10 monovalent hydrocarbon group.

12. The positive-type planographic printing plate precursor according to claim 11, wherein the recording layer has a multi-layer structure comprising an uppermost layer and another layer, and the uppermost layer contains the polymer compound and the infrared-ray absorbing agent.

13. The positive-type planographic printing plate precursor according to claim 11, wherein in the formula (1), Rf is a substituent containing a fluoroalkyl group or a perfluoroalkyl group having 9 to 30 fluorine atoms.

14. The positive-type planographic printing plate precursor according to claim 11, wherein in the formula (2), R²¹ represents a hydrogen atom or a methyl group.

15. The positive-type planographic printing plate precursor according to claim 11, wherein in the formula (2), R²² represents a divalent hydrocarbon group having a C3-C30 alicyclic structure.

16. The positive-type planographic printing plate precursor according to claim 11, wherein in the formula (2), A represents an oxygen atom or —NH—.

17. The positive-type planographic printing plate precursor according to claim 11, wherein the acid value per polymer is preferably 0.01 to 3.0 mmol/g.

18. The positive-type planographic printing plate precursor according to claim 12, wherein another layer contains an alkali-soluble resin, and the uppermost layer further contains an alkali-soluble resin and a compound which interacts with the alkali-soluble resin to reduce solubility in an aqueous alkali solution thereof.

19. The positive-type planographic printing plate precursor according to claim 18, wherein in the formula (1), Rf is a substituent containing a fluoroalkyl group or a perfluoroalkyl group having 9 to 30 fluorine atoms.

20. The positive-type planographic printing plate precursor according to claim 18, wherein the acid value per polymer is preferably 0.01 to 3.0 mmol/g.
